(19) United States
(12) Patent Application Publication
(10) Pub. No.: US 2007/0198199 A1
(43) Pub. Date: Aug. 23, 2007

(54) Method and system of computing and rendering the nature of the chemical bond of hydrogen-type molecules and molecular ions

(76) Inventor: Randell L. Mills, Cranbury, NJ (US)

Correspondence Address: MANELLI DENISON & SELTER, 2000 M STREET NW SUITE 700, WASHINGTON, DC, 20036-3307, US

(21) Appl. No.: 11/606,903

(22) Filed: Dec. 1, 2006

Related U.S. Application Data
(63) Continuation of application No. 10/893,280, filed on Jul. 19, 2004, now Pat. No. 7,188,033.

(51) Int. Cl. G06F 19/00

(52) U.S. Cl. 702/32; 702/1; 702/22; 702/27

(57) ABSTRACT

Provided is a system of computing and rendering a nature of a chemical bond based on physical, Maxwellian solutions of charge, mass, and current density functions of hydrogen-type molecules and molecular ions. The system includes a processor for processing Maxwellian equations representing charge, mass, and current density functions of hydrogen-type molecules and molecular ions and an output device in communication with the processor for displaying the nature of the chemical bond.

This application is a Continuation of U.S. patent application Ser. No. 10/893,280, filed Jul. 19, 2004, and this application claims priority to U.S. Provisional Patent Application Nos.: 60/488,622, filed Jul. 21, 2003; 60/491,963, filed Aug. 5, 2003; 60/534,112, filed Jan. 5, 2004; 60/542,278, filed Feb. 9, 2004; and 60/571,667, filed May 17, 2004, the complete disclosures of which are incorporated herein by reference.

### I. INTRODUCTION

1. Field of the Invention

This invention relates to a method and system of physically solving the charge, mass, and current density functions of hydrogen-type molecules and molecular ions and computing and rendering the nature of the chemical bond using the solutions. The results can be displayed on visual or graphical media. The display can be static or dynamic such that vibration and rotation can be displayed in an embodiment. The displayed information is useful to anticipate reactivity and physical properties. The insight into the nature of the chemical bond can permit the solution and display of other molecules and provide utility to anticipate their reactivity and physical properties.

The quantum mechanical theory of the nature of the chemical bond is based on phenomena that are “unique to quantum mechanics” and have no basis in experimental observation. The current methods of arriving at numbers that are meant to reproduce and possibly predict new experimental results on bonds and spectra can be classified as a plethora of curving-fitting algorithms, often computer-programmed, that have no basis in reality and are not representative of the corresponding real molecules or molecular ions. Specifically, they all depend on the nonexistent, nonphysical “exchange integral” that is a consequence of a postulated linear combination of product wavefunctions wherein it is implicit that each point electron with infinite self-electric-and-magnetic-field energies must exist as a “probability-wave cloud” and be in two places at the same time (i.e. centered on two nuclei simultaneously!) The exchange integral is a “spooky action” phenomenon that violates Einstein causality. A further nonphysical aspect is that the molecular solution is obtained without considering the nuclei to move under the Born-Oppenheimer approximation; yet, the molecule must have a further nonphysical perpetual-motion-type property of “zero point vibration.” Additional internal inconsistencies arise. The electron clouds mutually shield the nuclear charge to provide an adjustable parameter, “effective nuclear charge”; yet, neither has any self shielding effect even though the clouds are mutually indistinguishable and must classically result in a self interaction instability. The corresponding self-interaction energy term as well as the equally large electron-spin pairing energy are conspicuously absent from the Hamiltonian. Instead arbitrary types of variational parameters of the wavefunctions and mixing of wavefunctions as well as other adjustable parameters are introduced to force the solutions of a multitude of methods to more closely approximate the experimental parameters. Yet, the experimental bond energy is not calculated; rather a parameter Dₑ is determined from which the “zero point vibration” is subtracted and “anharmonicity term in the zero-point vibration” is added to obtain the experimentally measurable bond energy D₀.

Zero point vibration (ZOV), like the similar nonsensical prediction of quantum mechanics, zero-point energy of the vacuum, has never been directly measured. Furthermore, ZOV violates the second law of thermodynamics, and it is in conflict with direct experimental results such as the formation of solid hydrogen and Bose-Einstein condensates of molecules. As a consequence, the bond energy predictions of quantum mechanics have never been tested experimentally, and it is not possible to state that the methods predict the experimental bond energy at all. The many conflicting attempts suffer from the same short comings that plague atomic quantum theory, infinities, instability with respect to radiation according to Maxwell's equations, violation of conservation of linear and angular momentum, lack of physical relativistic invariance, etc. From a physical perspective, the implication for the basis of the chemical bond according to quantum mechanics being the exchange integral and the requirement of zero point vibration, “strictly quantum mechanical phenomena,” is that the theory cannot be a correct description of reality.

A proposed solution based on physical laws and fully compliant with Maxwell's equations solves the parameters of molecular ions and molecules of hydrogen isotopes from the Laplacian in elliptic coordinates in closed form equations with fundamental constants only. The boundary condition of nonradiation requires that the electron be a solution of the two-dimensional wave equation plus time. There is no a priori basis why the electron cannot obey this wave equation versus one based on three dimensions plus time. The corresponding Dirac delta function in the elliptic parameter ξ gives the physical representation of the bound electron as a two-dimensional equipotential surface of charge (mass) density with time-harmonic motion along a geodesic at each position on the surface. The electron molecular orbitals in this case that do not depend on an exchange integral are truly physical rather than purely mathematical. The closed form solutions of H₂⁺, D₂⁺, H₂, and D₂ given in TABLE I show that hydrogen species can be solved in closed form with tremendous accuracy using first principles. The observed

$$\sqrt{\frac{k}{μ}}$$

dependency of vibrational energies on the isotope is obtained without the requirement of any imaginary (experimentally not observed) zero-point vibration.

The results corresponding to the nature of the chemical bond match over 20 parameters of hydrogen molecular ions and molecules. Overall, the results are better than those given by current approaches, without the fabricated exchange integral, zero-point vibration, anharmonicity term in the zero-point vibration, renormalization, effective nuclear charge, multitude of contradictory and non-unique approaches and solutions having variational and adjustable parameters and all types of violations of first principles. Such a classical solution was deemed to be impossible according to quantum mechanics since the molecule is not supposed to obey physical laws—“it was impossible to explain why two hydrogen atoms come together to form a stable chemical bond . . . the existence of the chemical bond is a quantum mechanical effect” [10]. Yet, classical laws predict the current observations and also predict new forms of hydrogen molecular ion and molecular hydrogen that was missed by QM. Remarkably, the predictions match recent experimental data [49-71, 91, 96-97].

Additionally, the ground-state density ρ and the ground-state wavefunction Ψ[ρ] of the more recent advancement, density functional theory, have some similarities with the equipotential, minimum energy, charge-density functions (molecular orbitals) of classical quantum mechanics (CQM) [98-100]. Perhaps an opportunity exists to go beyond the nonphysical exchange integral, zero order vibration, adjustable parameters, and other “phenomena that are unique to quantum mechanics.” The goal of developing curve-fitting algorithms that simply generate good numbers may be replaced by an understanding of the physical nature of the chemical bond and derivations from first principles. With such an understanding, further accurate predictions can be anticipated.

2. Background of the Invention

2.A. Classical Approach to the Nature of the Chemical Bond

2.A.a. Nonradiation Boundary Condition

In an attempt to provide some physical insight into atomic problems and starting with the same essential physics as Bohr of e⁻ moving in the Coulombic field of the proton and the wave equation as modified by Schrödinger, a classical approach was explored which yields a model which is remarkably accurate and provides insight into physics on the atomic level [1-5, 40]. The proverbial view deeply seated in the wave-particle duality notion that there is no large-scale physical counterpart to the nature of the electron may not be correct. Physical laws and intuition may be restored when dealing with the wave equation and quantum mechanical problems. Specifically, a theory of classical quantum mechanics (CQM) was derived from first principles that successfully applies physical laws on all scales. Using Maxwell's equations, the classical wave equation is solved with the constraint that the bound n=1-state electron cannot radiate energy. It was found that quantum phenomena were predicted with accuracy within that of the fundamental constants in closed form equations that contained fundamental constants only. In this paper, the hydrogen-isotope molecular ions and molecules are solved in the same manner.

One-electron atoms include the hydrogen atom, He⁺, Li²⁺, Be³⁺, and so on. The mass-energy and angular momentum of the electron are constant; this requires that the equation of motion of the electron be temporally and spatially harmonic. Thus, the classical wave equation applies and

$$[ {∇}^{2} - \frac{1}{{v}^{2}} \frac{{\partial }^{2}}{\partial {t}^{2}} ] ρ ( r , θ , ϕ , t ) = 0 \qquad ( I .1 )$$

where ρ(r,θ,φ,t) is the time dependent charge-density function of the electron in time and space. In general, the wave equation has an infinite number of solutions. To arrive at the solution which represents the electron, a suitable boundary condition must be imposed. It is well known from experiments that each single atomic electron of a given isotope radiates to the same stable state. Thus, the physical boundary condition of nonradiation of the bound electron was imposed on the solution of the wave equation for the time dependent charge-density function of the electron [1-5]. The condition for radiation by a moving point charge given by Haus [28] is that its spacetime Fourier transform does possess components that are synchronous with waves traveling at the speed of light. Conversely, it is proposed that the condition for nonradiation by an ensemble of moving point charges that comprises a current-density function is
For non-radiative states, the current-density function must NOT possess spacetime Fourier components that are synchronous with waves traveling at the speed of light.
The time, radial, and angular solutions of the wave equation are separable. The motion is time harmonic with angular frequency ωₙ, A constant angular function is a solution to the wave equation. Solutions of the Schrödinger wave equation comprising a radial function radiate according to Maxwell's equation as shown previously by application of Haus' condition [1-5]. In fact, it was found that any function which permitted radial motion gave rise to radiation. A radial function which does satisfy the boundary condition is a radial delta function

$$f ( r ) = \frac{1}{{r}^{2}} δ ( r - {r}_{n} ) \qquad ( I .2 )$$

This function defines a constant charge density on a spherical shell where rₙ=nr₁ wherein n is an integer in an excited state as given in the Excited States section of Ref. [5], and Eq. (I.1) becomes the two-dimensional wave equation plus time with separable time and angular functions. As discussed in Sec. IV.1, the solution for nonradiation also gives a two-dimensional equipotential membrane for the molecular orbitals of the hydrogen molecular ion and hydrogen molecule. Consequently, the wave equation in the corresponding preferred coordinates, elliptic coordinates after James and Coolidge [10, 16], becomes two dimensional plus time. Although unconventional in this application, the two-dimensional wave equation is also familiar to quantum mechanics. For example, it is used to solve the angular functions of the Schrödinger equation [41]. The solutions are the well known spherical harmonics.

There is no a priori reason why the electron must be a solution of the three dimensional wave equation plus time and cannot obey a two-dimensional wave equation plus time. Furthermore, in addition to the important result of stability to radiation, several more very important physical results are subsequently realized: 1.) The charge is distributed on a two-dimension surface; thus, there are no infinities in the corresponding fields. Infinite fields are simply renormalized in the case of the point-particles of quantum mechanics, but it is physically gratifying that none arise in this case since infinite fields have never been measured or realized in the laboratory. 2.) The hydrogen molecular ion or molecule has finite dimensions rather than extending over all space. From measurements of the resistivity of hydrogen as a function of pressure, the finite dimensions of the hydrogen molecule are evident in the plateau of the resistivity versus pressure curve of metallic hydrogen [42]. This is in contradiction to the predictions of quantum probability functions such as an exponential radial distribution in space. 3.) Consistent with experiments, neutral scattering is predicted without violation of special relativity and causality wherein a point must be everywhere at once as required in the QM case. 4.) There is no electron self interaction. The continuous charge-density function is a two-dimensional equipotential energy surface with an electric field that is strictly normal for the elliptic parameter ξ>0 (See Sec. IV) according to Gauss' law and Faraday's law. The relationship between the electric field equation and the electron source charge-density function is given by Maxwell's equation in two dimensions [43-44].

$$n \cdot ( {E}_{1} - {E}_{2} ) = \frac{σ}{{ɛ}_{0}} \qquad ( I .3 )$$

where n is the normal unit vector, E₁=0 (E₁ is the electric field inside of the MO), E₂ is the electric field outside of the MO and σ is the surface charge density. This relation shows that only a two-dimensional geometry meets the criterion for a fundamental particle. This is the nonsingularity geometry which is no longer divisible. It is the dimension from which it is not possible to lower dimensionality. In this case, there is no electrostatic self interaction since the corresponding potential is continuous across the surface according to Faraday's law in the electrostatic limit, and the field is discontinuous, normal to the charge according to Gauss' law [43-45]. 5.) The instability of electron-electron repulsion of molecular hydrogen is eliminated since the central field of the hydrogen molecular ion relative to a second electron at ξ>0 which binds to form the hydrogen molecule is that of a single charge at the foci. 6.) The ellipsoidal MOs allow exact spin pairing over all time which is consistent with experimental observation. This aspect is not possible in the QM model. And, 7.) The ellipsoidal MOs allow for the basis of excited states as fully Maxwellian compliant resonator mode excitations and for the ionization of the electron as a plane wave with the [symbol] of angular momentum conserved corresponding to the de Broglie wavelength. Physical predictions match the wave-particle duality nature of the free electron as shown in the Electron in Free Space section of Ref [5].

As with any model, the proving ground is experimental data and also the ability to predict new results. The Maxwellian solutions are unique—not an infinite number of arbitrary results from corresponding inconsistent algorithms, wavefunctions, and variational and adjustable parameters as is the case with quantum mechanics. It is found that CQM based on Maxwell's equations gives the bond energy and other parameters associated with the nature of the chemical bond in closed form equations containing fundamental constants without a plethora of fudge factors (e.g. the value used for the nuclear charge is the fundamental constant e=+1.6021892×10⁻¹⁹ C). The complications of prior approaches based on the Schrödinger equation with point-particle-probability-density wavefunctions such as the required exchange integral and zero-point vibration which does not experimentally exist are eliminated. It is shown that there is remarkable agreement between predictions and the experimental observations, and the results are physically intuitive in contrast to the “phenomena that are unique to quantum mechanics” [7-8, 10]. Furthermore the theory is predictive and the predictions match recent experimental results as discussed infra. and in Secs. I.2.A.b and IV.9.

2.A.b. Excited States and the Possibility of Lower-Energy States

Consider the excited states of the hydrogen atom. The central field of the proton corresponds to integer one charge. Excited states comprise an electron with a trapped photon. In all energy states of hydrogen, the photon has an electric field which superposes with the field of the proton. In the n=1 state, the sum is one, and the sum is zero in the ionized state. In an excited state, the sum is a fraction of one (i.e. between zero and one). Derivations from first principles given in Ref. [5] demonstrate that each “allowed” fraction corresponding to an excited state is

$$\frac{1}{integer} .$$

The relationship between the electric field equation and the “trapped photon” source charge-density function is given by Maxwell's equation in two dimensions. The result is given by Eq. (I.3) where n is the radial normal unit vector, E₁=0 (E₁ is the electric field outside of the electron), E₂ is given by the total electric field at rₙ=na_{H}, and σ is the surface charge density. The electric field of an excited state is fractional; therefore, the source charge function is fractional. It is well known that fractional charge is not “allowed.” The reason is that fractional charge typically corresponds to a radiative current-density function. The excited states of the hydrogen atom are examples. They are radiative; consequently, they are not stable as shown in Ref. [5]. Thus, an excited electron decays to the first nonradiative state corresponding to an integer field, n=1 (i.e. a field of integer one times the central field of the proton). Equally valid from first principles are electronic states where the magnitude of the sum of the electric field of the photon and the proton central field are an integer greater than one times the central field of the proton. These states are nonradiative. A catalyst can effect a transition between these states via a nonradiative energy transfer [5].

J. R. Rydberg showed that all of the spectral lines of atomic hydrogen were given by a completely empirical relationship:

$$\overline{v} = R ( \frac{1}{{n}_{f}^{2}} - \frac{1}{{n}_{i}^{2}} ) \qquad ( I .4 )$$

where R=109,677 cm⁻¹, n_{f}=1,2,3, . . . , nᵢ=2,3,4, . . . and nᵢ>n_{f}. Bohr, Schrödinger, and Heisenberg each developed a theory for atomic hydrogen that gave the energy levels in agreement with Rydberg's equation.

$$\begin{matrix}{E}_{n} = - \frac{{e}^{2}}{{n}^{2} 8 {πɛ}_{o} {a}_{H}} = - \frac{13.598 eV}{{n}^{2}} & ( I .5 a ) \\ n = 1 , 2 , 3 , … & ( I .5 b )\end{matrix}$$

The excited energy states of atomic hydrogen are given by Eq. (I.5a) for n>1 in Eq. (I.5b). The n=1 state is the “ground” state for “pure” photon transitions (i.e. the n=1 state can absorb a photon and go to an excited electronic state, but it cannot release a photon and go to a lower-energy electronic state). However, an electron transition from the ground state to a lower-energy state may be possible by a resonant nonradiative energy transfer such as multipole coupling or a resonant collision mechanism. Processes such as hydrogen molecular bond formation that occur without photons and that require collisions are common [46]. Also, some commercial phosphors are based on resonant nonradiative energy transfer involving multipole coupling [47].

It is proposed that atomic hydrogen may undergo a catalytic reaction with certain atoms, excimers, and ions which provide a reaction with a net enthalpy of an integer multiple of the potential energy of atomic hydrogen, m·27.2 eV wherein m is an integer. The ionization energy of He⁺ to He²⁺ is equal to two times the potential energy of atomic hydrogen, respectively [48]. Thus, this reaction fulfills the catalyst criterion—a chemical or physical process with an enthalpy change equal to an integer multiple of 27.2 eV. The theory and supporting data were given previously [5, 49-71]. The reaction involves a nonradiative energy transfer to form a hydrogen atom that is lower in energy than unreacted atomic hydrogen that corresponds to a fractional principal quantum number. That is

$$n = \frac{1}{2} , \frac{1}{3} , \frac{1}{4} , … , \frac{1}{p} ; p is an integer \qquad ( I .5 c )$$

replaces the well known parameter n=integer in the Rydberg equation for hydrogen excited states. The n=1 state of hydrogen and the

$$n = \frac{1}{integer}$$

states of hydrogen are nonradiative, but a transition between two nonradiative states, say n=1 to n=½, is possible via a nonradiative energy transfer. Thus, a catalyst provides a net positive enthalpy of reaction of m·27.2 eV (i.e. it resonantly accepts the nonradiative energy transfer from hydrogen atoms and releases the energy to the surroundings to affect electronic transitions to fractional quantum energy levels). As a consequence of the nonradiative energy transfer, the hydrogen atom becomes unstable and emits further energy until it achieves a lower-energy nonradiative state having a principal energy level given by Eqs. (I.5a) and (I.5c).

The predicted emission was recently reported [53]. Extreme ultraviolet (EUV) spectroscopy was recorded on microwave discharges of helium with 2% hydrogen. Novel emission lines were observed with energies of q·13.6 eV where q=1,2,3,4,6,7,8,9,11 or these discrete energies less 21.2 eV corresponding to inelastic scattering of these photons by helium atoms due to excitation of He (1s²) to He (1s¹2p¹). These lines matched H(1/p), fractional Rydberg states of atomic hydrogen, formed by a resonant nonradiative energy transfer to He⁺. Substantial experimental evidence exists that supports the existence of this novel hydrogen chemistry and its applications [49-71] such as EUV spectroscopy [49-60, 63-65, 67-68], characteristic emission from catalysts and the hydride ion products [50-51, 59-60, 65], lower-energy hydrogen emission [53-58, 67-68], chemically formed plasmas [49-62, 59-60, 63-64, 65], extraordinary (>100 eV) Balmer α line broadening [49-51, 53, 55, 59, 61-62, 65, 69], population inversion of H lines [59, 65-67], elevated electron temperature [53, 62-62, 68], anomalous plasma afterglow duration [63-64], power generation [54-55, 67-68], and analysis of novel chemical compounds [69-71].

The possibility of states with n=1/p is also predicted in the case of hydrogen molecular species wherein H(1/p) reacts a proton or two H(1/p) atoms react to form H₂⁺(1/p) and H₂ (1/p), respectively. The natural molecular-hydrogen coordinate system based on symmetry that was used by James and Coolidge [16], Kolos and Wolniewicz [15], and others [10] is elliptic coordinates. The magnitude of the central field in the derivations of molecular hydrogen species is taken as the general parameter p wherein p may be an integer which may be predictive of new possibilities. Thus, p replaces the effective nuclear charge of quantum mechanics and corresponds to the physical field of a resonant photon superimposed with the field of the proton. The case with p=1 is evaluated and compared with the experimental results for hydrogen species in Secs. IV.3 and IV.4, and the consequences that p=integer are considered in Sec. IV.9.

The background theory of classical quantum mechanics (CQM) for the physical solutions of hydrogen-type molecules and molecular ions is disclosed in R. Mills, The Grand Unified Theory of Classical Quantum Mechanics, January 2000 Edition, BlackLight Power, Inc., Cranbury, N.J., (“'00 Mills GUT”), provided by BlackLight Power, Inc., 493 Old Trenton Road, Cranbury, N.J., 08512; R. Mills, The Grand Unified Theory of Classical Quantum Mechanics, September 2001 Edition, BlackLight Power, Inc., Cranbury, N.J., Distributed by Amazon.com (“'01 Mills GUT”), provided by BlackLight Power, Inc., 493 Old Trenton Road, Cranbury, N.J., 08512; R. Mills, The Grand Unified Theory of Classical Quantum Mechanics, July 2004 Edition, BlackLight Power, Inc., Cranbury, N.J., (“'04 Mills GUT”), provided by BlackLight Power, Inc., 493 Old Trenton Road, Cranbury, N.J., 08512 (posted at www.blacklightpower.com); in prior PCT applications PCT/US02/35872; PCT/US02/06945; PCT/US02/06955; PCT/US01/09055; PCT/US01/25954; PCT/US00/20820; PCT/US00/20819; PCT/US00/09055; PCT/US99/17171; PCT/US99/17129; PCT/US98/22822; PCT/US98/14029; PCT/US96/07949; PCT/US94/02219; PCT/US91/08496; PCT/US90/01998; and PCT/US89/05037 and U.S. Pat. No. 6,024,935; the entire disclosures of which are all incorporated herein by reference; (hereinafter “Mills Prior Publications”).

### II. SUMMARY OF THE INVENTION

An object of the present invention is to solve the charge (mass) and current-density functions of hydrogen-type molecules and molecular ions from first principles. In an embodiment, the solution is derived from Maxwell's equations invoking the constraint that the bound electron does not radiate even though it undergoes acceleration.

Another objective of the present invention is to generate a readout, display, or image of the solutions so that the nature of the chemical bond can be better understood and potentially applied to predict reactivity and physical properties.

Another objective of the present invention is to apply the methods and systems of solving the nature of the chemical bond and its rendering to numerical or graphical form to molecules and ions other than hydrogen-types.

1. The Nature of the Chemical Bond

1.A. Dimensions of Hydrogen Molecular Ion

The hydrogen molecular ion charge and current density functions, bond distance, and energies are solved from the Laplacian in ellipsoidal coordinates with the constraint of nonradiation.

$$( η - ζ ) {R}_{ξ} \frac{\partial }{\partial ξ} ( {R}_{ξ} \frac{\partial ϕ}{\partial ξ} ) + ( ζ - ξ ) {R}_{η} \frac{\partial }{\partial η} ( {R}_{η} \frac{\partial ϕ}{\partial η} ) + ( ξ - η ) {R}_{ζ} \frac{\partial }{\partial ζ} ( {R}_{ζ} \frac{\partial ϕ}{\partial ζ} ) = 0 \qquad ( II .1 )$$

The force balance equation for the hydrogen molecular ion is

$$\begin{matrix}\frac{{ℏ}^{2}}{{m}_{e} {a}^{2} {b}^{2}} 2 {ab}^{2} X = \frac{{ⅇ}^{2}}{4 {πɛ}_{o}} X & ( II .2 ) \\ where & \\ X = \frac{1}{\sqrt{ξ + {a}^{2}}} \frac{1}{\sqrt{ξ + {b}^{2}}} \frac{1}{c} \sqrt{\frac{{ξ}^{2} - 1}{{ξ}^{2} - {η}^{2}}} & ( II .3 )\end{matrix}$$

Eq. (II.2) has the parametric solution
r(t)=ia cos ωt+jb sin ωt (II.4)
when the semimajor axis, a, is
a=2aₒ (II.5)
The internuclear distance, 2c′, which is the distance between the foci is
2c′=2aₒ (II.6)
The experimental internuclear distance is \sqrt{2}aₒ. The semiminor axis is
b=\sqrt{3}aₒ (II.7)
The eccentricity, e, is

$$e = \frac{1}{2} \qquad ( II .8 )$$

1.B. The Energies of the Hydrogen Molecular Ion

The potential energy of the electron in the central field of the protons at the foci is

$${V}_{e} = \frac{- 4 {ⅇ}^{2}}{8 {πɛ}_{o} \sqrt{{a}^{2} - {b}^{2}}} ln \frac{a + \sqrt{{a}^{2} + {b}^{2}}}{a - \sqrt{{a}^{2} - {b}^{2}}} = - 59.7575 eV \qquad ( II .9 )$$

The potential energy of the two protons is

$${V}_{p} = \frac{{ⅇ}^{2}}{8 {πɛ}_{o} {a}_{H }} = 13.5984 eV \qquad ( II .10 )$$

The kinetic energy of the electron is

$$T = \frac{2 {ℏ}^{2}}{{m}_{e} a \sqrt{{a}^{2} - {b}^{2}}} ln \frac{a + \sqrt{{a}^{2} + {b}^{2}}}{a - \sqrt{{a}^{2} - {b}^{2}}} = 29.8787 eV \qquad ( II .11 )$$

During bond formation, the electron undergoes a reentrant oscillatory orbit with vibration of the protons. The corresponding energy E̅_{osc} is the difference between the Doppler and average vibrational kinetic energies:

$${\overline{E}}_{osc} = {\overline{E}}_{D} + {\overline{E}}_{Kvib} = ( {V}_{e} + T + {V}_{p} ) \sqrt{\frac{2 {\overline{E}}_{K}}{{Mc}^{2}}} + \frac{1}{2} ℏ \sqrt{\frac{k}{μ}} \qquad ( II .12 )$$

The total energy is

$$\begin{matrix}{E}_{T} = {V}_{e} + T + {V}_{p} + {\overline{E}}_{osc} & ( II .13 ) \\ \begin{matrix}{E}_{T} = - \{ \begin{matrix}\frac{{ⅇ}^{2}}{8 π {e}_{o} {a}_{H}} ( \begin{matrix}\begin{matrix}4 ln 3 - \\ 1 -\end{matrix} \\ 2 ln 3\end{matrix} ) [ 1 + \sqrt{\frac{2 ℏ \sqrt{\frac{\frac{2 {ⅇ}^{2}}{4 {{pe}_{o} ( 2 {a}_{H} )}^{3}}}{{m}_{e}}}}{{m}_{e} {c}^{2}}} ] - \\ \frac{1}{ 2} ℏ \sqrt{ \frac{k}{ m}}\end{matrix} \} \\ = - 16.2803 eV - 0.11811 eV + \frac{1}{2} ( 0.29282 eV ) \\ = - 16.2527 eV\end{matrix} & ( II .14 )\end{matrix}$$

The energy of a hydrogen atom is
E(H)=−13.59844 eV (II.15)
The bond dissociation energy, E_{D}, is the difference between the total energy of the hydrogen atom (Eq. (II.15)) and E_{T} (Eq. (II.14)).
E_{D}=E(H)−E_{T}=2.654 eV (II.16)

2.A. Dimensions of Hydrogen

The hydrogen molecule charge and current density functions, bond distance, and energies are solved from the Laplacian in ellipsoidal coordinates with the constraint of nonradiation.

$$( η - ζ ) {R}_{ ξ} \frac{\partial }{\partial ξ} ( {R}_{ ξ} \frac{\partial ϕ}{\partial ξ} ) + ( ζ - ξ ) {R}_{ η} \frac{\partial }{\partial η} ( {R}_{ η} \frac{\partial ϕ}{\partial η} ) + ( ξ - η ) {R}_{ ζ} \frac{\partial }{\partial ζ} ( {R}_{ ζ} \frac{\partial ϕ}{\partial ζ} ) = 0 \qquad ( II .17 )$$

The force balance equation for the hydrogen molecule is

$$\begin{matrix}\frac{{ℏ}^{2}}{{m}_{e} {a}^{2} {b}^{2}} 2 {ab}^{2} X = \frac{{ⅇ}^{2}}{4 {πɛ}_{o}} X + \frac{{ℏ}^{2}}{2 {m}_{e} {a}^{2} {b}^{2}} 2 {ab}^{2} X & ( II .18 ) \\ where & \\ X = \frac{1}{\sqrt{ξ + {a}^{2}}} \frac{1}{\sqrt{ξ + {b}^{2}}} \frac{1}{c} \sqrt{\frac{{ξ}^{2} - 1}{{ξ}^{2} - {η}^{2}}} & ( II .19 )\end{matrix}$$

Eq. (II.18) has the parametric solution
r(t)=ia cos ωt+jb sin ωt (II.20)
when the semimajor axis, a, is
a=aₒ (II.21)
The internuclear distance, 2c′, which is the distance between the foci is
2c′=\sqrt{2}aₒ (II.22)
The experimental internuclear distance is \sqrt{2}aₒ. The semiminor axis is

$$b = \frac{1}{\sqrt{2}} {a}_{o} \qquad ( II .23 )$$

The eccentricity, e, is

$$e = \frac{1}{\sqrt{2}} \qquad ( II .24 )$$

2.B. The Energies of the Hydrogen Molecule

The potential energy of the two electrons in the central field of the protons at the foci is

$${V}_{e} = \frac{- 2 {ⅇ}^{2}}{8 {πɛ}_{o} \sqrt{{a}^{2} - {b}^{2}}} ln \frac{a + \sqrt{{a}^{2} - {b}^{2}}}{a - \sqrt{{a}^{2} - {b}^{2}}} = - 67.836 eV \qquad ( II .25 )$$

The potential energy of the two protons is

$${V}_{p} = \frac{{ⅇ}^{2}}{8 {πɛ}_{o} \sqrt{{a}^{2} - {b}^{2}}} = 19.242 eV \qquad ( II .26 )$$

The kinetic energy of the electrons is

$$T = \frac{{ℏ}^{2}}{2 {m}_{e} a \sqrt{{a}^{2} - {b}^{2}}} ln \frac{a + \sqrt{{a}^{2} - {b}^{2}}}{a - \sqrt{{a}^{2} - {b}^{2}}} = 33.918 eV \qquad ( II .27 )$$

The energy, Vₘ, of the magnetic force between the electrons is

$${V}_{m} = \frac{{ℏ}^{2}}{2 {m}_{e} a \sqrt{{a}^{2} - {b}^{2}}} ln \frac{a + \sqrt{{a}^{2} - {b}^{2}}}{a - \sqrt{{a}^{2} - {b}^{2}}} = - 16.959 eV \qquad ( II .28 )$$

During bond formation, the electrons undergo a reentrant oscillatory orbit with vibration of the protons. The corresponding energy E̅_{osc} is the difference between the Doppler and average vibrational kinetic energies:

$${\overline{E}}_{osc} = {\overline{E}}_{D} + {\overline{E}}_{Kvib} = ( {V}_{e} + T + {V}_{m} + {V}_{p} ) \sqrt{\frac{2 {\overline{E}}_{K}}{{Mc}^{2}}} + \frac{1}{2} ℏ \sqrt{\frac{k}{μ}} \qquad ( II .29 )$$

The total energy is

$$\begin{matrix}{E}_{T} = {V}_{e} + T + {V}_{m} + {V}_{p} + {\overline{E}}_{osc} \\ {E}_{T} = - \frac{{ⅇ}^{2}}{8 {πɛ}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + \sqrt{\frac{2 ℏ \sqrt{\frac{{ⅇ}^{2}}{\frac{4 {πɛ}_{o} {a}_{0}^{3}}{{m}_{e}}}}}{{m}_{e} {c}^{2}}} ] & ( II .30 ) \\ - \frac{1}{2} ℏ \sqrt{\frac{k}{μ}} = - 31.689 eV & ( II .31 )\end{matrix}$$

The energy of two hydrogen atoms is
E(2H[a_{H}])=−27.21 eV (II.32)
The bond dissociation energy, E_{D}, is the difference between the total energy of the corresponding hydrogen atoms (Eq. (II.32)) and E,. (Eq. (II.31)).
E_{D}=E(2H[a_{H}])−E_{T}=4.478 eV (II.33)
The experimental energy is E_{D}=4.478 eV. The calculated and experimental parameters of H₂, D₂, H₂⁺, and D₂⁺ from Sec. IV and Chp. 12 of Ref. [3] are given in TABLE I.

3. Hydrinos

A hydrogen atom having a binding energy given by

$$Binding Energy = \frac{13.6 eV}{{( \frac{1}{p} )}^{2}} \qquad ( II .34 )$$

where p is an integer greater than 1, preferably from 2 to 200, is disclosed in R. Mills, The Grand Unified Theory of Classical Quantum Mechanics, January 2000 Edition, BlackLight Power, Inc., Cranbury, N.J., Distributed by Amazon.com (“'00 Mills GUT”), provided by BlackLight Power, Inc., 493 Old Trenton Road, Cranbury, N.J., 08512; R. Mills, The Grand Unified Theory of Classical Quantum Mechanics, September 2001 Edition, BlackLight Power, Inc., Cranbury, N.J., Distributed by Amazon.com (“'01 Mills GUT”), provided by BlackLight Power, Inc., 493 Old Trenton Road, Cranbury, N.J., 08512 R. Mills, The Grand Unified Theory of Classical Quantum Mechanics, July, 2004 Edition posted at www.blacklightpower.com (“'04 Mills GUT”).

With regard to the Hydrino Theory—BlackLight Process section of '04 Mills GUT, the possibility of states with n=1/p is also predicted in the case of hydrogen molecular species wherein H(1/p) reacts a proton or two H(1/p) atoms react to form H₂⁺(1/p) and H₂(1/p), respectively. The natural molecular-hydrogen coordinate system based on symmetry is elliptic coordinates. The magnitude of the central field in the derivations of molecular hydrogen species is taken as the general parameter p wherein p may be an integer which may be predictive of new possibilities. Thus, p replaces the effective nuclear charge of quantum mechanics and corresponds to the physical field of a resonant photon superimposed with the field of the proton. The case with p=1 is evaluated and compared with the experimental results for hydrogen species in TABLE I, and the consequences that p=integer are considered in the Nuclear Magnetic Resonance Shift section.

Two hydrogen atoms react to form a diatomic molecule, the hydrogen molecule.
2H[a_{H}]→H₂[2c′=\sqrt{2}aₒ] (II.35)
where 2c′ is the internuclear distance. Also, two hydrino atoms react to form a diatomic molecule, a dihydrino molecule.

$$2 H [ \frac{{a}_{H}}{p} ] \to {H}_{2} [ 2 {c}^{′} = \frac{\sqrt{2} {a}_{o}}{p} ] \qquad ( II .36 )$$

where p is an integer.

Hydrogen molecules form hydrogen molecular ions when they are singly ionized.
H₂[2c′=\sqrt{2}aₒ]→H₂[2c′=2aₒ]⁺+e− (II.37)

Also, dihydrino molecules form dihydrino molecular ions when they are singly ionized.

$${H}_{2} [ 2 {c}^{′} = \frac{\sqrt{2} {a}_{o}}{p} ] \to {{H}_{2} [ 2 {c}^{′} = \frac{2 {a}_{o}}{p} ]}^{+} + e - \qquad ( II .38 )$$

3.A. Dimensions of Hydrogen Molecular Ion H₂⁺(1/p)

To obtain the parameters of H₂⁺(1/p), the Laplacian in ellipsoidal coordinates (Eq. (II.1)) is solved with the constraint of nonradiation. The force balance equation for the hydrogen molecular ion H₂⁺(1/p) having a central field of +pe at each focus of the prolate spheroid molecular orbital is

$$\begin{matrix}\frac{{ℏ}^{2}}{{m}_{e} {a}^{2} {b}^{2}} 2 {ab}^{2} X = \frac{p {e}^{2}}{4 {πɛ}_{o}} X \\ where & ( II .39 ) \\ X = \frac{1}{\sqrt{ξ + {a}^{2}}} \frac{1}{\sqrt{ξ + {b}^{2}}} \frac{1}{c} \sqrt{\frac{{ξ}^{2} - 1}{{ξ}^{2} - {η}^{2}}} & ( II .40 )\end{matrix}$$

Eq. (II.39) has the parametric solution
r(t)=ia cos ωt+jb sin ωt (II.41)
when the semimajor axis, a, is

$$a = \frac{2 {a}_{0}}{p} \qquad ( II .42 )$$

The internuclear distance, 2c′, which is the distance between the foci is

$$2 {c}^{′} = \frac{2 {a}_{o}}{p} \qquad ( II .43 )$$

The semiminor axis is

$$b = \frac{\sqrt{3}}{p} {a}_{o} \qquad ( II .44 )$$

The eccentricity, e, is

$$e = \frac{1}{2} \qquad ( II .45 )$$

3.B. The Energies of the Hydrogen Molecular Ion H₂⁺(1/p)

The potential energy of the electron in the central field of +pe at the foci is

$${V}_{e} = \frac{- 4 {p}^{2} {e}^{2}}{8 {πɛ}_{o} {a}_{o}} ln 3 \qquad ( II .46 )$$

The potential energy of the two protons is

$${V}_{p} = \frac{ {p}^{2} {e}^{2}}{8 {πɛ}_{o} {a}_{o}} \qquad ( II .47 )$$

The kinetic energy of the electron is

$$T = \frac{2 {p}^{2} {ⅇ}^{2}}{8 {πɛ}_{o} {a}_{o}} ln 3 \qquad ( II .48 )$$

During bond formation, the electron undergoes a reentrant oscillatory orbit with vibration of the protons. The corresponding energy E̅_{osc} is the difference between the Doppler and average vibrational kinetic energies:

$$\begin{matrix}{\overline{E}}_{osc} = {\overline{E}}_{D} + {\overline{E}}_{Kvib} \\ = ( {V}_{e} + T + {V}_{p} ) \sqrt{\frac{2 {\overline{E}}_{K}}{M {c}^{2}}} + \frac{1}{2} ℏ {p}^{2} \sqrt{\frac{k}{μ}} \\ = - {p}^{3} 0.118755 eV + \frac{1}{2} {p}^{2} ( 0.29282 eV )\end{matrix} \qquad ( II .49 )$$

The total energy of the hydrogen molecular ion having a central field of +pe at each focus of the prolate spheroid molecular orbital is

$$\begin{matrix}{E}_{T} = {V}_{e} + T + {V}_{p} + {\overline{E}}_{osc} & ( II .50 ) \\ \begin{matrix}{E}_{T} = - {p}^{2} \{ \frac{{e}^{2}}{8 {πɛ}_{o} {a}_{H}} ( 4 ln 3 - 1 - 2 ln 3 ) [ 1 + p \sqrt{\frac{2 ℏ \sqrt{\frac{\frac{2 {e}^{2}}{4 {{πɛ}_{o} ( 2 {a}_{H} )}^{3}}}{{m}_{e}}}}{{m}_{e} {c}^{2}}} ] - \frac{1}{2} ℏ \sqrt{\frac{k}{μ}} \} \\ = - {p}^{2} 16.13392 eV - {p}^{3} 0.118755 eV\end{matrix} & ( II .51 )\end{matrix}$$

The energy of a hydrogen atom H(1/p) is
E(H(1/p))=−p²13.59844 eV (II.52)
The bond dissociation energy, E_{D}, is the difference between the total energy of the hydrogen atom H(1/p) (Eq. (II.52)) and E_{T} (Eq. (II.51)).

$$\begin{matrix}{E}_{D} = - {p}^{2} 13.59844 - {E}_{T} \\ = - {p}^{2} 13.59844 - ( - {p}^{2} 16.13392 eV - {p}^{3} 0.118755 eV ) \\ = {p}^{2} 2.535 eV + {p}^{3} 0.118755 eV\end{matrix} \qquad ( II .53 )$$

4.A. Dimensions of Hydrogen H₂(1/p)

To obtain the parameters of H₂ (1/p), the Laplacian in ellipsoidal coordinates (Eq. (II.1)) is solved with the constraint of nonradiation. The force balance equation for the hydrogen molecule H₂(1/p) having a central field of +pe at each focus of the prolate spheroid molecular orbital is

$$\begin{matrix}\frac{{ℏ}^{2}}{{m}_{e} {a}^{2} {b}^{2}} 2 {ab}^{2} X = \frac{p {ⅇ}^{2}}{4 {πɛ}_{o}} X + \frac{{ℏ}^{2}}{2 {m}_{e} {a}^{2} {b}^{2}} 2 {ab}^{2} X \\ where & ( II .54 ) \\ X = \frac{1}{\sqrt{ξ + {a}^{2}}} \frac{1}{\sqrt{ξ + {b}^{2}}} \frac{1}{c} \sqrt{\frac{{ξ}^{2} - 1}{{ξ}^{2} - {η}^{2}}} & ( II .55 )\end{matrix}$$

Eq. (II.54) has the parametric solution
r(t)=ia cos ωt+jb sin ωt (II.56)
when the semimajor axis, a, is

$$a = \frac{{a}_{0}}{p} \qquad ( II .57 )$$

The internuclear distance, 2c′, which is the distance between the foci is

$$2 {c}^{′} = \frac{\sqrt{2}}{p} {a}_{o} \qquad ( II .58 )$$

The semiminor axis is

$$b = {c}^{′} = \frac{1}{p \sqrt{2}} {a}_{o} \qquad ( II .59 )$$

The eccentricity, e, is

$$e = \frac{1}{\sqrt{2}} \qquad ( II .60 )$$

4.B. The Energies of the Hydrogen Molecule H₂ (1/p)

The potential energy of the two electrons in the central field of +pe at the foci is

$${V}_{e} = \frac{- 2 p {ⅇ}^{2}}{8 {πɛ}_{o} \sqrt{{a}^{2} - {b}^{2}}} ln \frac{a + \sqrt{{a}^{2} - {b}^{2}}}{a - \sqrt{{a}^{2} - {b}^{2}}} \qquad ( II .61 )$$

The potential energy of the two protons is

$${V}_{p} = \frac{p}{8 {πɛ}_{o}} \frac{{ⅇ}^{2}}{\sqrt{{a}^{2} - {b}^{2}}} \qquad ( II .62 )$$

The kinetic energy of the electrons is

$$T = \frac{{ℏ}^{2}}{2 {m}_{e} a \sqrt{{a}^{2} - {b}^{2}}} ln \frac{a + \sqrt{{a}^{2} - {b}^{2}}}{a - \sqrt{{a}^{2} - {b}^{2}}} \qquad ( II .63 )$$

The energy, Vₘ, of the magnetic force between the electrons is

$${V}_{m} = \frac{- {ℏ}^{2}}{4 {m}_{e} a \sqrt{{a}^{2} - {b}^{2}}} ln \frac{a + \sqrt{{a}^{2} - {b}^{2}}}{a - \sqrt{{a}^{2} - {b}^{2}}} \qquad ( II .64 )$$

During bond formation, the electrons undergo a reentrant oscillatory orbit with vibration of the protons. The corresponding energy E̅_{osc} is the difference between the Doppler and average vibrational kinetic energies:

$$\begin{matrix}{\overline{E}}_{osc} = {\overline{E}}_{D} + {\overline{E}}_{Kvib} \\ = ( {V}_{e} + T + {V}_{p} ) \sqrt{\frac{2 {\overline{E}}_{K}}{M {c}^{2}}} + \frac{1}{2} {ℏ}^{2} \frac{k}{μ} \\ = - {p}^{3} 0.118755 eV + \frac{1}{2} {p}^{2} ( 0.29282 eV )\end{matrix} \qquad ( II .49 )$$

The total energy of the hydrogen molecule having a central field of +pe at each focus of the prolate spheroid molecular orbital is

$$\begin{matrix}{E}_{T} = {V}_{e} + T + {V}_{p} + {\overline{E}}_{osc} & ( II .50 ) \\ \begin{matrix}{E}_{T} = - {p}^{2} \{ \frac{{ⅇ}^{2}}{8 {πɛ}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + p \sqrt{2 ℏ \frac{\sqrt{\frac{\frac{{ⅇ}^{2}}{4 {{πɛ}_{o} ( 2 {a}_{H} )}^{3}}}{{m}_{e}}}}{{m}_{e} {c}^{2}}} ] - \frac{1}{2} ℏ \sqrt{\frac{k}{μ}} \} \\ = - {p}^{2} 16.13392 eV - {p}^{3} 0.118755 eV\end{matrix} & ( II .51 )\end{matrix}$$

The energy of two hydrogen atoms H(1/p) is
E(2H(1/p))=−p²27.20 eV (II.68)
The bond dissociation energy, E_{D}, is the difference between the total energy of the corresponding hydrogen atoms (Eq. (II.68)) and E_{T} (Eq. (II.67)).

$$\begin{matrix}{E}_{D} = E ( 2 H ( 1 / p ) ) - {E}_{T} \\ = - {p}^{2} 27.20 eV - {E}_{T} \\ = - {p}^{2} 27.20 eV - ( - {p}^{2} 31.351 eV - {p}^{3} 0.326469 eV ) \\ = {p}^{2} 4.151 eV + {p}^{3} 0.326469 eV\end{matrix} \qquad ( II .69 )$$

In an embodiment, the physical, Maxwellian solutions for the dimensions and energies of hydrogen-type molecules and molecular ions are processed with a processing means to produce an output. Embodiments of the system for performing computing and rendering of the nature of the chemical bond using the physical solutions may comprise a general purpose computer. Such a general purpose computer may have any number of basic configurations. For example, such a general purpose computer may comprise a central processing unit (CPU), one or more specialized processors, system memory, a mass storage device such as a magnetic disk, an optical disk, or other storage device, an input means such as a keyboard or mouse, a display device, and a printer or other output device. A system implementing the present invention can also comprise a special purpose computer or other hardware system and all should be included within its scope.

### III. BRIEF DESCRIPTION OF THE DRAWINGS

FIG. 1A is a prolate spheroid molecular orbital in accordance with the present invention, and

FIGS. 1B and 1C are a cross section of the prolate spheroid molecular orbital showing the parameters of molecules and molecular ions in accordance with the present invention where, a is the semimajor axis, 2a is the total length of the molecule or molecular ion along the principal axis, b=c is the semiminor axis 2b=2c is the total width of the molecule or molecular ion along the minor axis, c′ is the distance from the origin to a focus (nucleus), and 2c′ is the internuclear distance.

### IV. DETAILED DESCRIPTION OF THE INVENTION

The following preferred embodiments of the invention disclose numerous calculations which are merely intended as illustrative examples. Based on the detailed written description, one skilled in the art would easily be able to practice this invention within other like calculations to produce the desired result without undue effort.

1. Hydrogen-Type Molecular Ions

Each hydrogen-type molecular ion comprises two protons and an electron where the equation of motion of the electron is determined by the central field which is p times that of a proton at each focus (p is one for the hydrogen molecular ion, and p is an integer greater than one for each H₂⁺(1/p), called dihydrino molecular ion). The differential equations of motion in the case of a central field are [72]
m(\ddot{r}−r\dot{θ}²)=f(r) (15)
m(2\dot{r}\dot{θ}+r\ddot{θ})=0 (16)
The second or transverse equation, Eq. (16), gives the result that the angular momentum is constant.
r²\dot{θ}=constant=L/m (17)
where L is the angular momentum ( [symbol] in the case of the electron). The central force equations can be transformed into an orbital equation by the substitution,

$$u = \frac{1}{r} .$$

The differential equation of the orbit of a particle moving under a central force is

$$\frac{{δ}^{2} u}{{δθ}^{2}} + u = \frac{- 1}{\frac{m {L}^{2} {u}^{2}}{{m}^{2}}} f ( {u}^{- 1} ) \qquad ( 18 )$$

Because the angular momentum is constant, motion in only one plane need be considered; thus, the orbital equation is given in polar coordinates. The solution of Eq. (18) for an inverse-squared force

$$\begin{matrix}f ( r ) = - \frac{k}{{r}^{2}} \\ is & ( 19 ) \\ r = {r}_{0} \frac{1 + e}{1 + e cos θ} & ( 20 ) \\ e = A \frac{m \frac{{L}^{2}}{{m}^{2}}}{k} & ( 21 ) \\ {r}_{0} = \frac{m \frac{{L}^{2}}{{m}^{2}}}{k ( 1 + e )} & ( 22 )\end{matrix}$$

where e is the eccentricity of the ellipse and A is a constant. The equation of motion due to a central force can also be expressed in terms of the energies of the orbit. The square of the speed in polar coordinates is
v²=(\dot{r}²+r²\dot{θ}²) (23)
Since a central force is conservative, the total energy, E, is equal to the sum of the kinetic, T, and the potential, V, and is constant. The total energy is

$$\frac{1}{2} m ( {\dot{r}}^{2} + {r}^{2} {\dot{θ}}^{2} ) + V ( r ) = E = constant \qquad ( 24 )$$

Substitution of the variable

$$u = \frac{1}{r}$$

and Eq. (17) into Eq. (24) gives the orbital energy equation.

$$\frac{1}{2} m \frac{{L}^{2}}{{m}^{2}} ( ( \frac{{δ}^{2} u}{{θθ}^{2}} ) + {u}^{2} ) + V ( {u}^{- 1} ) = E \qquad ( 25 )$$

Because the potential energy function, V(r), for an inverse-squared force field is

$$V ( r ) = - \frac{k}{r} = - ku \qquad ( 26 )$$

the energy equation of the orbit, Eq. (25),

$$\frac{1}{2} m \frac{{L}^{2}}{{m}^{2}} ( ( \frac{{δ}^{2} u}{δ {θ}^{2}} ) + {u}^{2} ) - ku = E \qquad ( 27 )$$

which has the solution

$$r = \frac{m \frac{{L}^{2}}{{m}^{2}} {k}^{- 1}}{1 + {( 1 + 2 Em \frac{{L}^{2}}{{m}^{2}} {k}^{- 2} )}^{1 / 2} cos θ} \qquad ( 28 )$$

where the eccentricity, e, is

$$e = {( 1 + 2 E m \frac{{L}^{2}}{{m}^{2}} {k}^{- 2} )}^{1 / 2} \qquad ( 29 )$$

Eq. (29) permits the classification of the orbits according to the total energy, E, as follows:

E<0, e<1 closed orbits (ellipse or circle)

E=0, e=1 parabolic orbit

E>0, e>1 hyperbolic orbit

Since E=T+V and is constant, the closed orbits are those for which T<|V|, and the open orbits are those for which T≧|V|. It can be shown that the time average of the kinetic energy, <T>, for elliptic motion in an inverse-squared field is ½ that of the time average of the potential energy, <V>. <T>=½<V>.

As demonstrated in the One Electron Atom section of Ref. [5], the electric inverse-squared force is conservative; thus, the angular momentum of the electron, [symbol] , and the energy of atomic orbitals called “orbitspheres” are constant. In addition, the orbitspheres are nonradiative when the boundary condition is met.

The central force equation, Eq. (24), has orbital solutions which are circular, elliptic, parabolic, or hyperbolic. The former two types of solutions are associated with atomic and molecular orbitals. These solutions are nonradiative. The boundary condition for nonradiation given in the One Electron Atom section of Ref. [5], is the absence of components of the space-time Fourier transform of the charge-density function synchronous with waves traveling at the speed of light. The boundary condition is met when the velocity for the charge density at every coordinate position on the orbitsphere is

$${v}_{n} = \frac{ℏ}{{m}_{e} {r}_{n}} \qquad ( 30 )$$

The allowed velocities and angular frequencies are related to rₙ by

$$\begin{matrix}{v}_{n} = {r}_{n} {ω}_{n} & ( 31 ) \\ {ω}_{n} = \frac{ℏ}{{m}_{e} {r}_{n}^{2}} & ( 32 )\end{matrix}$$

As demonstrated in the One Electron Atom section of Ref. [5] and by Eq. (32), this condition is met for the product function of a radial Dirac delta function and a time harmonic function where the angular frequency, ω, is constant and given by Eq. (32).

$${ω}_{n} = \frac{ℏ}{{m}_{e} {r}_{n}^{2}} = \frac{\frac{π L}{{m}_{e}}}{A} \qquad ( 33 )$$

where L is the angular momentum and A is the area of the closed geodesic orbit. Consider the solution of the central force equation comprising the product of a two-dimensional ellipsoid and a time harmonic function. The spatial part of the product function is the convolution of a radial Dirac delta function with the equation of an ellipsoid. The Fourier transform of the convolution of two functions is the product of the individual Fourier transforms of the functions; thus, the boundary condition is met for an ellipsoidal-time harmonic function when

$${ω}_{n} = \frac{πℏ}{{m}_{e} A} = \frac{ℏ}{{m}_{e} a b} \qquad ( 34 )$$

where the area of an ellipse is
A=πab (35)
where 2b is the length of the semiminor axis and 2a is the length of the semimajor axis¹. The geometry of molecular hydrogen is elliptic with the internuclear axis as the principal axis; thus, the electron orbital is a two-dimensional ellipsoidal-time harmonic function. The mass follows geodesics time harmonically as determined by the central field of the protons at the foci. Rotational symmetry about the internuclear axis further determines that the orbital is a prolate spheroid. In general, ellipsoidal orbits of molecular bonding, hereafter referred to as ellipsoidal molecular orbitals (MOs), have the general equation

$$\frac{{x}^{2}}{{a}^{2}} + \frac{{y}^{2}}{{b}^{2}} + \frac{{z}^{2}}{{c}^{2}} = 1 \qquad ( 36 )$$

The semiprincipal axes of the ellipsoid are a, b, c.
¹In addition to nonradiation, the angular frequency given by Eq. (34) corresponds to a Lorentzian invariant magnetic moment of a Bohr magneton, μ_{B}, as given in Sec. VIII. The internal field is uniform along the semiminor axis, and the far field is that of a dipole as shown in Sec. VIII.

In ellipsoidal coordinates, the Laplacian is

$$\begin{matrix}( η - ζ ) {R}_{ξ} \frac{\partial }{\partial ξ} ( {R}_{ξ} \frac{\partial ϕ}{\partial ξ} ) + ( ζ - ξ ) {R}_{η} \frac{\partial }{\partial η} ( {R}_{η} \frac{\partial ϕ}{\partial η} ) + \\ ( ξ - η ) {R}_{ζ} \frac{\partial }{\partial ζ} ( {R}_{ζ} \frac{\partial ϕ}{\partial ζ} ) = 0\end{matrix} \qquad ( 37 )$$

An ellipsoidal MO is equivalent to a charged perfect conductor (i.e. no dissipation to current flow) whose surface is given by Eq. (36). It is a two-dimensional equipotential membrane where each MO is supported by the outward centrifugal force due to the corresponding angular velocity which conserves its angular momentum of [symbol] . It satisfies the boundary conditions for a discontinuity of charge in Maxwell's equations, Eq. (12). It carries a total charge q, and it's potential is a solution of the Laplacian in ellipsoidal coordinates, Eq. (37).

Excited states of orbitspheres are discussed in the Excited States of the One Electron Atom (Quantization) section of Ref. [5]. In the case of ellipsoidal MOs, excited electronic states are created when photons of discrete frequencies are trapped in the ellipsoidal resonator cavity of the MO The photon changes the effective charge at the MO surface where the central field is ellipsoidal and arises from the protons and the effective charge of the “trapped photon” at the foci of the MO Force balance is achieved at a series of ellipsoidal equipotential two-dimensional surfaces confocal with the ground state ellipsoid. The “trapped photons” are solutions of the Laplacian in ellipsoidal coordinates, Eq. (37).

As is the case with the orbitsphere, higher and lower energy states are equally valid. The photon standing wave in both cases is a solution of the Laplacian in ellipsoidal coordinates. For an ellipsoidal resonator cavity, the relationship between an allowed circumference, 4aE, and the photon standing wavelength, λ, is
4aE=nλ (38)
where n is an integer and where

$$k = \frac{\sqrt{{a}^{2} - {b}^{2}}}{a} \qquad ( 39 )$$

is used in the elliptic integral, E, of Eq. (38). Applying Eqs. (38) and (39), the relationship between an allowed angular frequency given by Eq. (34) and the photon standing wave angular frequency, ω, is:

$$\frac{π ℏ}{{m}_{e} A} = \frac{ℏ}{{m}_{e} n {a}_{1} n {b}_{1}} = \frac{ℏ}{{m}_{e} {a}_{n} {b}_{n}} = \frac{1}{{n}^{2}} {ω}_{1} = {ω}_{n} \qquad ( 40 )$$

where n=1,2,3,4, . . .

$$n = \frac{1}{2} , \frac{1}{3} , \frac{1}{4} , …$$

ω₁ is the allowed angular frequency for n=1
a₁ and b₁ are the allowed semimajor and semiminor axes for n=1

The potential, φ, and distribution of charge, σ, over the conducting surface of an ellipsoidal MO are sought given the conditions: 1.) the potential is equivalent to that of a charged ellipsoidal conductor whose surface is given by Eq. (36), 2.) it carries a total charge q, and 3.) initially there is no external applied field. To solve this problem, a potential function must be found which satisfies Eq. (37), which is regular at infinity, and which is constant over the given ellipsoid. The solution is well known and is given after Stratton [73]. Consider that the Laplacian is solved in ellipsoidal coordinates wherein ξ is the parameter of a family of ellipsoids all confocal with the standard surface ξ=0 whose axes have the specified values a, b, c. The variables ζ and η are the parameters of confocal hyperboloids and as such serve to measure position on any ellipsoid ξ=constant. On the surface ξ=0; therefore, φ must be independent of ζ and η. Due to the uniqueness property of solutions of the Laplacian, a function which satisfies Eq. (37), behaves properly at infinity, and depends only on ξ, can be adjusted to represent the potential correctly at any point outside the ellipsoid ξ=0.

Thus, it is assumed that φ=φ(ξ). Then, the Laplacian reduces to

$$\frac{δ}{δ ξ} ( {R}_{ξ} \frac{\partial ϕ}{\partial ξ} ) = 0 \\ {R}_{ξ} = \sqrt{( ξ + {a}^{2} ) ( ξ + {b}^{2} ) ( ξ + {c}^{2} )} \qquad ( 41 )$$

which on integration leads to

$$ϕ ( ξ ) = {C}_{1} {\int }_{ξ}^{∞} \frac{δ ξ}{{R}_{ξ}} \qquad ( 42 )$$

where C₁ is an arbitrary constant. The upper limit is selected to ensure the proper behavior at infinity. When ξ becomes very large, R_{ξ} approaches ξ^{3/2} and

$$ϕ \sim \frac{2 C}{\sqrt{ξ}} ( ξ \to ∞ ) \qquad ( 43 )$$

Furthermore, the equation of an ellipsoid can be written in the form

$$\frac{{x}^{2}}{1 + \frac{{a}^{2}}{ξ}} + \frac{{y}^{2}}{1 + \frac{{b}^{2}}{ξ}} + \frac{{z}^{2}}{1 + \frac{{c}^{2}}{ξ}} = ξ \qquad ( 44 )$$

If r²=x²+y²+z² is the distance from the origin to any point on the ellipsoid ξ, it is apparent that as ξ becomes very large ξ→r². Thus, at great distances from the origin, the potential becomes that of a point charge at the origin:

$$ϕ \sim \frac{2 {C}_{1}}{r} \qquad ( 45 )$$

The solution Eq. (32) is, therefore, regular at infinity, and the constant C₁ is then determined. It has been shown by Stratton [73] that whatever the distribution, the dominant term of the expansion at remote points is the potential of a point charge at the origin equal to the total charge of the distribution—in this case q. Hence

$${C}_{1} = \frac{q}{8 π {ɛ}_{o}} ,$$

and the potential at any point is

$$ϕ ( ξ ) = \frac{q}{8 π {ɛ}_{o}} {\int }_{ξ}^{∞} \frac{\partial ξ}{{R}_{ξ}} \qquad ( 46 )$$

The equipotential surfaces are the ellipsoids ξ=constant. Eq. (46) is an elliptic integral and its values have been tabulated [74].

Since the distance along a curvilinear coordinate u¹ is measured not by du¹ but by h₁du¹, the normal derivative in ellipsoidal coordinates is given by

$$\begin{matrix}\frac{δ ϕ}{δ n} = \frac{1}{{h}_{1}} \frac{δ ϕ}{δ ξ} = \frac{- q}{4 π {ɛ}_{o}} \frac{1}{\sqrt{( ξ - η ) ( ξ - ζ )}} \\ where & ( 47 ) \\ {h}_{1} = \frac{1}{2} \frac{\sqrt{( ξ - η ) ( ξ - ζ )}}{{R}_{ξ}} & ( 48 )\end{matrix}$$

The density of charge, σ, over the surface ξ=0 is

$$σ = {{ɛ}_{o} ( \frac{δ ϕ}{δ n} )}_{ξ = 0} = \frac{q}{4 π \sqrt{ηζ}} \qquad ( 49 )$$

Defining x, y, z in terms of ξ, η, we put ξ=0, it may be easily verified that

$$\frac{{x}^{2}}{{a}^{4}} + \frac{{y}^{2}}{{b}^{4}} + \frac{{z}^{2}}{{c}^{4}} = \frac{ζ η}{{a}^{2} {b}^{2} {c}^{2}} ( ξ = 0 ) \qquad ( 50 )$$

Consequently, the charge density in rectangular coordinates is

$$σ = \frac{q}{4 π a b c} \frac{1}{\sqrt{\frac{{x}^{2}}{{a}^{4}} + \frac{{y}^{2}}{{b}^{4}} + \frac{{z}^{2}}{{c}^{4}}}} \qquad ( 51 )$$

(The mass-density function of an MO is equivalent to its charge-density function where m replaces q of Eq. (51)). The equation of the plane tangent to the ellipsoid at the point x₀, y₀, z₀ is

$$X \frac{{x}_{0}}{{a}^{2}} + Y \frac{{y}_{0}}{{b}^{2}} + Z \frac{{z}_{0}}{{c}^{2}} = 1 \qquad ( 52 )$$

where X, Y, Z are running coordinates in the plane. After dividing through by the square root of the sum of the squares of the coefficients of X, Y, and Z, the right member is the distance D from the origin to the tangent plane. That is,

$$\begin{matrix}D = \frac{1}{\sqrt{\frac{{x}^{2}}{{a}^{4}} + \frac{{y}^{2}}{{b}^{4}} + \frac{{z}^{2}}{{c}^{4}}}} \\ so that & ( 53 ) \\ σ = \frac{q}{4 π a b c} D & ( 54 )\end{matrix}$$

In other words, the surface density at any point on a charged ellipsoidal conductor is proportional to the perpendicular distance from the center of the ellipsoid to the plane tangent to the ellipsoid at the point. The charge is thus greater on the more sharply rounded ends farther away from the origin.

In the case of hydrogen-type molecules and molecular ions, rotational symmetry about the internuclear axis requires that two of the axes be equal. Thus, the MO is a spheroid, and Eq. (46) can be integrated in terms of elementary functions. If a>b=c, the spheroid is prolate, and the potential is given by

$$ϕ = \frac{1}{8 π {ɛ}_{o}} \frac{q}{\sqrt{{a}^{2} - {b}^{2}}} ln \frac{\sqrt{ξ + {a}^{2}} + \sqrt{{a}^{2} - {b}^{2}}}{\sqrt{ξ + {a}^{2}} - \sqrt{{a}^{2} - {b}^{2}}} \qquad ( 55 )$$

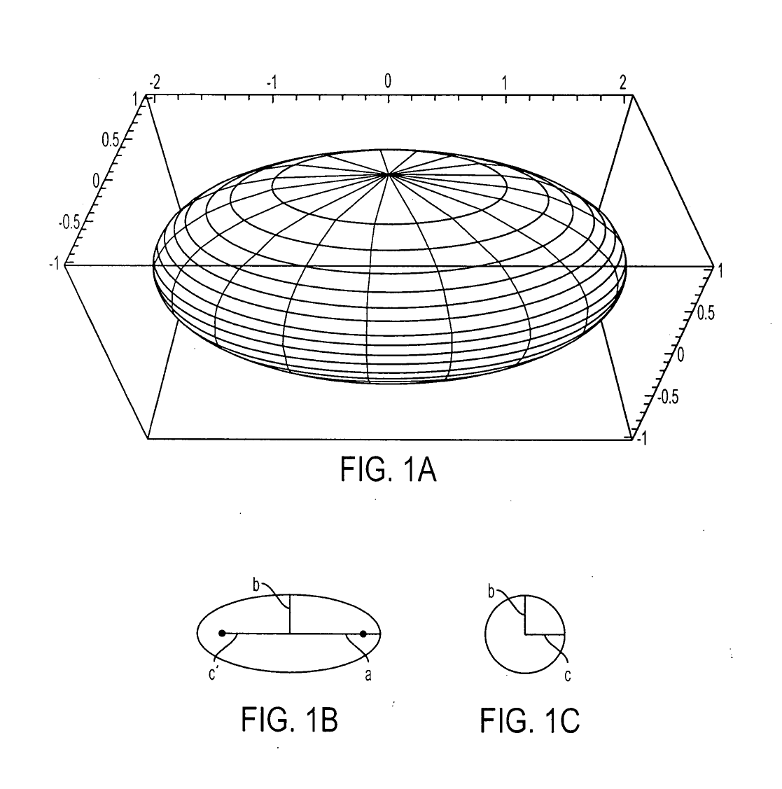

A prolate spheroid MO and the definition of axes are shown in FIGS. 1A and 1B, respectively.

1.A. Spheroidal Force Equations

1.A.a. Electric Force

The spheroidal MO is a two-dimensional surface of constant potential given by Eq. (55) for ξ=0. For an isolated electron MO the electric field inside is zero as given by Gauss' Law

$${\int }_{S} E ⅆ A = {\int }_{V} \frac{ρ}{{ɛ}_{o}} ⅆ V \qquad ( 56 )$$

where the charge density, ρ, inside the MO is zero. Gauss' Law at a two-dimensional surface with continuity of the potential across the surface according to Faraday's law in the electrostatic limit [43-45] is

$$n \cdot ( {E}_{1} - {E}_{2} ) = \frac{σ}{{ɛ}_{0}} \qquad ( 57 )$$

E₂ is the electric field inside which is zero. The electric field of an ellipsoidal MO is given by substituting σ given by Eq. (47) and Eq. (49) into Eq. (57).

$$E = \frac{σ}{{ɛ}_{o}} = \frac{q}{4 π {ɛ}_{o}} \frac{1}{\sqrt{( ξ - η ) ( ξ - ζ )}} \qquad ( 58 )$$

The electric field in spheroid coordinates is

$$E = \frac{q}{8 π {ɛ}_{o}} \frac{1}{\sqrt{ξ + {a}^{2}}} \frac{1}{\sqrt{ξ + {b}^{2}}} \frac{1}{c} \sqrt{\frac{{ξ}^{2} - 1}{{ξ}^{2} - {η}^{2}}} \qquad ( 59 )$$

From Eq. (40), the magnitude of the elliptic field corresponding to a below “ground state” hydrogen-type molecular ion is an integer. The integer is one in the case of the hydrogen molecular ion and an integer greater than one in the case of each dihydrino molecular ion. The central electric force from the two protons, Fₑ, is

$${F}_{e} = ZeE = \frac{p 2 {e}^{2}}{8 π {ɛ}_{o}} \frac{1}{\sqrt{ξ + {a}^{2}}} \frac{1}{\sqrt{ξ + {b}^{2}}} \frac{1}{c} \sqrt{\frac{{ξ}^{2} - 1}{{ξ}^{2} - {η}^{2}}} \qquad ( 60 )$$

where p is one for the hydrogen molecular ion, and p is an integer greater than one for each dihydrino molecule and molecular ion.

1.A.b. Centrifugal Force

Each point or coordinate position on the continuous two-dimensional electron MO defines an infinitesimal mass-density element which moves along a geodesic orbit of a spheroidal MO in such a way that its eccentric angle, θ, changes at a constant rate. That is θ=ωt at time t where ω is a constant, and
r(t)=ia cos ωt+jb sin ωt (61)
is the parametric equation of the ellipse of the geodesic. If a(t) denotes the acceleration vector, then
a(t)=−ω²r(t) (62)
In other words, the acceleration is centripetal as in the case of circular motion with constant angular speed, ω. The centripetal force, F_{c}, is
F_{c}=ma=−mω²r(t) (63)
Recall that nonradiation results when ω=constant given by Eq. (40). Substitution of ω given by Eq. (40) into Eq. (63) gives

$${F}_{c} = \frac{- {ℏ}^{2}}{{m}_{e} {a}^{2} {b}^{2}} r ( t ) = \frac{- {ℏ}^{2}}{{m}_{e} {a}^{2} {b}^{2}} D \qquad ( 64 )$$

where D is the distance from the origin to the tangent plane as given by Eq. (53). If X is defined as follows

$$X = \frac{1}{\sqrt{ξ + {a}^{2}}} \frac{1}{\sqrt{ξ + {b}^{2}}} \frac{1}{c} \sqrt{\frac{{ξ}^{2} - 1}{{ξ}^{2} - {η}^{2}}} \qquad ( 65 )$$

then it follows from Eqs. (47), (54), (58), and (60) that
D=2ab²X (66)

1.B. Force Balance of Hydrogen-Type Molecular Ions

Force balance between the electric and centrifugal forces is

$$\frac{{ℏ}^{2}}{{m}_{e} {a}^{2} {b}^{2}} 2 {ab}^{2} X = \frac{{pe}^{2}}{4 π {ɛ}_{o}} X \qquad ( 67 )$$

which has the parametric solution given by Eq. (61) when

$$a = \frac{2 {a}_{0}}{p} \qquad ( 68 )$$

1.C. Energies of Hydrogen-Type Molecular Ions

From Eq. (40), the magnitude of the elliptic field corresponding to a below “ground state” hydrogen-type molecule is an integer, p. The potential energy, Vₑ, of the electron MO in the field of magnitude p times that of the protons at the foci (ξ=0) is

$$\begin{matrix}{V}_{e} = \frac{- 4 {pe}^{2}}{8 π {ɛ}_{o} \sqrt{{a}^{2} - {b}^{2}}} ln \frac{a + \sqrt{{a}^{2} - {b}^{2}}}{a - \sqrt{{a}^{2} - {b}^{2}}} \\ where & ( 69 ) \\ \sqrt{{a}^{2} - {b}^{2}} = {c}^{′} & ( 70 )\end{matrix}$$

2c′ is the distance between the foci which is the internuclear distance. The kinetic energy, T, of the electron MO is given by the integral of the left side of Eq. (67)

$$T = \frac{2 {ℏ}^{2}}{{m}_{e} a \sqrt{{a}^{2} - {b}^{2}}} ln \frac{a + \sqrt{{a}^{2} - {b}^{2}}}{a - \sqrt{{a}^{2} - {b}^{2}}} \qquad ( 71 )$$

From the orbital equations in polar coordinates, Eqs. (20-22), the following relationship can be derived:

$$\begin{matrix}a = \frac{m \frac{{L}^{2}}{{m}^{2}}}{k ( 1 - {e}^{2} )} \\ For any ellipse , & ( 72 ) \\ b = a \sqrt{1 - {e}^{2}} \\ Thus , & ( 73 ) \\ b = a \sqrt{\frac{\frac{{L}^{2}}{{m}^{2}} m}{ka}} ( polar coordinates ) & ( 74 )\end{matrix}$$

Using Eqs. (64) and (71), and (26) and (71), respectively, it can be appreciated that b of polar coordinates corresponds to c′=\sqrt{a²−b²} of elliptic coordinates, and k of polar coordinates with one attracting focus is replaced by 2k of elliptic coordinates with two attracting foci. In elliptic coordinates, k is given by Eqs. (58) and (60)

$$k = \frac{2 {pe}^{2}}{4 π {ɛ}_{o}} \qquad ( 75 )$$

and L for the electron equals [symbol] ; thus, in elliptic coordinates

$${c}^{′} = a \sqrt{\frac{{ℏ}^{2} 4 π {ɛ}_{o}}{{me}^{2} 2 pa}} = \sqrt{\frac{{aa}_{0}}{2 p}} \qquad ( 76 )$$

Substitution of a given by Eq. (68) into Eq. (76) gives

$${c}^{′} = \frac{{a}_{0}}{p} \qquad ( 77 )$$

The internuclear distance from Eq. (77) is

$$2 {c}^{′} = \frac{2 {a}_{0}}{p} .$$

One half the length of the semiminor axis of the prolate spheroidal MO, b=c, is
b=\sqrt{a²−c′²} (78)
Substitution of

$$a = \frac{2 {a}_{0}}{p} and {c}^{′} = \frac{{a}_{0}}{p}$$

into Eq. (78) gives

$$b = \frac{\sqrt{3}}{p} {a}_{0} \qquad ( 79 )$$

The eccentricity, e, is

$$e = \frac{{c}^{′}}{a} \qquad ( 80 )$$

Substitution of

$$a = \frac{2 {a}_{0}}{p} and {c}^{′} = \frac{{a}_{0}}{p}$$

into Eq. (80) gives

$$e = \frac{1}{2} \qquad ( 81 )$$

The potential energy, Vₚ, due to proton-proton repulsion in the field of magnitude p times that of the protons at the foci (ξ=0) is

$${V}_{p} = \frac{p {ⅇ}^{2}}{8 π {ɛ}_{o} \sqrt{{a}^{2} - {b}^{2}}} \qquad ( 82 )$$

The total energy E_{T} is given by the sum of the energy terms
E_{T}=Vₑ+Vₚ+T (83)
Substitution of a and b given by Eqs. (68) and (79), respectively, into Eqs. (69), (71), (82), and (83) gives

$$\begin{matrix}{V}_{e} = \frac{- 4 {p}^{2} {ⅇ}^{2}}{8 π {ɛ}_{o} {a}_{o}} ln 3 & ( 84 ) \\ {V}_{p} = \frac{{p}^{2} {ⅇ}^{2}}{8 π {ɛ}_{o} {a}_{o}} & ( 85 ) \\ T = \frac{2 {p}^{2} {ⅇ}^{2}}{8 π {ɛ}_{o} {a}_{o}} ln 3 & ( 86 ) \\ {E}_{T} = - 13.6 eV ( 4 {p}^{2} ln 3 - {p}^{2} - 2 {p}^{2} ln 3 ) = - {p}^{2} 16.28 eV & ( 87 )\end{matrix}$$

1.D. Vibration of Hydrogen-Type Molecular Ions

A charge, q, oscillating according to r₀(t)=d sin ω₀t has a Fourier spectrum

$$J ( k , ω ) = \frac{q {ω}_{0} d}{2} {J}_{m} ( k cos θ d ) \{ δ [ ω - ( m + 1 ) {ω}_{0} ] + δ [ ω - ( m - 1 ) {ω}_{0} ] \} \qquad ( 88 )$$

where Jₘ's are Bessel functions of order m. These Fourier components can, and do, acquire phase velocities that are equal to the velocity of light [28]. The protons of hydrogen-type molecular ions and molecules oscillate as simple harmonic oscillators; thus, vibrating protons will radiate. Moreover, nonoscillating protons may be excited by one or more photons that are resonant with the oscillatory resonance frequency of the molecule or molecular ion, and oscillating protons may be further excited to higher energy vibrational states by resonant photons. The energy of a photon is quantized according to Planck's equation
E= [symbol] ω (89)
The energy of a vibrational transition corresponds to the energy difference between the initial and final vibrational states. Each state has an electromechanical resonance frequency, and the emitted or absorbed photon is resonant with the difference in frequencies. Thus, as a general principle, quantization of the vibrational spectrum is due to the quantized energies of photons and the electromechanical resonance of the vibrationally excited ion or molecule.

It is shown by Fowles [75] that a perturbation of the orbit determined by an inverse-squared force results in simple harmonic oscillatory motion of the orbit. In a circular orbit in spherical coordinates, the transverse equation of motion gives

$$\dot{θ} = \frac{L / m}{{r}^{2}} \qquad ( 90 )$$

where L is the angular momentum. The radial equation of motion is
m(\ddot{r}−r\dot{θ}²)=f(r) (91)
Substitution of Eq. (90) into Eq. (91) gives

$$m \ddot{r} - \frac{{m ( L / m )}^{2}}{{r}^{3}} = f ( r ) \qquad ( 92 )$$

For a circular orbit, r is a constant and \ddot{r}=0. Thus, the radial equation of motion is given by

$$- \frac{{m ( L / m )}^{2}}{{a}^{3}} = f ( a ) \qquad ( 93 )$$

where a is the radius of the circular orbit for central force, f(a), at r=a. A perturbation of the radial motion may be expressed in terms of a variable x defined by
x=r−a (94)
The differential equation can then be written as
m\ddot{x}−m(L/m)²(x+a)⁻³=f(x+a) (95)
Expanding the two terms involving x+a as a power series in x, gives

$$m \ddot{x} - {m ( L / m )}^{2} {a}^{- 3} ( 1 - 3 \frac{x}{a} + … ) = f ( a ) + {f}^{′} ( a ) x + … \qquad ( 96 )$$

Substitution of Eq. (93) into Eq. (96) and neglecting terms involving x² and higher powers of x gives

$$m \ddot{x} + [ \frac{- 3}{a} f ( a ) - {f}^{′} ( a ) ] x = 0 \qquad ( 97 )$$

For an inverse-squared central field, the coefficient of x in Eq. (97) is positive, and the equation is the same as that of the simple harmonic oscillator. In this case, the particle, if perturbed, oscillates harmonically about the circle r=a, and an approximation of the angular frequency of this oscillation is

$$ω = \sqrt{\frac{[ \frac{- 3}{a} f ( a ) - {f}^{′} ( a ) ]}{m}} = \sqrt{\frac{k}{m}} \qquad ( 98 )$$

An apsis is a point in an orbit at which the radius vector assumes an extreme value (maximum or minimum). The angle swept out by the radius vector between two consecutive apsides is called the apsidal angle. Thus, the apsidal angle is π for elliptic orbits under the inverse-squared law of force. In the case of a nearly circular orbit, Eq. (97) shows that r oscillates about the circle r=a, and the period of oscillation is given by

$${τ}_{r} = 2 π \sqrt{\frac{m}{- [ \frac{3}{a} f ( a ) + {f}^{′} ( a ) ]}} \qquad ( 99 )$$

The apsidal angle in this case is just the amount by which the polar angle θ increases during the time that r oscillates from a minimum value to the succeeding maximum value which is τᵣ. From Eq. (90),

$$\dot{θ} = \frac{L / m}{{r}^{2}} ;$$

therefore, θ remains constant, and Eq. (93) gives

$$\dot{θ} \approx \frac{L / m}{{a}^{2}} = {[ - \frac{f ( a )}{ma} ]}^{1 / 2} \qquad ( 100 )$$

Thus, the apsidal angle is given by

$$ψ = \frac{1}{2} {τ}_{r} \dot{θ} = {π [ 3 + a \frac{{f}^{′} ( a )}{f ( a )} ]}^{- 1 / 2} \qquad ( 101 )$$

Thus, the power force of f(r)=−crⁿ gives
ψ=π(3+n)^{-1/2} (102)
The apsidal angle is independent of the size of the orbit in this case. The orbit is reentrant, or repetitive, in the case of the inverse-squared law (n=−2) for which ψ=π.

A prolate spheroid MO and the definition of axes are shown in FIGS. 1A and 1B, respectively. Consider the two nuclei A and B, each at focus of the prolate spheroid MO. From Eqs. (65), (67), (69), and (71), the attractive force between the electron and each nucleus at a focus is

$$\begin{matrix}f ( a ) = - \frac{{pe}^{2}}{4 π {ɛ}_{o} {a}^{2}} \\ and & ( 103 ) \\ {f}^{′} ( a ) = \frac{2 {pe}^{2}}{4 π {ɛ}_{o} {a}^{3}} & ( 104 )\end{matrix}$$

In addition to the attractive force between the electron and the nuclei, there is a repulsive force between the two nuclei that is the source of a corresponding reactive force on the reentrant electron orbit. Consider an elliptic geodesic of the MO in the xy-plane with a nucleus A at (−c′, 0) and a nucleus B at (c′, 0). For B acting as the attractive focus, the reactive repulsive force at the point (a, 0), the positive semimajor axis, depends on the distance from (a, 0) to nucleus A at (−c′, 0) (i.e. the distance from the position of the electron MO at the semimajor axis to the opposite nuclear repelling center at the opposite focus). The distance is given by the sum of the semimajor axis a and c′, ½ the internuclear distance. The contribution from the repulsive force between the two protons is

$$\begin{matrix}f ( a + {c}^{′} ) = - \frac{{pe}^{2}}{8 π {{ɛ}_{o} ( a + {c}^{′} )}^{2}} \\ and & ( 105 ) \\ {f}^{′} ( a + {c}^{′} ) = - \frac{{pe}^{2}}{4 π {{ɛ}_{o} ( a + {c}^{′} )}^{3}} & ( 106 )\end{matrix}$$

Thus, from Eqs. (98) and (103-106), the angular frequency of this oscillation is

$$\begin{matrix}ω = \sqrt{\frac{\frac{{pe}^{2}}{4 π {ɛ}_{o} {a}^{3}} - \frac{{pe}^{2}}{8 π {{ɛ}_{o} ( a + {c}^{′} )}^{3}}}{μ}} \\ = \sqrt{\frac{\frac{{pe}^{2}}{4 π {{ɛ}_{o} ( \frac{2 {a}_{H}}{p} )}^{3}} - \frac{{pe}^{2}}{8 π {{ɛ}_{o} ( \frac{3 {a}_{H}}{p} )}^{3}}}{μ}} \\ = {p}^{2} 4.44865 \times {10}^{14} rad \text{/} s\end{matrix} \qquad ( 107 )$$

where the semimajor axis, a, is

$$a = \frac{2 {a}_{H}}{p}$$

according to Eq. (68) and c′ is

$${c}^{′} = \frac{{a}_{H}}{p}$$

according to Eq. (77).

In the case of a hydrogen molecule or molecular ion, the electrons which have a mass of 1/1836 that of the protons move essentially instantaneously, and the charge density is that of a continuous membrane. Thus, a stable electron orbit is maintained with oscillatory motion of the protons. Hydrogen molecules and molecular ions are symmetrical along the semimajor axis; thus, the oscillatory motion of protons is along this axis. Let x be the increase in the semimajor due to the reentrant orbit with a corresponding displacement of the protons along the semimajor axis from the position of the initial foci of the stationary state. The equation of proton motion due to the perturbation of an orbit having an inverse-squared central force [72] and neglecting terms involving x² and higher is given by
μ\ddot{x}+kx=0 (108)
which has the solution in terms of the maximum amplitude of oscillation, A, the reduced nuclear mass, μ, the restoring constant or spring constant, k, the resonance angular frequency, ω₀, and the vibrational energy, E_{vib}, [76]

$$\begin{matrix}A cos {ω}_{0} t \\ where & ( 109 ) \\ {ω}_{0} = \sqrt{\frac{k}{μ}} & ( 110 )\end{matrix}$$

For a symmetrical displacement, x, the potential energy corresponding to the oscillation, E_{Pvib}, is given by

$${E}_{Pvib} = 2 ( \frac{1}{2} {kx}^{2} ) = {kx}^{2} \qquad ( 111 )$$

The total energy of the oscillating molecular ion, E_{Totalvib}, is given as the sum of the kinetic and potential energies

$${E}_{Totalvib} = \frac{1}{2} μ x + {kx}^{2} \qquad ( 112 )$$

The velocity is zero when x is the maximum amplitude, A. The total energy of the oscillating molecular ion, E_{Totalvib}, is then given as the potential energy with x=A

$$\begin{matrix}{E}_{Totalvib} = {kA}^{2} \\ Thus , & ( 113 ) \\ A = \sqrt{\frac{{E}_{Totalvib}}{k}} & ( 114 )\end{matrix}$$

It is shown in the Excited States of the One Electron Atom (Quantization) section of Ref. [5] that the change in angular frequency of the electron orbitsphere, Eq. (2.21) of Ref. [5], is identical to the angular frequency of the photon necessary for the excitation, ωₚₕₒₜₒₙ, (Eq. (2.19) of Ref. [5]). The energy of the photon necessary to excite the equivalent transition in an electron orbitsphere is one-half of the excitation energy of the stationary cavity because the change in kinetic energy of the electron orbitsphere supplies one-half of the necessary energy. The change in the angular frequency of the orbitsphere during a transition and the angular frequency of the photon corresponding to the superposition of the free space photon and the photon corresponding to the kinetic energy change of the orbitsphere during a transition are equivalent. The correspondence principle holds. It can be demonstrated that the resonance condition between these frequencies is to be satisfied in order to have a net change of the energy field [27]. The bound electrons are excited with the oscillating protons. Thus, the mechanical resonance frequency, ω₀, is only one-half that of the electromechanical frequency which is equal to the angular frequency of the free space photon, ω, which excites the vibrational mode of the hydrogen molecule or hydrogen molecular ion. The vibrational energy, E_{vib}, corresponding to the photon is given by

$${E}_{vib} = ℏ ω = ℏ {ω}_{0} = ℏ \sqrt{\frac{k}{μ}} = 2 {kA}^{2} \qquad ( 115 )$$

where Planck's equation (Eq. (89)) was used. The reduced mass is given by

$$\begin{matrix}μ = \frac{{m}_{1} {m}_{2}}{{m}_{1} + {m}_{2}} \\ Thus , & ( 116 ) \\ A = \sqrt{\frac{{ℏω}_{0}}{2 k}} & ( 117 )\end{matrix}$$

Since the protons and electron are not fixed, but vibrate about the center of mass, the maximum amplitude is given by the reduced amplitude, A_{reduced}, given by

$${A}_{reduced} = \frac{{A}_{1} {A}_{2}}{{A}_{1} + {A}_{2}} \qquad ( 118 )$$

where Aₙ is the amplitude n if the origin is fixed. Thus, Eq. (117) becomes

$$\begin{matrix}{A}_{reduced} = \frac{1}{2} \sqrt{\frac{{ℏω}_{0}}{2 k}} \\ and from Eq . ( 110 ) , \\ {A}_{reduced} is & ( 119 ) \\ {A}_{reduced} = \frac{1}{2} \sqrt{\frac{{ℏω}_{0}}{2 k}} = \frac{1}{2} \sqrt{\frac{ℏ}{2 k}} {( \frac{k}{μ} )}^{1 / 4} = \frac{\sqrt{ℏ}}{{2}^{3 / 2} {( k μ )}^{1 / 4}} & ( 120 )\end{matrix}$$

Then, from Eq. (80), A_{c′}, the displacement of c′ is the eccentricity e given by Eq. (81) times A_{reduced} (Eq. (120)):

$${A}_{{c}^{′}} = e {A}_{reduced} = \frac{{A}_{reduced}}{2} = \frac{\sqrt{ℏ}}{{2}^{5 / 2} {( k μ )}^{1 / 4}} \qquad ( 121 )$$

Thus, during bond formation, the perturbation of the orbit determined by an inverse-squared force results in simple harmonic oscillatory motion of the orbit, and the corresponding frequency, ω(0), for a hydrogen-type molecular ion H₂⁺(1/p) given by Eqs. (98) and (107) is

$$\begin{matrix}ω ( 0 ) = {p}^{2} \sqrt{\frac{k ( 0 )}{μ}} \\ = {p}^{2} \sqrt{\frac{165.51 {Nm}^{- 1}}{μ}} \\ = {p}^{2} 4.449 \times {10}^{14} radians \text{/} s\end{matrix} \qquad ( 122 )$$

where the reduced nuclear mass of hydrogen given by Eq. (116) is
μ=0.5 mₚ (123)
and the spring constant, k(0), given by Eqs. (98) and (107) is
k(0)=p⁴165.51 Nm⁻¹ (124)
The transition-state vibrational energy, E_{vib}(0), is given by Planck's equation (Eq. (89)):
E_{vib}(0)= [symbol] ω= [symbol] p²4.44865×10¹⁴ rad/s=p²0.2928 eV (125)
The amplitude of the oscillation, A_{reduced}(0), given by Eq. (120) and Eqs. (123-124) is

$$\begin{matrix}{A}_{reduced} ( 0 ) = \frac{\sqrt{ℏ}}{{2}^{3 / 2} {( {p}^{4} 165.51 {Nm}^{- 1} μ )}^{1 / 4}} \\ = \frac{5.952 \times {10}^{- 12} m}{p} \\ = 0.1125 \frac{{a}_{o}}{p}\end{matrix} \qquad ( 126 )$$

Then, from Eq. (80), A_{c′}(0), the displacement of c′, is the eccentricity e given by Eq. (81) times A_{reduced}(0) (Eq. (126)):

$$\begin{matrix}{A}_{ {c}^{ ′}} ( 0 ) = {eA}_{ reduced} ( 0 ) \\ = \frac{ {A}_{ reduced} ( 0 )}{2} \\ = \frac{ \sqrt{ℏ}}{ {2}^{ 5 / 2} {( k μ )}^{1 / 4}} \\ = \frac{0.05625 {a}_{ o}}{ p}\end{matrix} \qquad ( 127 )$$

The spring constant and vibrational frequency for the formed molecular ion are then obtained from Eqs. (98) and (103-107) using the increases in the semimajor axis and internuclear distances due to vibration in the transition state. The vibrational energy, E_{vib}(1), for the H₂⁺(1/p) υ=1→υ=0 transition given by adding A_{c′}(0) (Eq. (121)) to the distances a and a+c′ in Eqs. (107) and (125) is
E_{vib}(1)=p²0.270 eV (128)
where υ is the vibrational quantum number.

A harmonic oscillator is a linear system as given by Eq. (108). In this case, the predicted resonant vibrational frequencies and energies, spring constants, and amplitudes for H₂⁺(1/p) for vibrational transitions to higher energy υᵢ→υ_{f} are given by (υ_{f}−υᵢ) times the corresponding parameters given by Eq. (122) and Eqs. (124-128). However, excitation of vibration of the molecular ion by external radiation causes the semimajor axis and, consequently, the internuclear distance to increase as a function of the vibrational quantum number, υ. Consequently, the vibrational energies of hydrogen-type molecular ions are nonlinear as a function of the vibrational quantum number, υ. The lines become more closely spaced and the change in amplitude, ΔA_{reduced}, between successive states becomes larger as higher states are excited due to the distortion of the molecular ion in these states. The energy difference of each successive transition of the vibrational spectrum can be obtained by considering nonlinear terms corresponding to anharmonicity.

The harmonic oscillator potential energy function can be expanded about the internuclear distance and expressed as a Maclaurin series corresponding to a Morse potential after Karplus and Porter (K&P) [8] and after Eq. (96). Treating the Maclaurin series terms as anharmonic perturbation terms of the harmonic states, the energy corrections can be found by perturbation methods. The energy \tilde{v}_{υ} of state υ is

$$\begin{matrix}{\tilde{v}}_{υ} = {υω}_{0} - υ ( υ - 1 ) {ω}_{0} {x}_{0} , υ = 0 , 1 , 2 , 3 … \\ where & ( 129 ) \\ {ω}_{0} {x}_{0} = \frac{hc {ω}_{0}^{2}}{4 {D}_{0}} & ( 130 )\end{matrix}$$

ω₀ is the frequency of the υ=1→υ=0 transition corresponding to Eq. (128), and D₀ is the bond dissociation energy given by Eq. (160). From Eqs. (128), (130), and (160),

$${ω}_{0} {x}_{0} = \frac{100 {hc ( 8.06573 \times {10}^{3} \frac{{cm}^{- 1}}{eV} {p}^{2} 0.270 eV )}^{2}}{4 e ( {p}^{2} 2.535 eV + {p}^{3} 0.118755 eV )} {cm}^{- 1} \qquad ( 131 )$$

The vibrational energies of successive states are given by Eqs. (128-131).

Using Eqs. (107), (120-122), (124-131), and Eq. (161) the corresponding parameters for deuterium-type molecular ions with

$$\begin{matrix}μ = {m}_{p} \\ are & ( 132 ) \\ \begin{matrix}ω ( 0 ) = {p}^{2} \sqrt{\frac{k ( 0 )}{μ}} \\ = {p}^{2} \sqrt{\frac{165.65 {Nm}^{- 1}}{μ}} \\ = {p}^{2} 3.147 \times {10}^{14} \text{radians/s}\end{matrix} & ( 133 ) \\ k ( 0 ) = {p}^{4} 165.65 {Nm}^{- 1} & ( 134 ) \\ {E}_{vib} ( 0 ) = {p}^{2} 0.20714 eV & ( 135 ) \\ \begin{matrix}{A}_{reduced} ( 0 ) = \frac{\sqrt{ℏ}}{{2}^{3 / 2} {( {p}^{4} 165.65 {Nm}^{- 1} μ )}^{1 / 4}} \\ = \frac{5.004 \times {10}^{- 12} m}{p} \\ = 0.09457 \frac{{a}_{o}}{p}\end{matrix} & ( 136 ) \\ {E}_{vib} ( 1 ) = {p}^{2} 0.193 eV & ( 137 ) \\ {ω}_{0} {x}_{0} = \frac{100 {hc ( 8.06573 \times {10}^{3} \frac{{cm}^{- 1}}{eV} {p}^{2} 0.193 eV )}^{2}}{4 e ( {p}^{2} 2.5770 eV + {p}^{3} 0.118811 eV )} {cm}^{- 1} & ( 138 )\end{matrix}$$

The vibrational energies of successive states are given by Eqs. (129) and (137-138).

1.E. The Doppler Energy Term of Hydrogen-Type Molecular Ions

As shown in Sec. IV.1.D, the electron orbiting the nuclei at the foci of an ellipse may be perturbed such that a stable reentrant orbit is established that gives rise to a vibrational state corresponding to time harmonic oscillation of the nuclei and electron. The perturbation is caused by a photon that is resonant with the frequency of oscillation of the nuclei wherein the radiation is electric dipole with the corresponding selection rules.

Oscillation may also occur in the transition state. The perturbation arises from the decrease in internuclear distance as the molecular bond forms. Relative to the unperturbed case given in Sec. IV.1.B, the reentrant orbit may give rise to a decrease in the total energy while providing a transient kinetic energy to the vibrating nuclei. However, as an additional condition for stability, radiation must be considered. Regarding the potential for radiation, the nuclei may be considered point charges. A point charge undergoing periodic motion accelerates and as a consequence radiates according to the Larmor formula (cgs units) [77]:

$$P = \frac{2 {e}^{2}}{3 {c}^{3}} {\vert \dot{v} \vert}^{2} \qquad ( 139 )$$

where e is the charge, \dot{v} is its acceleration, and c is the speed of light. The radiation has a corresponding force that can be determined based on conservation of energy with radiation. The radiation reaction force, F_{rad}, given by Jackson [78] is

$${F}_{rad} = \frac{2}{3} \frac{{ⅇ}^{2}}{{c}^{3}} \ddot{v} \qquad ( 140 )$$

Then, the Abraham-Lorentz equation of motion is given by [78]

$$m ( \dot{v} - \frac{2}{3} \frac{{ⅇ}^{2}}{{mc}^{3}} \ddot{v} ) = {F}_{ext} \qquad ( 141 )$$

where Fₑₓₜ is the external force and m is the mass. The external force for the vibrating system is given by Eq. (108).
Fₑₓₜ=kx (142)
where x is the displacement of the protons along the semimajor axis from the position of the initial foci of the stationary state in the absence of vibration with a reentrant orbit of the electron. A nonradiative state must be achieved after the emission due to transient vibration wherein the nonradiative condition given by Eq. (34) must be satisfied.

As shown in the Resonant Line Shape and Lamb Shift section of Ref. [5], the spectroscopic linewidth arises from the classical rise-time band-width relationship, and the Lamb Shift is due to conservation of energy and linear momentum and arises from the radiation reaction force between the electron and the photon. The radiation reaction force in the case of the vibration of the molecular ion in the transition state corresponds to a Doppler energy, E_{D}, that is dependent on the motion of the electron and the nuclei. The Doppler energy of the electron is given by Eq. (2.72) of Ref. [5]:

$${\overline{E}}_{D} ≅ 2 \sqrt{{E}_{K} {E}_{R}} = {E}_{hv} \sqrt{\frac{2 {\overline{E}}_{K}}{{Mc}^{2}}} \qquad ( 143 )$$

where E_{R} is the recoil energy which arises from the photon's linear momentum given by Eq. (2.67) of Ref. [5], E_{K} is the vibrational kinetic energy of the reentrant orbit in the transition state, and M is the mass of the electron mₑ.

As given in Sec. IV.1.D, for inverse-squared central field, the coefficient of x in Eq. (97) is positive, and the equation is the same as that of the simple harmonic oscillator. Since the electron of the hydrogen molecular ion is perturbed as the internuclear separation decreases with bond formation, it oscillates harmonically about the semimajor axis given by Eq. (68), and an approximation of the angular frequency of this oscillation is

$$ω = \sqrt{\frac{[ \frac{- 3}{a} f ( a ) - {f}^{′} ( a ) ]}{{m}_{e}}} = \sqrt{\frac{k}{{m}_{e}}} \qquad ( 144 )$$

From Eqs. (65), (67), (69), and (71), the central force terms between the electron MO and the two protons are

$$\begin{matrix}f ( a ) = - \frac{2 p {ⅇ}^{2}}{4 {πɛ}_{o} {a}^{2}} \\ and & ( 145 ) \\ {f}^{′} ( a ) = \frac{4 p {ⅇ}^{2}}{4 {πɛ}_{o} {a}^{2}} & ( 146 )\end{matrix}$$

Thus, the angular frequency of this oscillation is

$$ω = \sqrt{\frac{\frac{2 p {ⅇ}^{2}}{4 {{πɛ}_{o} ( \frac{2 {a}_{H}}{p} )}^{3}}}{{m}_{e}}} = {p}^{2} 2.06538 \times {10}^{16} rad \text{/} s \qquad ( 147 )$$

where the semimajor axis, a, is

$$a = \frac{2 {a}_{H}}{p}$$

according to Eq. (68) including the reduced electron mass. The kinetic energy, E_{K}, is given by Planck's equation (Eq. (89)):
E̅_{K}=ω=p²2.06538×10¹⁶ rad/s=p²13.594697 eV (148)
In Eq. (143), substitution of the total energy of the hydrogen molecular ion, E_{T}, (Eq. (87)) for Eₕᵥ, the mass of the electron, mₑ, for M, and the kinetic energy given by Eq. (148) for E̅_{K} gives the Doppler energy of the electron for the reentrant orbit.

$$\begin{matrix}{\overline{E}}_{D} ≅ {E}_{ hv} \sqrt{ \frac{2 { {E}^{ \_}}_{ K}}{ {Mc}^{ 2}}} \\ = - {p}^{ 2} 16.28034 eV \sqrt{\frac{2 e ( {p}^{2} 13.594697 eV )}{{m}_{e} {c}^{2}}} \\ = - {p}^{3} 0.118755 eV\end{matrix} \qquad ( 149 )$$

The total energy of the molecular ion is decreased by E̅_{D}.

In addition to the electron, the nuclei also undergo simple harmonic oscillation in the transition state at their corresponding frequency given in Sec. IV.1.D. On average, the total energy of vibration is equally distributed between kinetic energy and potential energy [79]. Thus, the average kinetic energy of vibration corresponding to the Doppler energy of the electrons, E̅_{Kvib}, is ½ of the vibrational energy of the molecular ion given by Eq. (125). The decrease in the energy of the hydrogen molecular ion due to the reentrant orbit in the transition state corresponding to simple harmonic oscillation of the electron and nuclei, E̅_{osc}, is given by the sum of the corresponding energies, E̅_{D} and E̅_{Kvib}. Using Eq. (149) and E_{vib} from Eq. (125) gives

$$\begin{matrix}{\overline{E}}_{osc} = {\overline{E}}_{D} + {\overline{E}}_{Kvib} = {\overline{E}}_{D} + \frac{1}{2} ℏ {p}^{2} \sqrt{\frac{k}{μ}} & ( 150 ) \\ {\overline{E}}_{osc} = - {p}^{3} 0.118755 eV + \frac{1}{2} {p}^{2} ( 0.29282 eV ) & ( 151 )\end{matrix}$$

To the extent that the MO dimensions are the same, the electron reentrant orbital energies, E̅_{K}, are the same independent of the isotope of hydrogen, but the vibrational energies are related by Eq. (110). Thus, the differences in bond energies are essentially given by ½ the differences in vibrational energies. Using Eq. (149) with the deuterium reduced electron mass for E_{T} and E̅_{D}, and E_{vib} for D₂⁺(1/p) given by Eq. (135), that corresponds to the deuterium reduced nuclear mass (Eq. (132)), the corresponding E̅_{osc} is

$${\overline{E}}_{osc} = - {p}^{3} 0.118811 eV + \frac{1}{2} {p}^{2} ( 0.20714 eV ) \qquad ( 152 )$$

1.F. Total (Ionization) and Bond Energies of Hydrogen and Deuterium Molecular Ions

The total energy of the hydrogen molecular ion which is equivalent to the negative of the ionization energy is given by the sum of E_{T} (Eqs. (83) and (87)) and E̅_{osc} given by Eqs. (147-150). Thus, the total energy of the hydrogen molecular ion having a central field of +pe at each focus of the prolate spheroid molecular orbital including the Doppler term is

$$\begin{matrix}{E}_{T} = {V}_{e} + {V}_{p} + T + {\overline{E}}_{osc} & ( 153 ) \\ \begin{matrix}{E}_{T} = - {p}^{2} \{ \begin{matrix}\frac{{ⅇ}^{2}}{8 {πɛ}_{o} {a}_{H}} ( \begin{matrix}4 ln 3 - \\ 1 - 2 ln 3\end{matrix} ) [ \begin{matrix}1 + \\ p \sqrt{\frac{2 ℏ \sqrt{\frac{\frac{2 {ⅇ}^{2}}{4 {{πɛ}_{o} ( 2 {a}_{H} )}^{3}}}{{m}_{e}}}}{{m}_{e} {c}^{2}}}\end{matrix} ] - \\ \frac{1}{2} ℏ \sqrt{\frac{k}{μ}}\end{matrix} \} \\ = {p}^{ 2} 16.2803 eV - {p}^{ 3} 0.118811 eV + \frac{1}{ 2} {p}^{ 2} ℏ \sqrt{ \frac{k}{ μ}}\end{matrix} & ( 154 )\end{matrix}$$

From Eqs. (151) and (153-154), the total energy for hydrogen-type molecular ions is

$$\begin{matrix}{E}_{T} = - {p}^{2} 16.28033 eV + {\overline{E}}_{osc} \\ = {p}^{2} 16.28033 eV - {p}^{3} 0.118755 eV + \\ \frac{1}{2} {p}^{2} ( 0.29282 eV ) \\ = - p {-}^{2} 16.13392 eV - {p}^{3} 0.118755 eV\end{matrix} \qquad ( 155 )$$

The total energy of the deuterium molecular ion is given by the sum of E_{T} (Eq. (87)) corrected for the reduced electron mass of D and E̅_{osc} given by Eq. (152):

$$\begin{matrix}{E}_{T} = - {p}^{2} 16.284 eV + {\overline{E}}_{osc} \\ = - {p}^{2} 16.284 eV - {p}^{3} 0.118811 eV + \\ \frac{1}{2} {p}^{2} ( 0.20714 eV ) \\ = - {p}^{2} 16.180 eV - {p}^{3} 0.118811 eV\end{matrix} \qquad ( 156 )$$

The bond dissociation energy, E_{D}, is the difference between the total energy of the corresponding hydrogen atom or H(1/p) atom [37, 48], called hydrino atom having a principal quantum number 1/p where p is an integer, and E_{T}.
E_{D}=E(H(1/p))−E_{T} (157)
where [48]
E(H(1/p))=−p²13.59844 eV (158)
and [37]
E(D(1/p))=−p²13.603 eV (159)
The hydrogen molecular ion bond energy, E_{D}, is given by Eq. (155) with the reduced electron mass and Eqs. (157-158):

$$\begin{matrix}{E}_{D} = - {p}^{2} 13.59844 - {E}_{T} \\ = - {p}^{2} 13.59844 - ( - {p}^{2} 16.13392 eV - {p}^{3} 0.118755 eV ) \\ = {p}^{2} 2.535 eV + {p}^{3} 0.118755 eV\end{matrix} \qquad ( 160 )$$

The deuterium molecular ion bond energy, E_{D}, is given by Eq. (156) with the reduced electron mass of D and Eqs. (157) and (159):

$$\begin{matrix}{E}_{D} = - {p}^{2} 13.603 - {E}_{T} \\ = - {p}^{2} 13.603 - ( - {p}^{2} 16.180 eV - {p}^{3} 0.118811 eV ) \\ = {p}^{2} 2.5770 eV + {p}^{3} 0.118811 eV\end{matrix} \qquad ( 161 )$$

2. Hydrogen-Type Molecules

2.A. Force Balance of Hydrogen-Type Molecules

Hydrogen-type molecules comprise two indistinguishable electrons bound by an elliptic field. Each electron experiences a centrifugal force, and the balancing centripetal force (on each electron) is produced by the electric force between the electron and the elliptic electric field and the magnetic force between the two electrons causing the electrons to pair. In the present case of hydrogen-type molecules, if the eccentricity equals

$$\frac{1}{\sqrt{2}} ,$$

then the vectorial projection of the magnetic force between the electrons,

$$\sqrt{\frac{3}{4}}$$

of Eq. (7.15) of the Two Electron Atom section of Ref. [5], is one. The molecules will be solved by self consistency. Assume

$$e = \frac{1}{\sqrt{2}} ,$$

then the force balance equation given by Eq. (7.18) of the Two Electron Atom section of Ref. [5] and Eq. (67)

$$\begin{matrix}\frac{{ℏ}^{2}}{{m}_{e} {a}^{2} {b}^{2}} 2 {ab}^{2} X = \frac{p {ⅇ}^{2}}{4 {πɛ}_{o}} X + \frac{{ℏ}^{2}}{2 {m}_{e} {a}^{2} {b}^{2}} 2 {ab}^{2} X & ( 162 ) \\ \frac{2 {a}_{o}}{pa} - \frac{{a}_{o}}{pa} = 1 & ( 163 ) \\ a = \frac{{a}_{o}}{p} & ( 164 )\end{matrix}$$

Substitution of Eq. (164) into Eq. (76) is

$${c}^{′} = \frac{1}{p \sqrt{2}} {a}_{o} \qquad ( 165 )$$

Substitution of Eqs. (164-165) into Eq. (78) is

$$b = {c}^{′} = \frac{1}{p \sqrt{2}} {a}_{o} \qquad ( 166 )$$

Substitution of Eqs. (164-165) into Eq. (80) is

$$e = \frac{1}{\sqrt{2}} \qquad ( 167 )$$

The eccentricity is

$$\frac{1}{\sqrt{2}} ;$$

thus, the present self consistent solution which was obtained as a boundary value problem is correct. The internuclear distance given by multiplying Eq. (165) by two is

$$\frac{{a}_{o} \sqrt{2}}{p} .$$

2.B. Energies of Hydrogen-Type Molecules

The energy components defined previously for the molecular ion, Eqs. (69), (71), (82), and (83), apply in the case of the corresponding molecule. And, each molecular energy component is given by the integral of corresponding force in Eq. (162) where each energy component is the total for the two equivalent electrons. The parameters a and b are given by Eqs. (164) and (166), respectively.

$$\begin{matrix}{V}_{e} = \frac{- 2 {pe}^{2}}{8 {πɛ}_{o} \sqrt{{a}^{2} - {b}^{2}}} ln \frac{a + \sqrt{{a}^{2} - {b}^{2}}}{a - \sqrt{{a}^{2} - {b}^{2}}} & ( 168 ) \\ {V}_{p} = \frac{p}{8 {πɛ}_{o}} \frac{{e}^{2}}{\sqrt{{a}^{2} - {b}^{2}}} & ( 169 ) \\ T = \frac{{ℏ}^{2}}{2 {m}_{e} a \sqrt{{a}^{2} - {b}^{2}}} ln \frac{a + \sqrt{{a}^{2} - {b}^{2}}}{a - \sqrt{{a}^{2} - {b}^{2}}} & ( 170 )\end{matrix}$$

The energy, Vₘ, corresponding to the magnetic force of Eq. (162) is

$$\begin{matrix}{V}_{m} = \frac{- {ℏ}^{2}}{4 {m}_{e} a \sqrt{{a}^{2} - {b}^{2}}} ln \frac{a + \sqrt{{a}^{2} - {b}^{2}}}{a - \sqrt{{a}^{2} - {b}^{2}}} & ( 171 ) \\ {E}_{T} = {V}_{e} + T + {V}_{m} + {V}_{p} & ( 172 ) \\ \begin{matrix}{E}_{T} = - 13.60 eV [ ( 2 {p}^{2} \sqrt{2} - {p}^{2} \sqrt{2} + \frac{{p}^{2} \sqrt{2}}{2} ) ln \frac{\sqrt{2} + 1}{\sqrt{2} - 1} - {p}^{2} \sqrt{2} ] \\ = - {p}^{2} 31.63\end{matrix} & ( 173 )\end{matrix}$$

2.C. Vibration of Hydrogen-Type Molecules

The vibrational energy levels of hydrogen-type molecules may be solved in the same manner as hydrogen-type molecular ions given in Sec. IV.1.D. The corresponding central force terms of Eq. (98) are

$$\begin{matrix}f ( a ) = - \frac{{pe}^{2}}{8 {πɛ}_{o} {a}^{2}} & ( 174 ) \\ and & \\ {f}^{′} ( a ) = \frac{{pe}^{2}}{4 {πɛ}_{o} {a}^{3}} & ( 175 )\end{matrix}$$

The distance for the reactive nuclear-repulsive terms is given by the sum of the semimajor axis, a, and c′, ½ the internuclear distance. The contribution from the repulsive force between the two protons is

$$\begin{matrix}f ( a + {c}^{′} ) = \frac{{pe}^{2}}{8 {{πɛ}_{o} ( a + {c}^{′} )}^{2}} & ( 176 ) \\ and & \\ {f}^{′} ( a + {c}^{′} ) = \frac{{pe}^{2}}{4 {{πɛ}_{o} ( a + {c}^{′} )}^{3}} & ( 177 )\end{matrix}$$

Thus, from Eqs. (98) and (174-177), the angular frequency of the oscillation is

$$\begin{matrix}ω = \sqrt{\frac{\frac{{pe}^{2}}{8 {πɛ}_{o} {a}^{3}} - \frac{{pe}^{2}}{8 {{πɛ}_{o} ( a + {c}^{′} )}^{3}}}{μ}} \\ = \sqrt{\frac{\frac{{pe}^{2}}{8 {{πɛ}_{o} ( \frac{{a}_{0}}{p} )}^{3}} - \frac{{pe}^{2}}{8 {{πɛ}_{o} ( \frac{( 1 + \frac{1}{\sqrt{2}} ) {a}_{0}}{p} )}^{3}}}{μ}} \\ = {p}^{2} 8.62385 \times {10}^{14 } rad \text{/} s\end{matrix} \qquad ( 178 )$$

where the semimajor axis, a, is

$$a = \frac{{a}_{0}}{p}$$

according to Eq. (164) and c′ is

$${c}^{′} = \frac{{a}_{0}}{p \sqrt{2}}$$

according to Eq. (165). Thus, during bond formation, the perturbation of the orbit determined by an inverse-squared force results in simple harmonic oscillatory motion of the orbit, and the corresponding frequency, ω(0), for a hydrogen-type molecule H₂(1/p) given by Eqs. (98) and (107) is

$$\begin{matrix}ω ( 0 ) = {p}^{ 2} \sqrt{ \frac{k ( 0 )}{μ}} \\ = {p}^{ 2} \sqrt{ \frac{621.98 {Nm}^{- 1}}{ μ}} \\ = {p}^{ 2} 8.62385 \times {10}^{ 14} radians \text{/} s\end{matrix} \qquad ( 179 )$$

where the reduced nuclear mass of hydrogen is given by Eq. (123) and the spring constant, k(0), given by Eqs. (98) and (178) is
k(0)=p⁴621.98 Nm⁻¹ (180)
The transition-state vibrational energy, E_{vib}(0), is given by Planck's equation (Eq. (89)):
E_{vib}(0)= [symbol] ω= [symbol] p²8.62385×10¹⁴ rad/s=p²0.56764 eV (181)
The amplitude of oscillation, A_{reduced}(0), given by Eqs. (120), (123), and (180) is

$$\begin{matrix}{A}_{reduces} ( 0 ) = \frac{\sqrt{ℏ}}{{2}^{3 / 2} {( {p}^{4} 621.98 {Nm}^{- 1} μ )}^{1 / 4}} \\ = \frac{4.275 \times {10}^{- 12} m}{p} \\ = 0.08079 \frac{{a}_{o}}{p}\end{matrix} \qquad ( 182 )$$

Then, from Eq. (80), A_{c′}(0), the displacement of c′ is the eccentricity, e, given by Eq. (167) times A_{reduced}(0) (Eq. (182)):

$${A}_{{c}^{′}} ( 0 ) = {eA}_{reduced} ( 0 ) = \frac{{A}_{reduced} ( 0 )}{\sqrt{2}} = \frac{\sqrt{ℏ}}{4 {( k μ )}^{1 / 4}} = \frac{0.05713 {a}_{o}}{p} \qquad ( 183 )$$

The spring constant and vibrational frequency for the formed molecule are then obtained from Eqs. (98) and (174-183) using the increases in the semimajor axis and internuclear distances due to vibration in the transition state. The vibrational energy, E_{vib}(1), for the H₂ (1/p) υ=1→υ=0 transition given by adding A_{c′}(0) (Eq. (183)) to the distances a and a+c′ in Eqs. (174-181) is
E_{vib}(1)=p²0.517 eV (184)
where υ is the vibrational quantum number. Using Eq. (138) with Eqs. (184) and (213), the anharmonic perturbation term, ω₀x₀, of H₂(1/p) is

$${ω}_{0} {x}_{0} = \frac{100 {hc ( 8.06573 \times {10}^{3} \frac{{cm}^{- 1}}{eV} {p}^{2} 0.517 eV )}^{2}}{4 e ( {p}^{2} 4.151 eV + {p}^{3} 0.326469 eV )} {cm}^{- 1} \qquad ( 185 )$$

where ω₀ is the frequency of the υ=1→υ=0 transition corresponding to Eq. (184) and D₀ is the bond dissociation energy given by Eq. (213). The vibrational energies of successive states are given by Eqs. (129) and (184-185).

Using the reduced nuclear mass given by Eq. (132), the corresponding parameters for deuterium-type molecules D₂(1/p) (Eqs. (174-185) and (214)) are

$$\begin{matrix}\begin{matrix}ω ( 0 ) = {p}^{2} \sqrt{\frac{k ( 0 )}{μ}} \\ = {p}^{2} \sqrt{\frac{621.98 {Nm}^{- 1}}{μ}} \\ = {p}^{2} 6.09798 \times {10}^{14} radians \text{/} s\end{matrix} & ( 186 ) \\ k ( 0 ) = {p}^{4} 621.98 {Nm}^{- 1} & ( 187 ) \\ {E}_{vib} ( 0 ) = {p}^{2} 0.4014 eV & ( 188 ) \\ \begin{matrix}{A}_{reduced} ( 0 ) = \frac{\sqrt{ℏ}}{{2}^{3 / 2} {( {p}^{4} 621.98 {Nm}^{- 1} μ )}^{1 / 4}} \\ = \frac{3.595 \times {10}^{- 12} m}{p} \\ = 0.06794 \frac{{a}_{o}}{p}\end{matrix} & ( 189 ) \\ {E}_{vin} ( 1 ) = {p}^{2} 0.371 eV & ( 190 ) \\ {ω}_{0} {x}_{0} = \frac{100 {hc ( 8.06573 \times {10}^{3} \frac{{cm}^{- 1}}{eV} {p}^{2} 0.317 eV )}^{2}}{4 e ( {p}^{2} 4.229 eV + {p}^{3} 0.326469 eV )} {cm}^{- 1} & ( 191 )\end{matrix}$$

The vibrational energies of successive states are given by Eqs. (129) and (190-191).

2.D. The Doppler Energy Term of Hydrogen-Type Molecules

The radiation reaction force in the case of the vibration of the molecule in the transition state also corresponds to the Doppler energy, E_{D}, given by Eq. (143) that is dependent on the motion of the electrons and the nuclei. Here, a nonradiative state must also be achieved after the emission due to transient vibration wherein the nonradiative condition given by Eq. (34) must be satisfied. Typically, a third body is required to form hydrogen-type molecules. For example, the exothermic chemical reaction of H+H to form H₂ does not occur with the emission of a photon. Rather, the reaction requires a collision with a third body, M, to remove the bond energy—H+H+M→H₂+M* [46]. The third body distributes the energy from the exothermic reaction, and the end result is the H₂ molecule and an increase in the temperature of the system. Thus, a third body removes the energy corresponding to the additional force term given by Eq. (142). From Eqs. (65), (162), (168) and (170), the central force terms between the electron MO and the two protons are

$$\begin{matrix}f ( a ) = - \frac{p {e}^{2}}{4 {πɛ}_{o} {a}^{2}} \\ and & ( 192 ) \\ {f}^{′} ( a ) = \frac{2 p {e}^{2}}{ 4 {πɛ}_{o} {a}^{3}} & ( 193 )\end{matrix}$$

Thus, the angular frequency of this oscillation is

$$ω = \sqrt{\frac{\frac{p {e}^{2}}{4 {{πɛ}_{o} ( \frac{{a}_{0}}{p} )}^{3}}}{{m}_{e}}} = {p}^{2} 4.13414 \times {10}^{16} rad \text{/} s \qquad ( 194 )$$

where the semimajor axis, a, is

$$a = \frac{{a}_{0}}{p}$$

according to Eq. (164). The kinetic energy, E_{K}, is given by Planck's equation (Eq. (89)):
E̅_{K}=ω=p²4.13414×10¹⁶ rad/s=p²27.216 eV (195)
In Eq. (143), substitution of the total energy of the hydrogen molecule, E_{T}, (Eq. (173)) for Eₕᵥ, the mass of the electron, mₑ, for M, and the kinetic energy given by Eq. (195) for E̅_{K} gives the Doppler energy of the electrons for the reentrant orbit.

$$\begin{matrix}{\overline{E}}_{D} ≅ {E}_{ h v} \sqrt{ \frac{2 { {E}^{ \_}}_{ K}}{ M {c}^{ 2}}} \\ = - 31.635 {p}^{ 2} eV \sqrt{ \frac{2 e ( {p}^{ 2} 27.216 eV )}{ {m}_{ e} {c}^{ 2}}} \\ = - {p}^{3} 0.326469 eV\end{matrix} \qquad ( 196 )$$

The total energy of the molecule is decreased by E̅_{D}.

In addition to the electrons, the nuclei also undergo simple harmonic oscillation in the transition state at their corresponding frequency given in Sec. IV.2.C. On average, the total energy of vibration is equally distributed between kinetic energy and potential energy [79]. Thus, the average kinetic energy of vibration corresponding to the Doppler energy of the electrons, E̅_{Kvib} is ½ of the vibrational energy of the molecule given by Eq. (110). The decrease in the energy of the hydrogen molecule due to the reentrant orbit in the transition state corresponding to simple harmonic oscillation of the electrons and nuclei, E̅_{osc}, is given by the sum of the corresponding energies, E̅_{D} and E̅_{Kvib}. Using Eq. (196) and E_{vib} from Eq. (181) gives

$$\begin{matrix}{\overline{E}}_{osc} = {\overline{E}}_{D} + {\overline{E}}_{Kvib} = {\overline{E}}_{D} + \frac{1}{2} ℏ {p}^{2} \sqrt{\frac{k}{μ}} & ( 197 ) \\ {\overline{E}}_{osc} = - {p}^{3} 0.326469 eV + \frac{1}{2} {p}^{2} ( 0.56764 eV ) & ( 198 )\end{matrix}$$

To the extent that the MO dimensions are the same, the electron reentrant orbital energies, E̅_{K}, are the same independent of the isotope of hydrogen, but the vibrational energies are related by Eq. (110). Thus, the differences in bond energies are essentially given by ½ the differences in vibrational energies. Using Eq. (196) and E_{vib} for D₂(1/p) given by Eq. (188), that corresponds to the deuterium reduced nuclear mass (Eq. (132)), the corresponding E̅osc is

$${\overline{E}}_{osc} = - {p}^{3} 0.326469 eV + \frac{1}{2} {p}^{2} ( 0.401380 eV ) \qquad ( 199 )$$

2.E. Total, Ionization, and Bond Energies of Hydrogen and Deuterium Molecules

The total energy of the hydrogen molecule is given by the sum of E_{T} (Eqs. (172-173)) and E̅_{osc} given Eqs. (194-197). Thus, the total energy of the hydrogen molecule having a central field of +pe at each focus of the prolate spheroid molecular orbital including the Doppler term is

$$\begin{matrix}{E}_{T} = {V}_{e} + T + {V}_{m} + {V}_{p} + {\overline{E}}_{osc} & ( 200 ) \\ \begin{matrix}{E}_{T} = - {p}^{2} \{ [ \begin{matrix}\frac{ {ⅇ}^{ 2}}{ 8 {πɛ}_{ o} {a}_{ 0}} [ ( 2 \sqrt{2} - \sqrt{2} + \frac{ \sqrt{2}}{ 2} ) ln \frac{ \sqrt{2} + 1}{ \sqrt{2} - 1} - \sqrt{2} ] \\ [ 1 + p \sqrt{2 ℏ \sqrt{ \frac{ \frac{ {ⅇ}^{ 2}}{ 4 {πɛ}_{ o} {a}_{ 0}^{ 3}}}{ {m}_{ e} {c}^{ 2}}}} ] - \frac{1}{2} ℏ \sqrt{\frac{k}{μ}}\end{matrix} ] \} \\ = - {p}^{2} 31.635 eV - {p}^{3} 0.326469 eV + \frac{1}{2} ℏ \sqrt{\frac{k}{μ}}\end{matrix} & ( 201 )\end{matrix}$$

From Eqs. (198) and (200-201), the total energy for hydrogen-type molecules is

$$\begin{matrix}{E}_{T} = - {p}^{2} 31.635 eV + {\overline{E}}_{osc} \\ = - {p}^{2} 31.635 eV - {p}^{3} 0.326469 eV + \frac{1}{2} {p}^{2} ( 0.56764 eV ) \\ = - {p}^{2} 31.351 eV - {p}^{3} 0.326469 eV\end{matrix} \qquad ( 202 )$$

The total energy of the deuterium molecule is given by the sum of E_{T} (Eq. (173)) and E̅_{osc} given by Eq. (199):

$$\begin{matrix}{E}_{T} = - {p}^{2} 31.6354 eV + {\overline{E}}_{osc} \\ = - {p}^{2} 31.6354 eV - {p}^{3} 0.326469 eV + \frac{1}{2} {p}^{2} ( 0.401380 eV ) \\ = - {p}^{2} 31.4345 eV - {p}^{3} 0.326469 eV\end{matrix} \qquad ( 203 )$$

The first ionization energy of the hydrogen molecule, IP₁,
H₂(1/p)→H₂⁺(1/p)+e⁻ (204)
is given by the difference of Eqs. (155) and (202):

$$\begin{matrix}{IP}_{1} = {E}_{T} ( {H}_{2}^{+} ( 1 / p ) ) - {E}_{T} ( {H}_{2} ( 1 / p ) ) \\ = - {p}^{2} 16.13392 eV - {p}^{3} 0.118755 eV - \\ ( - {p}^{2} 31.351 eV - {p}^{3} 0.326469 eV ) \\ = {p}^{2} 15.2171 eV + {p}^{3} 0.207714 eV\end{matrix} \qquad ( 205 )$$

The second ionization energy, IP₂, is given by the negative of Eq. (155).
IP₂=p²16.13392 eV+p³0.118755 eV (206)
The first ionization energy of the deuterium molecule, IP₁,
D₂(1/p)→D₂⁺(1/p)+e⁻ (207)
is given by the difference of Eqs. (156) and (203):

$$\begin{matrix}{IP}_{1} = {E}_{T} ( {D}_{2}^{+} ( 1 / p ) ) - {E}_{T} ( {D}_{2} ( 1 / p ) ) \\ = - {p}^{2} 16.180 eV - {p}^{3} 0.118811 eV - \\ ( - {p}^{2} 31.4345 eV - {p}^{3} 0.326469 eV ) \\ = {p}^{2} 15.255 eV + {p}^{3} 0.2077 eV\end{matrix} \qquad ( 208 )$$

The second ionization energy, IP₂, is given by the negative of Eq. (156).
IP₂=p²16.180 eV+p³0.118811 eV (209)
The bond dissociation energy, E_{D}, is the difference between the total energy of the corresponding hydrogen atoms and E_{T}
E_{D}=E(2H(1/p))−E_{T} (210)
where [48]
E(2H(1/p))=−p²27.20 eV (211)
and [37]
E(2D(1/p))=−p²27.206 eV (212)
The hydrogen bond energy, E_{D}, is given by Eqs. (210-211) and (202):

$$\begin{matrix}{E}_{D} = - {p}^{2} 27.20 eV - {E}_{T} \\ = - {p}^{2} 27.20 eV - ( - {p}^{2} 31.351 eV - {p}^{3} 0.326469 eV ) \\ = {p}^{2} 4.151 eV + {p}^{3} 0.326469 eV\end{matrix} \qquad ( 213 )$$

The deuterium bond energy, E_{D}, is given by Eqs. (210), (212), and (203):

$$\begin{matrix}{E}_{D} = {p}^{2} 27.206 eV - {E}_{T} \\ = - {p}^{2} 27.206 eV - ( - {p}^{2} 31.4345 eV - {p}^{3} 0.326469 eV ) \\ = {p}^{2} 4.229 eV + {p}^{3} 0.326469 eV\end{matrix} \qquad ( 214 )$$

3. The Hydrogen Molecular Ion

3.A. Force Balance of Hydrogen Molecular Ion

Force balance between the electric and centrifugal forces is given by Eq. (67) where p=1

$$\frac{{ℏ}^{2}}{{m}_{e} {a}^{2} {b}^{2}} 2 {ab}^{2} X = \frac{{e}^{2}}{4 {πɛ}_{o}} X \qquad ( 215 )$$

which has the parametric solution given by Eq. (61) when
a=2aₒ (216)
The semimajor axis, a, is also given by Eq. (68) where p=1. The internuclear distance, 2c′, which is the distance between the foci is given by Eq. (77) where p=1.
2c′=2aₒ (217)
The experimental internuclear distance is 2aₒ. The semiminor axis is given by Eq. (79) where p=1.
b=\sqrt{3}aₒ (218)
The eccentricity, e, is given by Eq. (81).

$$e = \frac{1}{2} \qquad ( 219 )$$

3.B. Energies of the Hydrogen Molecular Ion

The potential energy, Vₑ, of the electron MO in the field of the protons at the foci (ξ=0) is given by Eq. (69) where p=1

$${V}_{e} = \frac{- 4 {e}^{2}}{8 {πɛ}_{o} \sqrt{{a}^{2} - {b}^{2}}} ln \frac{a + \sqrt{{a}^{2} - {b}^{2}}}{a - \sqrt{{a}^{2} - {b}^{2}}} \qquad ( 220 )$$

The potential energy, Vₚ, due to proton-proton repulsion is given by Eq. (82) where p=1

$${V}_{p} = \frac{{e}^{2}}{8 {πɛ}_{o} \sqrt{{a}^{2} - {b}^{2}}} \qquad ( 221 )$$

The kinetic energy, T, of the electron MO is given by Eq. (71) where p=1

$$T = \frac{2 {ℏ}^{2}}{{m}_{e} a \sqrt{{a}^{2} - {b}^{2}}} ln \frac{a + \sqrt{{a}^{2} - {b}^{2}}}{a - \sqrt{{a}^{2} - {b}^{2}}} . \qquad ( 222 )$$

Substitution of a and b given by Eqs. (216) and (218), respectively, into Eqs. (220-222) is

$$\begin{matrix}{V}_{e} = \frac{- 4 {e}^{2}}{8 {πɛ}_{o} {a}_{H}} ln 3 = - 59.7575 eV & ( 223 ) \\ {V}_{p} = \frac{{e}^{2}}{8 {πɛ}_{o} {a}_{H}} = 13.5984 eV & ( 224 ) \\ T = \frac{2 {e}^{2}}{8 {πɛ}_{o} {a}_{H}} ln 3 = 29.8787 eV & ( 225 )\end{matrix}$$

The Doppler term, E̅_{osc}, for hydrogen and deuterium are given by Eqs. (151) and (152), respectively, where p=1

$$\begin{matrix}\begin{matrix}{\overline{E}}_{osc} ( {H}_{2}^{+} ) = {\overline{E}}_{D} + {\overline{E}}_{Kvib} \\ = - 0.118755 eV + \frac{1}{2} ( 0.29282 eV ) \\ = 0.027655\end{matrix} & ( 226 ) \\ \begin{matrix}{\overline{E}}_{osc} ( {D}_{2}^{+} ) = - 0.118811 eV + \frac{1}{2} ( 0.20714 eV ) \\ = - 0.01524 eV\end{matrix} & ( 227 )\end{matrix}$$

The total energy, E_{T}, for the hydrogen molecular ion given by Eqs. (153-155) is

$$\begin{matrix}{E}_{T} = - \{ \begin{matrix}\frac{{ⅇ}^{2}}{8 {πɛ}_{o} {a}_{H}} ( \begin{matrix}4 ln 3 - \\ 1 - 2 ln 3\end{matrix} ) [ \begin{matrix}1 + \\ p \sqrt{\frac{2 ℏ \sqrt{\frac{\frac{2 {ⅇ}^{2}}{4 {{πɛ}_{o} ( 2 {a}_{H} )}^{3}}}{{m}_{e}}}}{{m}_{e} {c}^{2}}}\end{matrix} ] - \\ \frac{1}{2} ℏ \sqrt{\frac{k}{μ}}\end{matrix} \} \\ = - 16.2803 eV - 0.118811 eV + \frac{1}{2} ( 0.29282 eV ) \\ = - 16.2527 eV\end{matrix} \qquad ( 228 )$$

where in Eqs. (223-228), the radius of the hydrogen atom a_{H} (Eq. (1.228) of Ref. [5]) was used in place of a₀ to account for the corresponding electrodynamic force between the electron and the nuclei as given in the case of the hydrogen atom by Eq. (1.221) of Ref. [5]. The negative of Eq. (228) is the ionization energy of H₂⁺ and the second ionization energy, IP₂, of H₂. From Eqs. (153-154) and (156) the total energy, E_{T}, for the deuterium molecular ion (the ionization energy of D₂⁺ and the second ionization energy, IP₂, of D₂) is

$$\begin{matrix}{E}_{T} = - 16.284 eV - 0.118811 eV + \frac{1}{2} ( 0.20714 eV ) \\ = - 16.299 eV\end{matrix} \qquad ( 229 )$$

The bond dissociation energy, E_{D}, is the difference between the total energy of the corresponding hydrogen atom and E_{T}. The hydrogen molecular ion bond energy, E_{D}, including the reduced electron mass given by Eq. (160) where p=1 is

$$\begin{matrix}{E}_{D} = 2.535 eV + 0.118755 eV \\ = 2.654 eV\end{matrix} \qquad ( 230 )$$

The experimental bond energy of the hydrogen molecular ion [19] is
E_{D}=2.651 eV (231)
From Eq. (161) where p=1, the deuterium molecular ion bond energy, E_{D}, including the reduced electron mass of D is

$$\begin{matrix}{E}_{D} = 2.5770 eV + 0.118811 eV \\ = 2.6958 eV\end{matrix} \qquad ( 232 )$$

The experimental bond energy of the deuterium molecular ion [80] is
E_{D}=2.691 eV (233)

3.C. Vibration of the Hydrogen Molecular Ion

It can be shown that a perturbation of the orbit determined by an inverse-squared force results in simple harmonic oscillatory motion of the orbit [75]. The resonant vibrational frequency for H₂⁺ given by Eq. (122) is

$$ω ( 0 ) = \sqrt{\frac{k ( 0 )}{μ}} = \sqrt{\frac{165.51 {Nm}^{- 1}}{μ}} = 4.449 \times {10}^{14} radians \text{/} s \qquad ( 234 )$$

wherein p=1. The spring constant, k(0), for H₂⁺ given by Eq. (124) is
k(0)=165.51 Nm⁻¹ (235)
The vibrational energy, E_{vib}(0), of H₂⁺ during bond formation given by Eq. (125) is
E_{vib}(0)=0.29282 eV (236)
The amplitude of oscillation given by Eq. (126) is

$$\begin{matrix}A ( 0 ) = \frac{\sqrt{ℏ}}{{2}^{3 / 2} {( 165.51 {Nm}^{- 1} μ )}^{1 / 4}} \\ = 5.952 \times {10}^{- 12} m \\ = 0.1125 {a}_{o}\end{matrix} \qquad ( 237 )$$

(237) The vibrational energy for the H₂⁺ υ=1→υ=0 transition given by Eq. (128) is
E_{vib}(1)=0.270 eV (238)
The experimental vibrational energy of H₂⁺ [8, 37] is
E_{vib}=0.271 eV (239)
The anharmonicity term of H₂⁺ given by Eq. (131) is
ω₀x₀=55.39 cm⁻¹ (240)
The experimental anharmonicity term of H₂⁺ from NIST [37] is
ωₑxₑ=66.2 cm⁻¹ (241)
Higher-order terms after Eq. (96) are indicated. The vibrational energy for the D₂⁺ υ=1→υ=0 transition given by Eq. (137) is
E_{vib}=0.193 eV (242)
The vibrational energy of the D₂⁺ [37] based on calculations from experimental data is
E_{vib}=0.196 eV (243)
The anharmonicity term of D₂⁺ given by Eq. (138) is
ω₀x₀=27.86 cm⁻¹ (244)
The experimental anharmonicity term of D₂⁺ for the state

$${X}^{2} {\sum }_{g}^{+ 1} s σ$$

is not given, but the term for state

$${B}^{2} {\sum }_{g}^{+ 3} d σ$$

from NIST [37] is
ωₑxₑ=2.62 cm⁻¹ (245)

4. The Hydrogen Molecule

4.A. Force Balance of the Hydrogen Molecule

The force balance equation for the hydrogen molecule is given by Eq. (162) where p=1

$$\frac{{ℏ}^{2}}{{m}_{e} {a}^{2} {b}^{2}} 2 {ab}^{2} X = \frac{{ⅇ}^{2}}{4 {πɛ}_{o}} X + \frac{{ℏ}^{2}}{2 {m}_{e} {a}^{2} {b}^{2}} 2 {ab}^{2} X \qquad ( 246 )$$

which has the parametric solution given by Eq. (61) when
a=aₒ (247)
The semimajor axis, a, is also given by Eq. (164) where p=1. The internuclear distance, 2c′, which is the distance between the foci is given by Eq. (165) where p=1.
2c′=\sqrt{2}aₒ (248)
The experimental internuclear distance is \sqrt{2}aₒ. The semiminor axis is given by Eq. (166) where p=1.

$$b = \frac{1}{\sqrt{2}} {a}_{o} \qquad ( 249 )$$

The eccentricity, e, is given by Eq. (167).

$$e = \frac{1}{\sqrt{2}} \qquad ( 250 )$$

The finite dimensions of the hydrogen molecule are evident in the plateau of the resistivity versus pressure curve of metallic hydrogen [42].

4.B. Energies of the Hydrogen Molecule

The energies of the hydrogen molecule are given by Eqs. (168-171) where p=1

$$\begin{matrix}{V}_{e} = \frac{- 2 {ⅇ}^{2}}{8 {πɛ}_{o} \sqrt{{a}^{2} - {b}^{2}}} ln \frac{a + \sqrt{{a}^{2} - {b}^{2}}}{a - \sqrt{{a}^{2} - {b}^{2}}} = - 67.8358 eV & ( 251 ) \\ {V}_{p} = \frac{{ⅇ}^{2}}{8 {πɛ}_{o} \sqrt{{a}^{2} - {b}^{2}}} = 19.2415 eV & ( 252 ) \\ T = \frac{{ℏ}^{2}}{2 {m}_{e} a \sqrt{{a}^{2} - {b}^{2}}} ln \frac{a + \sqrt{{a}^{2} - {b}^{2}}}{a - \sqrt{{a}^{2} - {b}^{2}}} = 33.9179 eV & ( 253 )\end{matrix}$$

The energy, Vₘ, of the magnetic force is

$${V}_{m} = \frac{- {ℏ}^{2}}{4 {m}_{e} a \sqrt{{a}^{2} - {b}^{2}}} ln \frac{a + \sqrt{{a}^{2} - {b}^{2}}}{a - \sqrt{{a}^{2} - {b}^{2}}} = - 16.9589 eV \qquad ( 254 )$$

The Doppler terms, E̅_{osc}, for hydrogen and deuterium molecules are given by Eqs. (198) and (199), respectively, where p=1

$$\begin{matrix}\begin{matrix}{\overline{E}}_{osc} ( {H}_{2} ) = {\overline{E}}_{D} + {\overline{E}}_{Kvib} \\ = - 0.326469 eV + \frac{1}{2} ( 0.56764 eV ) \\ = - 0.042649 eV\end{matrix} & ( 255 ) \\ \begin{matrix}{\overline{E}}_{osc} ( {D}_{2} ) = - 0.326469 eV + \frac{1}{2} ( 0.401380 eV ) \\ = - 0.125779 eV\end{matrix} & ( 256 )\end{matrix}$$

The total energy, E_{T}, for the hydrogen molecule given by Eqs. (200-202) is

$$\begin{matrix}{E}_{T} = - \{ \begin{matrix}\frac{{e}^{2}}{8 π {ɛ}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] \\ [ 1 + \sqrt{\frac{2 ℏ \sqrt{\frac{{e}^{2}}{\frac{4 π {ɛ}_{o} {a}_{0}^{3}}{{m}_{e}}}}}{{m}_{e} {c}^{2}}} ] - \frac{1}{2} ℏ \sqrt{\frac{k}{μ}}\end{matrix} \} \\ = - 31.635 eV - 0.326469 eV + \frac{1}{2} ( 0.56764 eV ) \\ = - 31.6776 eV\end{matrix} \qquad ( 257 )$$

From Eqs. (200-201) and (203), the total energy, E_{T}, for the deuterium molecule is

$$\begin{matrix}{E}_{T} = - 31.635 eV - 0.326469 eV + \frac{1}{2} ( 0.401380 eV ) \\ = - 31.7608 eV\end{matrix} \qquad ( 258 )$$

The first ionization energies of the hydrogen and deuterium molecules, IP₁, (Eqs. (204) and (207)) are given by the differences in the total energy of corresponding molecular ions and molecules which are given by Eqs. (205) and (208), respectively, where p=1:

$$\begin{matrix}\begin{matrix}{IP}_{1} ( {H}_{2} ) = 15.2171 eV + 0.207714 eV \\ = 15.4248 eV\end{matrix} & ( 259 ) \\ \begin{matrix}{IP}_{1} ( {D}_{2} ) = 15.255 eV + 0.2077 eV \\ = 15.4627 eV\end{matrix} & ( 260 )\end{matrix}$$

The bond dissociation energy, E_{D}, is the difference between the total energy of two of the corresponding hydrogen atoms and E_{T}. The hydrogen molecular bond energy, E_{D}, given by Eq. (213) where p=1 is

$$\begin{matrix}{E}_{D} = 4.151 eV + 0.326469 eV \\ = 4.478 eV\end{matrix} \qquad ( 261 )$$

The experimental bond energy of the hydrogen molecule [19] is
E_{D}=4.478 eV (262)
The deuterium molecular bond energy, E_{D}, given by Eq. (214) where p=1 is

$$\begin{matrix}{E}_{D} = 4.229 eV + 0.326469 eV \\ = 4.556 eV\end{matrix} \qquad ( 263 )$$

The experimental bond energy of the deuterium molecule [19] is
E_{D}=4.556 eV (264)

4.C. Vibration of the Hydrogen Molecule

It can be shown that a perturbation of the orbit determined by an inverse-squared force results in simple harmonic oscillatory motion of the orbit [75]. The resonant vibrational frequency for H₂ given by Eq. (179) is

$$\begin{matrix}ω ( 0 ) = \sqrt{\frac{k ( 0 )}{μ}} \\ = \sqrt{\frac{621.98 {Nm}^{- 1}}{μ}} \\ = 8.62385 \times {10}^{14} radians \text{/} s\end{matrix} \qquad ( 265 )$$

The spring constant, k(0), for H₂ given by Eq. (180) is
k(0)=621.98 Nm⁻¹ (266)
wherein p=1. The vibrational energy, E_{vib}(0), of H₂ during bond formation given by Eq. (181) is
E_{vib}(0)=0.56764 eV (267)
The amplitude of oscillation given by Eq. (182) is

$$\begin{matrix}A ( 0 ) = \frac{\sqrt{ℏ}}{{2}^{3 / 2} {( {p}^{4} 621.98 {Nm}^{- 1} μ )}^{1 / 4}} \\ = 4.275 \times {10}^{- 12} m\end{matrix} \\ m = 0.08079 {a}_{0} \qquad ( 268 )$$

The vibrational energy for the H₂ υ=1→υ=0 transition given by Eq. (184) is
E_{vib}(1)=0.517 eV (269)
The experimental vibrational energy of H₂ [20-21] is
E_{vib}(1)=0.5159 eV (270)
The anharmonicity term of H₂ given by Eq. (185) is
ω₀x₀=120.4 cm⁻¹ (271)
The experimental anharmonicity term of H₂ from Huber and Herzberg [80] is
ωₑxₑ=121.33 cm⁻¹ (272)
The vibrational energy for the D₂ υ=1→υ=0 transition given by Eq. (190) is
E_{vib}=0.371 eV (273)
The experimental vibrational energy of D₂ [8, 37] is
E_{vib}=0.371 eV (274)
The anharmonicity term of D₂ given by Eq. (191) is
ω₀x₀=60.93 cm⁻¹ (275)
The experimental anharmonicity term of D₂ from NIST [37] is
ωₑxₑ=61.82 cm⁻¹ (276)

The results of the determination of the bond, vibrational, total, and ionization energies, and internuclear distances for hydrogen and deuterium molecules and molecular ions are given in TABLE I. The calculated results are based on first principles and given in closed form equations containing fundamental constants only. The agreement between the experimental and calculated results is excellent.

TABLE I
The calculated and experimental parameters of H₂, D₂, H₂⁺ and D₂⁺.

| | | | | | | Ref. |
|---|---|---|---|---|---|---|
| | | | | | | for |
| Parameter | Calculated | | Experimental | | Eqs. | Exp. |
| H₂ Bond Energy | 4.478 | eV | 4.478 | eV | 261 | 19 |
| D₂ Bond Energy | 4.556 | eV | 4.556 | eV | 263 | 19 |
| H₂⁺ Bond Energy | 2.654 | eV | 2.651 | eV | 230 | 19 |
| D₂⁺ Bond Energy | 2.696 | eV | 2.691 | eV | 232 | 80 |
| H₂ Total Energy | 31.677 | eV | 31.675 | eV | 257 | 19, |
| | | | | | | 81, 48^{a} |
| D₂ Total Energy | 31.760 | eV | 31.760 | eV | 258 | 37, 80^{b} |
| H₂ Ionization Energy | 15.425 | eV | 15.426 | eV | 259 | 81 |
| D₂ Ionization Energy | 15.463 | eV | 15.466 | eV | 260 | 80 |
| H₂⁺ Ionization Energy | 16.253 | eV | 16.250 | eV | 228 | 19, 48^{c} |
| D₂⁺ Ionization Energy | 16.299 | eV | 16.294 | eV | 229 | 37, 80^{d} |
| H₂⁺ Magnetic Moment | 9.274 × 10⁻²⁴ | | 9.274 × 10⁻²⁴ | | 328-334 | 82 |
| | μ_{B} | | JT⁻ μ_{B} | | | |
| Absolute H₂ Gas-Phase | −28.0 | ppm | −28.0 | ppm | 345 | 83-84 |
| NMR Shift | | | | | | |
| H₂ Internuclear Distance^{e} | 0.748 | Å | 0.741 | Å | 248 | 85 |
| | \sqrt{2}αₒ | | | | | |
| D₂ Internuclear Distance^{e} | 0.748 | Å | 0.741 | Å | 248 | 85 |
| | \sqrt{2}αₒ | | | | | |
| H₂⁺ Internuclear Distance | 1.058 | Å | 1.06 | Å | 217 | 19 |
| | 2αₒ | | | | | |
| D₂⁺ Internuclear Distance^{e} | 1.058 | Å | 1.0559 | Å | 217 | 80 |
| | 2αₒ | | | | | |
| H₂ Vibrational Energy | 0.517 | eV | 0.516 | eV | 269 | 20-21 |
| D₂ Vibrational Energy | 0.371 | eV | 0.371 | eV | 274 | 8, 37 |
| H₂ ωₑxₑ | 120.4 | cm⁻¹ | 121.33 | cm⁻¹ | 271 | 80 |
| D₂ ω ₑxₑ | 60.93 | cm⁻¹ | 61.82 | cm⁻¹ | 275 | 37 |
| H₂⁺ Vibrational Energy | 0.270 | eV | 0.271 | eV | 238 | 8, 37 |
| D₂⁺ Vibrational Energy | 0.193 | eV | 0.196 | eV | 242 | 37 |
| H₂ J = 1 to J = 0 Rotational | 0.0148 | eV | 0.01509 | eV | 290 | 19 |
| Energy^{e} | | | | | | |
| D₂ J = 1 to J = 0 Rotational | 0.00741 | eV | 0.00755 | eV | 278-283, | 19 |
| Energy^{e} | | | | | 290 | |
| H₂⁺ J = 1 to J = 0 Rotational | 0.00740 | eV | 0.00739 | eV | 286 | 19 |
| Energy | | | | | | |
| D₂⁺ J = 1 to J = 0 Rotational | 0.00370 | eV | 0.003723 | eV | 278-286 | 80 |
| Energy^{e} | | | | | | |

^{a}The experimental total energy of the hydrogen molecule is given by adding the first (15.42593 eV) [81] and second (16.2494 eV) ionization energies where the second ionization energy is given by the addition of the ionization energy of the hydrogen atom (13.59844 eV) [47] and the bond energy of H₂⁺ (2.651 eV) [19].
^{b}The experimental total energy of the deuterium molecule is given by adding the first (15.466 eV) [80] and second (16.294 eV) ionization energies where the second ionization energy is given by the addition of the ionization energy of the deuterium atom (13.603 eV) [37] and the bond energy of D₂⁺ (2.692 eV) [80].
^{c}The experimental second ionization energy of the hydrogen molecule, IP₂, is given by the sum of the ionization energy of the hydrogen atom (13.59844 eV) [47] and the bond energy of H₂⁺ (2.651 eV) [19].
^{d}The experimental second ionization energy of the deuterium molecule, IP₂, is given by the sum of the ionization energy of the deuterium atom (13.603 eV) [37] and the bond energy of D₂⁺ (2.692 eV) [80].
^{e}Not corrected for the slight reduction in internuclear distance due to E̅_{osc}.

5. Diatomic Molecular Rotation

A molecule with a permanent dipole moment can resonantly absorb a photon which excites a rotational mode about the center of mass of the molecule. Momentum must be conserved with excitation of a rotational mode. The photon carries [symbol] of angular momentum; thus, the rotational angular momentum of the molecule changes by [symbol] . And, the rotational charge-density function is equivalent to the rigid rotor problem considered in the Rotational Parameters of the Electron (Angular Momentum, Rotational Energy, Moment of Inertia) section of Ref. [5]. The corresponding rigid rotor equation is,

$$- \frac{{ℏ}^{2}}{2 I} [ \begin{matrix}\frac{1}{sin θ} \frac{\partial }{\partial θ} {( sin θ \frac{\partial }{\partial θ} )}_{r , ϕ} + \\ \frac{1}{ {sin}^{2} θ} {( \frac{ {\partial }^{2}}{\partial {ϕ}^{2}} )}_{r , ϕ}\end{matrix} ] Y ( θ , ϕ ) = {E}_{rot} Y ( θ , ϕ ) \qquad ( 277 )$$

The energies are given by [41]

$${E}_{rotational} = \frac{{ℏ}^{2}}{2 I} J ( J + 1 ) \qquad ( 278 )$$

where J is an integer. For Eq. (278), J=0 corresponds to rotation about the z-axis where the internuclear axis is along the y-axis, and J≠0 corresponds to a linear combination of rotations about the z and x-axis. For a diatomic molecule having atoms of masses m₁ and m₂, the moment of inertia is
I=μr² (279)
where μ is the reduced mass

$$μ = \frac{{m}_{1} {m}_{2}}{{m}_{1} + {m}_{2}} \qquad ( 280 )$$

and where r is the distance between the centers of the atoms, the internuclear distance.

As given in the Selection Rules section of Ref. [5], the radiation of a multipole of order (l, m) carries m [symbol] units of the z component of angular momentum per photon of energy [symbol] ω. Thus, the z component of the angular momentum of the corresponding excited rotational state is
L_{z}=m [symbol] (281)
Thus, the selection rule for rotational transitions is
ΔJ=±1 (282)
In addition, the molecule must possess a permanent dipole moment. In the case of absorption of electromagnetic radiation, the molecule goes from a state with a quantum number J to one with a quantum number of J+1. Using Eq. (278), the energy difference is

$$Δ E = {E}_{J + 1} - {E}_{J} = \frac{{ℏ}^{2}}{I} [ J + 1 ] \qquad ( 283 )$$

5.A. Diatomic Molecular Rotation of Hydrogen-Type Molecular Ions

The reduced mass of hydrogen-type molecular ions and molecules, μ_{H}_{₂}, having two protons is given by Eq. (280) where m₁=m₂=mₚ, and mₚ is the mass of the proton.

$${μ}_{{H}_{2}} = \frac{{m}_{p} {m}_{p}}{{m}_{p} + {m}_{p}} = \frac{1}{2} {m}_{p} \qquad ( 284 )$$

The moment of inertia of hydrogen-type molecular ions is given by substitution of the reduced mass, Eq. (284), for μ of Eq. (279) and substitution of the internuclear distance, two times Eq. (77), for r of Eq. (279).

$$I = {m}_{p} \frac{2 {a}_{o}^{2}}{{p}^{2}} \qquad ( 285 )$$

where p is an integer which corresponds to H₂⁺(1/p),

$$n = \frac{1}{p} ,$$

the fractional quantum number of the hydrogen-type molecular ion. Using Eqs. (283) and (285), the rotational energy absorbed by a hydrogen-type molecular ion with the transition from the state with the rotational quantum number J to one with the rotational quantum number J+1 is

$$\begin{matrix}Δ E = {E}_{J + 1} - {E}_{J} \\ = \frac{{p}^{2} {ℏ}^{2}}{{m}_{p} 2 {a}_{H}^{2}} [ J + 1 ] \\ = {p}^{2} [ J + 1 ] 1.186 \times {10}^{- 21} \\ J = {p}^{2} [ J + 1 ] 0.00740 eV\end{matrix} \qquad ( 286 )$$

From Eq. (286), the calculated energy for the J=0 to J=1 transition of the hydrogen molecular ion H₂⁺ not including the increase in internuclear due to E̅_{osc}. given by Eq. (226) is
ΔE=0.00740 eV (287)
The experimental value is [19].
ΔE=0.00739 eV (288)

5.B. Diatomic Molecular Rotation of Hydrogen-Type Molecules

The moment of inertia of hydrogen-type molecules is given by substitution of the reduced mass, Eq. (284), for μ of Eq. (279) and substitution of the internuclear distance, two times Eq. (165), for r of Eq. (279).

$$I = {m}_{p} \frac{{a}_{o}^{2}}{{p}^{2}} \qquad ( 289 )$$

where p is an integer which corresponds to H₂ (1/p), n=1/p, the fractional quantum number of the hydrogen-type molecule. Using Eqs. (283) and (289), the rotational energy absorbed by a hydrogen-type molecule with the transition from the state with the rotational quantum number J to one with the rotational quantum number J+1 is

$$\begin{matrix}Δ E = {E}_{J + 1} - {E}_{J} \\ = \frac{{p}^{2} {ℏ}^{2}}{{m}_{p} {a}_{o}^{2}} [ J + 1 ] \\ = {p}^{2} [ J + 1 ] 2.37 \times {10}^{- 21} \\ J = {p}^{2} [ J + 1 ] 0.0148 eV\end{matrix} \qquad ( 290 )$$

From Eq. (290), the calculated energy for the J=0 to J=1 transition of the hydrogen molecule H₂ not including the reduction in internuclear due to E̅_{osc} given by Eq. (255) is
ΔE=0.0148 eV (291)
The experimental value is [19].
ΔE=0.01509 eV (292)

6. Nuclear Magnetic Resonance Shift

The proton gyromagnetic ratio, γ_{P}/2π, is
γ_{P}/2π=42.57602 MHz T⁻¹ (293)
The NMR frequency, f, is the product of the proton gyromagnetic ratio given by Eq. (293) and the magnetic flux, B.
f=γ_{P}/2πB=42.57602 MHz T⁻¹B (294)
A typical flux for a superconducting NMR magnet is 1.5 T. According to Eq. (294) this corresponds to a radio frequency (RF) of 63.86403 MHz. With a constant magnetic field, the frequency is scanned to yield the spectrum where the scan is typically achieved using a Fourier transform on the free induction decay signal following a radio frequency pulse. Or, in a less common type of NMR spectrometer, the radiofrequency is held constant (e.g. 60 MHz), the applied magnetic field, H₀

$$( {H}_{0} = \frac{B}{{μ}_{0}} ) ,$$

is varied over a small range, and the frequency of energy absorption is recorded at the various values for H₀. The spectrum is typically scanned and displayed as a function of increasing H₀. The protons that absorb energy at a lower H₀ give rise to a downfield absorption peak; whereas, the protons that absorb energy at a higher H₀ give rise to an upfield absorption peak. The electrons of the compound of a sample influence the field at the nucleus such that it deviates slightly from the applied value. For the case that the chemical environment has no NMR effect, the value of H₀ at resonance with the radiofrequency held constant at 60 MHz is

$$\frac{2 π f}{{μ}_{0} {γ}_{P}} = \frac{( 2 π ) ( 60 MHz )}{{μ}_{0} 42.57602 MHz {T}^{- 1}} = {H}_{0} \qquad ( 295 )$$

In the case that the chemical environment has a NMR effect, a different value of H₀ is required for resonance. This chemical shift is proportional to the electronic magnetic flux change at the nucleus due to the applied field which in the case of each dihydrino molecule is a function of its semimajor and semiminor axes as shown infra.

Consider the application of a z-axis-directed uniform external magnetic flux, B_{z}, to a dihydrino molecule comprising prolate spheroidal electron MOs with two spin-paired electrons. In the case of hydrogen-type molecules, the electronic interaction with the nuclei requires that each nuclear magnetic moment is in the direction of the semiminor axis. Thus, the nuclei are NMR active towards B_{z} when the orientation of the semimajor axis, a, is along the x-axis, and the semiminor axes, b=c, are along the y-axis and z-axis, respectively. The flux is applied over the time interval Δt=tᵢ−t_{f} such that the field increases at a rate dB/dt. The electric field, E, along a perpendicular elliptic path of the dihydrino MO at the plane z=0 is given by

$$∮ E \cdot ⅆ s = \int \frac{ⅆ B}{ⅆ t} \cdot ⅆ A \qquad ( 296 )$$

The induced electric field must be constant along the path; otherwise, compensating currents would flow until the electric field is constant. Thus, Eq. (296) becomes

$$E = \frac{\int \frac{ⅆ B}{ⅆ t} \cdot ⅆ A}{∮ ⅆ s} = \frac{\int \frac{ⅆ B}{ⅆ t} \cdot ⅆ A}{4 aE ( k )} = \frac{π ab \frac{ⅆ B}{ⅆ t}}{4 aE ( k )} \qquad ( 297 )$$

where E(k) is the elliptic integral given by

$$\begin{matrix}E ( k ) = {\int }_{0}^{\frac{π}{2}} \sqrt{1 - k {sin}^{2} ϕ} ⅆ ϕ = 1.2375 & ( 298 ) \\ k = e = \frac{\sqrt{{a}^{2} - {b}^{2}}}{a} = \frac{\sqrt{2}}{2} & ( 299 )\end{matrix}$$

the area of an ellipse, A, is
A=πab (300)
the perimeter of an ellipse, s, is
s=4aE(k) (301)
a is the semimajor axis given by Eq. (164), b is the semiminor axis given by Eq. (166), and e is the eccentricity given by Eq. (167). The acceleration along the path, dv/dt, during the application of the flux is determined by the electric force on the charge density of the electrons:

$${m}_{e} \frac{ⅆ v}{ⅆ t} = eE = \frac{e π ab}{4 aE ( k )} \frac{ⅆ B}{ⅆ t} \qquad ( 302 )$$

Thus, the relationship between the change in velocity, v, and the change in B is

$$ⅆ v = \frac{e π ab}{4 aE ( k ) {m}_{e}} ⅆ B \qquad ( 303 )$$

Let Δv represent the net change in v over the time interval Δt=tᵢ−t_{f} of the application of the flux. Then,

$$Δ v = {\int }_{{v}_{0}}^{{v}_{0} + Δ v} ⅆ v = \frac{e π ab}{4 aE ( k ) {m}_{e}} {\int }_{0}^{B} ⅆ B = \frac{e π abB}{4 aE ( k ) {m}_{e}} \qquad ( 304 )$$

The average current, I, of a charge moving time harmonically along an ellipse is

$$I = ef = \frac{ev}{4 aE ( k )} \qquad ( 305 )$$

where f is the frequency. The corresponding magnetic moment is given by

$$m = AI = π abI = \frac{π abev}{4 aE ( k )} \qquad ( 306 )$$

Thus, from Eqs. (304) and (306), the change in the magnetic moment, Δm, due to an applied magnetic flux, B, is [86]

$$Δ m = - \frac{{( e π ab )}^{2}}{{( 4 aE ( k ) )}^{2} {m}_{e}} \qquad ( 307 )$$

Next, the contribution from all plane cross sections of the prolate spheroid MO must be integrated along the z-axis. The spheroidal surface is given by

$$\frac{{x}^{2}}{{a}^{2}} + \frac{{y}^{2}}{{b}^{2}} + \frac{{z}^{2}}{{b}^{2}} = 1 \qquad ( 308 )$$

The intersection of the plane z=z′ (−b≦z′≦b) with the spheroid determines the curve

$$\begin{matrix}\frac{{x}^{2}}{{a}^{2}} + \frac{{y}^{2}}{{b}^{2}} = 1 - \frac{{z}^{′2}}{{b}^{2}} & ( 309 ) \\ or & \\ \frac{{x}^{2}}{{a}^{2} ( 1 - \frac{{z}^{′2}}{{b}^{2}} )} + \frac{{y}^{2}}{{b}^{2} ( 1 - \frac{{z}^{′2}}{{b}^{2}} )} = 1 & ( 310 )\end{matrix}$$

Eq. (310) is an ellipse with semimajor axis a′ and semiminor axis b′ given by

$$\begin{matrix}{a}^{′} = a \sqrt{1 - \frac{{z}^{′2}}{{b}^{2}}} & ( 311 ) \\ {b}^{′} = b \sqrt{1 - \frac{{z}^{′2}}{{b}^{2}}} & ( 312 )\end{matrix}$$

The eccentricity, e′, is given by

$${ⅇ}^{′} = \frac{\sqrt{{a}^{2} ( 1 - \frac{{z}^{′2}}{{b}^{2}} ) - {b}^{2} ( 1 - \frac{{z}^{′2}}{{b}^{2}} )}}{a \sqrt{1 - \frac{{z}^{′2}}{{b}^{2}}}} = \frac{\sqrt{{a}^{2} - {b}^{2}}}{a} = e \qquad ( 313 )$$

where e is given by Eq. (299). The area, A′, is given by
A′=πd b′ (314)
and the perimeter, s′, is given by

$${s}^{′} = 4 {a}^{′} E ( k ) = 4 aE ( k ) \sqrt{1 - \frac{{z}^{′2}}{{b}^{2}}} = s \sqrt{1 - \frac{{z}^{′2}}{{b}^{2}}} \qquad ( 315 )$$

where s is given by Eq. (301). The differential magnetic moment change along the z-axis is

$$d Δ m = - \frac{1}{2 b} \frac{{( e π {a}^{′} {b}^{′} )}^{2} B}{{( 4 dE ( k ) )}^{2} {m}_{e}} {dz}^{′} \qquad ( 316 )$$

Using Eq. (312) for the parameter b′, the change in magnetic moment for the dihydrino molecule is given by the integral over −b≦b′≦b:

$$Δ m = - \frac{1}{2 b} {\int }_{- b}^{b} \frac{{( e π {a}^{′} b \sqrt{1 - \frac{{z}^{′2}}{{b}^{2}}} )}^{2} B}{{( 4 dE ( k ) )}^{2} {m}_{e}} ⅆ {z}^{′} - {C}_{1} \frac{1}{{m}_{e}} {( \frac{π e}{4 E ( k )} )}^{2} \qquad ( 317 )$$

Then, integral to correct for the z-dependence of b′ is

$$\begin{matrix}{C}_{1} = \frac{{\int }_{- b}^{b} ( {b}^{2} - {z}^{2} ) ⅆ z}{2 b} \\ = \frac{2}{3} {b}^{2} \\ = \frac{{a}_{0}^{2}}{3 p}\end{matrix} \qquad ( 318 )$$

where the semiminor axis,

$$b = \frac{{a}_{0}}{p \sqrt{2}} ,$$

given by Eq. (166) was used.

The change in magnetic moment would be given by the substitution of Eq. (318) into Eq. (317), if the charge density were constant along the path of Eqs. (297) and (305), but it is not. The charge density of the MO in rectangular coordinates (Eq. (51)) is

$$σ = \frac{e}{4 π abc} \frac{1}{\sqrt{\frac{{x}^{2}}{{a}^{4}} + \frac{{y}^{2}}{{b}^{4}} + \frac{{z}^{2}}{{c}^{4}}}} \qquad ( 319 )$$

(The mass-density function of an MO is equivalent to its charge-density function where m replaces q of Eq. (51)). The equation of the plane tangent to the ellipsoid at the point x₀, y₀, z₀ is

$$X \frac{{x}_{0}}{{a}^{2}} = Y \frac{{y}_{0}}{{b}^{2}} + Z \frac{{z}_{0}}{{c}^{2}} = 1 \qquad ( 320 )$$

where X, Y, Z are running coordinates in the plane. After dividing through by the square root of the sum of the squares of the coefficients of X, Y, and Z, the right member is the distance D from the origin to the tangent plane. That is,

$$\begin{matrix}D = \frac{1}{\sqrt{\frac{{x}^{2}}{{a}^{4}} + \frac{{y}^{2}}{{b}^{4}} + \frac{{z}^{2}}{{c}^{4}}}} & ( 321 ) \\ so that & \\ σ = \frac{e}{4 π abc} D & ( 322 )\end{matrix}$$

In other words, the surface density at any point on a the ellipsoidal MO is proportional to the perpendicular distance from the center of the ellipsoid to the plane tangent to the ellipsoid at the point. The charge is thus greater on the more sharply rounded ends farther away from the origin. In order to maintain current continuity, the diamagnetic velocity of Eq. (304) must be a constant along any given path integral corresponding to a constant electric field. Consequently, the charge density must be the minimum value of that given by Eq. (319). The minimum corresponds to y=b and x=z=0 such that the charge density is

$$σ = \frac{e}{4 π {ab}^{2}} \frac{1}{\sqrt{\frac{{0}^{2}}{{a}^{4}} + \frac{{b}^{2}}{{b}^{4}} + \frac{{0}^{2}}{{b}^{4}}}} = \frac{e}{4 π ab} \qquad ( 323 )$$

The MO is an equipotential surface, and the current must be continuous over the two-dimensional surface. Continuity of the surface current density, K, due to the diamagnetic effect of the applied magnetic field on the MO and the equipotential boundary condition require that the current of each elliptical curve determined by the intersection of the plane z=z′ (−b≦z′≦b) with the spheroid be the same. The charge density is spheroidally symmetrical about the semimajor axis. Thus, λ, the charge density per unit length along each elliptic path cross section of Eq. (310) is given by distributing the surface charge density of Eq. (323) uniformly along the z-axis for −b≦z′≦b. So, λ(z′=0), the linear charge density λ in the plane z′=0 is

$$λ ( {z}^{′} = 0 ) = \frac{σ}{\frac{1}{2 b}} = \frac{e}{4 π ab} 2 b = \frac{e}{2 π a} \qquad ( 324 )$$

And, the linear charge density must be equally distributed over each elliptical path cross section corresponding to each plane z=z′. The current is independent of z′ when the linear charge density, λ(z′), is normalized for the path length:

$$λ ( {z}^{′} ) = \frac{e}{2 π a} \frac{4 aE ( k )}{4 {a}^{′} E ( {k}^{′} )} = \frac{e}{2 π d} \qquad ( 325 )$$

where the equality of the eccentricities of each elliptical plane cross section given by Eq. (313) was used. Substitution of Eq. (325) for the corresponding charge density,

$$\frac{e}{4 dE ( k )} ,$$

of Eq. (317) and using Eq. (318) gives

$$Δ m = \frac{2}{3} \frac{{ⅇ}^{2} {b}^{2} B}{4 {m}_{e}} = \frac{{ⅇ}^{2} {a}_{0}^{2} B}{12 {p}^{2} {m}_{e}} \qquad ( 326 )$$

The two electrons are spin-paired and the velocities are mirror opposites. Thus, the change in velocity of each electron treated individually (Eq. (10.3) of Ref. [5]) due to the applied field would be equal and opposite. However, as shown in the Three Electron Atom section of Ref. [5], the two paired electrons may be treated as one with twice the mass where mₑ is replaced by 2mₑ in Eq. (326). In this case, the paired electrons spin together about the applied field axis, the z-axis, to cause a reduction in the applied field according to Lenz's law. Thus, from Eq. (326), the change in magnetic moment is given by

$$Δ m = \frac{{ⅇ}^{2} {a}_{0}^{2} B}{24 {p}^{2} {m}_{e}} \qquad ( 327 )$$

The magnetic moment and magnetic field of the ellipsoidal MO is that corresponding to a Bohr magneton wherein the electrons are spin-paired in molecular hydrogen. The magnetic dipole moment, μ, of a current loop is
μ=iA (328)
The area of an ellipse is given by Eq. (300). For any elliptic orbital due to a central field, the frequency, f, is

$$f = \frac{\frac{L}{m}}{2 π ab} \qquad ( 329 )$$

where L is the angular momentum. The current, i, is

$$i = ef = \frac{\frac{eL}{{m}_{e}}}{2 π ab} \qquad ( 330 )$$

where e is the charge. Substitution of Eqs. (330) and (300) into Eq. (328) where L is the angular momentum of the electron, [symbol] , gives

$$μ = \frac{e ℏ}{2 {m}_{e}} = {μ}_{B} \qquad ( 331 )$$

which is the Bohr magneton.

The magnetic field can be solved as a magnetostatic boundary value problem which is equivalent to that of a uniformly magnetized ellipsoid [73]. The magnetic scalar potential inside the ellipsoidal MO, φ⁻, is

$${ϕ}^{-} = \frac{e ℏ}{2 {m}_{e}} x {\int }_{0}^{∞} \frac{ⅆ s}{( s + {a}^{2} ) {R}_{s}} \qquad ( 332 )$$

The magnetic scalar potential outside of the MO, φ⁺, is

$${ϕ}^{+} = \frac{e ℏ}{2 {m}_{e}} x {\int }_{ξ}^{∞} \frac{ⅆ s}{( s + {a}^{2} ) {R}_{s}} \qquad ( 333 )$$

The magnetic field inside the ellipsoidal MO, H⁻, is

$${H}_{x}^{-} = - \frac{δ {ϕ}^{-}}{δ x} = \frac{- e ℏ}{2 {m}_{e}} {\int }_{0}^{∞} \frac{ⅆ s}{( s + {a}^{2} ) {R}_{s}} \qquad ( 334 )$$

The magnetic field inside the ellipsoidal MO. is uniform and parallel to the minor axis. The diamagnetic field has the same dependence wherein the diamagnetic moment replaces the Bohr magneton.

The opposing diamagnetic flux is uniform, parallel, and opposite the applied field as given by Stratton [87]. Specifically, the change in magnetic flux, ΔB, at the nucleus due to the change in magnetic moment, Δm, is
ΔB=μ₀A₂Δm (335)
where μ₀ is the permeability of vacuum,

$${A}_{2} = {\int }_{0}^{∞} \frac{ⅆ s}{( s + {b}^{2} ) {R}_{s}} \qquad ( 336 )$$

is an elliptic integral of the second kind given by Whittaker and Watson [88], and
Rₛ=(s+b²){square root over (s+a²))} (337)
Substitution of Eq. (337) into Eq. (336) gives

$${A}_{2} = {\int }_{0}^{∞} \frac{ⅆ s}{{( s + {b}^{2} )}^{2} {( s + {a}^{2} )}^{1 / 2}} \qquad ( 338 )$$

From integral 154 of Lide [89]:

$${A}_{2} = - {\{ \frac{1}{{a}^{2} - {b}^{2}} \frac{\sqrt{s + {a}^{2}}}{s + {b}^{2}} \}}_{0}^{∞} - \frac{1}{2} \frac{1}{{a}^{2} - {b}^{2}} {\int }_{0}^{∞} \frac{ⅆ s}{( s + {b}^{2} ) \sqrt{s + {a}^{2}}} \qquad ( 339 )$$

The evaluation at the limits of the first integral is

$$- {\{ \frac{1}{{a}^{2} - {b}^{2}} \frac{\sqrt{s + {a}^{2}}}{s + {b}^{2}} \}}_{0}^{∞} = \frac{a}{{b}^{2} ( {a}^{2} - {b}^{2} )} \qquad ( 340 )$$

From integral 147 of Lide [90], the second integral is:

$$- \frac{1}{2} \frac{1}{{a}^{2} - {b}^{2}} {\int }_{0}^{∞} \frac{ⅆ s}{( s + {b}^{2} ) \sqrt{s + {a}^{2}}} = {\{ \frac{1}{2} \frac{1}{{( {a}^{2} - {b}^{2} )}^{3 / 2}} ln \frac{\sqrt{s + {a}^{2}} + \sqrt{{a}^{2} - {b}^{2}}}{\sqrt{s + {a}^{2}} - \sqrt{{a}^{2} - {b}^{2}}} \}}_{0}^{∞} \qquad ( 341 )$$

Evaluation at the limits of the second integral gives

$$- \frac{1}{2} \frac{1}{{( {a}^{2} - {b}^{2} )}^{3 / 2}} ln \frac{a + \sqrt{{a}^{2} - {b}^{2}}}{a - \sqrt{{a}^{2} - {b}^{2}}} \qquad ( 342 )$$

Combining Eq. (340) and Eq. (342) gives

$$\begin{matrix}{A}_{2} = \frac{a}{{b}^{2} ( {a}^{2} - {b}^{2} )} - \frac{1}{2} \frac{1}{{( {a}^{2} - {b}^{2} )}^{3 / 2}} ln \frac{a + \sqrt{{a}^{2} - {b}^{2}}}{a - \sqrt{{a}^{2} - {b}^{2}}} \\ = \frac{{p}^{3} 4}{{a}_{0}^{3}} - \frac{{p}^{3} \sqrt{2}}{{a}_{0}^{3}} ln \frac{\sqrt{2} + 1}{\sqrt{2} - 1}\end{matrix} \qquad ( 343 )$$

where the semimajor axis,

$$a = \frac{{a}_{0}}{p} ,$$

given by Eq. (164) and the semiminor axis,

$$b = \frac{{a}_{0}}{p \sqrt{2}} ,$$

given by Eq. (166) were used.

Substitution of Eq. (327) and Eq. (343) into Eq. (335) gives

$$Δ B = - {μ}_{0} ( \frac{{p}^{3} 4}{{a}_{0}^{3}} - \frac{{p}^{3} \sqrt{2}}{{a}_{0}^{3}} ln \frac{\sqrt{2} + 1}{\sqrt{2} - 1} ) \frac{{a}_{0}^{2} {ⅇ}^{2} B}{24 {p}^{2} {m}_{e}} \qquad ( 344 )$$

Additionally, it is found both theoretically and experimentally that the dimensions, r², of the molecule corresponding to the area in Eqs. (296) and (306) used to derived Eq. (344) must be replaced by an average, (r²), that takes into account averaging over the orbits isotopically oriented. The correction of 2/3 is given by Purcell [86]. In the case of hydrogen-type molecules, the electronic interaction with the nuclei require that each nuclear magnetic moment is in the direction of the semiminor axis. But free rotation about each of three axes results in an isotropic averaging of 2/3 where the rotational frequencies of hydrogen-type molecules are much greater than the corresponding NMR frequency (e.g. 10¹² Hz versus 10⁸ Hz). Thus, Eq. (344) gives the absolute upfield chemical shift

$$\frac{Δ B}{B}$$

of H₂ relative to a bare proton:

$$\begin{matrix}\frac{Δ B}{B} = \frac{Δ B}{B} \\ = - {μ}_{0} ( \frac{{p}^{3} 4}{{a}_{0}^{3}} - \frac{{p}^{3} \sqrt{2}}{{a}_{0}^{3}} ln \frac{\sqrt{2} + 1}{\sqrt{2} - 1} ) \frac{{a}_{0}^{2} {ⅇ}^{2}}{36 {p}^{2} {m}_{e}} \\ = - {μ}_{0} ( 4 - \sqrt{2} ln \frac{\sqrt{2} + 1}{\sqrt{2} - 1} ) \frac{{pe}^{2}}{36 {a}_{0} {m}_{e}} \\ = - p 28.01 ppm\end{matrix} \qquad ( 345 )$$

where p=1 for H₂.

It follows from Eqs. (164) and (345) that the diamagnetic flux (flux opposite to the applied field) at each nucleus is inversely proportional to the semimajor radius,

$$a = \frac{{a}_{o}}{p} .$$

For resonance to occur, ΔH₀, the change in applied field from that given by Eq. (295), must compensate by an equal and opposite amount as the field due to the electrons of the dihydrino molecule. According to Eq. (164), the ratio of the semimajor axis of the dihydrino molecule H₂ (1/p) to that of the hydrogen molecule H₂ is the reciprocal of an integer p. Similarly it is shown in the Hydrino Hydride Ion Nuclear Magnetic Resonance Shift section of Ref. [5] and previously [91], that according to Eq. (7.57) of Ref. [5] the ratio of the radius of the hydrino hydride ion H⁻(1/p) to that of the hydride ion H¹(1/1) is the reciprocal of an integer p. It follows from Eqs. (7.59-7.65) of Ref. [5] that compared to a proton with no chemical shift, the ratio of ΔH₀ for resonance of the proton of the hydrino hydride ion H⁻(1/p) to that of the hydride ion H⁻(1/1) is a positive integer. That is, if only the radius is considered, the absorption peak of the hydrino hydride ion occurs at a value of ΔH₀ that is a multiple of p times the value that is resonant for the hydride ion compared to that of a proton with no shift. However, a hydrino hydride ion is equivalent to the ordinary hydride ion except that it is in a lower energy state. The source current of the state must be considered in addition to the reduced radius.

As shown in the Stability of “Ground” and Hydrino States section of Ref. [5], for the below “ground” (fractional quantum number) energy states of the hydrogen atom, σₚₕₒₜₒₙ, the two-dimensional surface charge due to the “trapped photon” at the electron orbitsphere and phase-locked with the electron orbitsphere current, is given by Eqs. (5.13) and (2.11) of Ref. [5].

$${σ}_{photon} = \frac{e}{4 {π ( {r}_{n} )}^{2}} [ {Y}_{0}^{0} ( θ , ϕ ) - \frac{1}{n} [ {Y}_{0}^{0} ( θ , ϕ ) + Re \{ {Y}_{l}^{m} ( θ , ϕ ) {ⅇ}^{{ⅈω}_{n} t} \} ] ] δ ( r - {r}_{n} ) \\ n = \frac{1}{p} = 1 , \frac{1}{2} , \frac{1}{3} , \frac{1}{4} , … , \qquad ( 346 )$$

And, σ_{electron}, the two-dimensional surface charge of the electron orbitsphere is

$${σ}_{electron} = \frac{- e}{4 {π ( {r}_{n} )}^{2}} [ {Y}_{0}^{0} ( θ , ϕ ) + Re \{ {Y}_{l}^{m} ( θ , ϕ ) {ⅇ}^{{ⅈω}_{n} t} \} ] δ ( r - {r}_{n} ) \qquad ( 347 )$$

The superposition of σₚₕₒₜₒₙ (Eq. (346)) and σ_{electron}, (Eq. (347)) where the spherical harmonic functions satisfy the conditions given in the Angular Function section of Ref. [5] is

$${σ}_{photon} + {σ}_{electron} = \frac{- e}{4 {π ( {r}_{n} )}^{2}} [ \frac{1}{n} {Y}_{0}^{0} ( θ , ϕ ) + ( 1 + \frac{1}{n} ) Re \{ {Y}_{l}^{m} ( θ , ϕ ) {ⅇ}^{{ⅈω}_{n} t} \} ] δ ( r - {r}_{n} ) \\ n = \frac{1}{p} = 1 , \frac{1}{2} , \frac{1}{3} , \frac{1}{4} , … , \qquad ( 348 )$$

The ratio of the total charge distributed over the surface at the radius of the hydrino hydride ion H⁻(1/p) to that of the hydride ion H⁻(1/1) is an integer p, and the corresponding total source current of the hydrino hydride ion is equivalent to an integer p times that of an electron. The “trapped photon” obeys the phase-matching condition given in Excited States of the One-Electron Atom (Quantization) section of Ref [5], but does not interact with the applied flux directly. Only each electron does; thus, Δv of Eq. (304) must be corrected by a factor of 1/p corresponding to the normalization of the electron source current according to the invariance of charge under Gauss' Integral Law. As also shown by Eqs. (7.8-7.14) and (7.57) of Ref. [5], the “trapped photon” gives rise to a correction to the change in magnetic moment due to the interaction of each electron with the applied flux. The correction factor of 1/p consequently cancels the NMR effect of the reduced radius which is consistent with general observations on diamagnetism [92]. It follows that the same result applies in the case of Eq. (345) for H₂(1/p) wherein the coordinates are elliptic rather than spherical.

The cancellation of the chemical shift due to the reduced radius or the reduced semiminor and semimajor axes in the case of H⁻(1/p) and H₂(1/p), respectively, by the corresponding source current is exact except for an additional relativistic effect. The relativistic effect for H⁻(1/p) arises due to the interaction of the currents corresponding to the angular momenta of the “trapped photon” and the electrons and is analogous to that of the fine structure of the hydrogen atom involving the ²P_{3/2}—²P_{1/2} transition. The derivation follows that of the fine structure given in the Spin-Orbital Coupling section of Ref. [5].

$$\frac{e}{{m}_{e}}$$

of the electron, the electron angular momentum of [symbol] , and the electron magnetic momentum of μ_{B} are invariant for any electronic state. The same applies for the paired electrons of hydrino hydride ions. The condition that flux must be linked by the electron in units of the magnetic flux quantum in order to conserve the invariant electron angular momentum of [symbol] gives the additional chemical shift due to relativistic effects. Using Eqs. (2.85-2.86) of Ref. [5], Eq. (2.92) [5] may be written as

$${E}_{s / o} = \frac{α π {μ}_{0} {e}^{2} {ℏ}^{2}}{{m}_{e}^{2} {r}^{3}} \sqrt{\frac{3}{4}} = α 2 π 2 \frac{e ℏ}{2 {m}_{e}} \frac{{μ}_{0} e ℏ}{2 {m}_{e} {a}_{0}^{3}} \sqrt{\frac{3}{4}} = α 2 π 2 {μ}_{B} B \qquad ( 349 )$$

From Eq. (349) and Eq. (1.194) of Ref. [5], the relativistic stored magnetic energy contributes a factor of α2π In spherical coordinates, the relativistic change in flux, ΔB_{SR}, may be calculated using Eq. (7.64) of Ref. [5] and the relativistic factor of γ_{SR}=2πα which is the same as that given-by Eq. (1.218) of Ref. [5]:

$$\begin{matrix}Δ {B}_{SR} = - {γ}_{SR} {μ}_{0} \frac{Δ m}{{r}_{n}^{3}} ( {i}_{r} cos θ - {i}_{θ} sin θ ) \\ = - 2 π α {μ}_{0} \frac{Δ m}{{r}_{n}^{3}} ( {i}_{r} cos θ - {i}_{θ} sin θ )\end{matrix} \qquad ( 350 )$$

for r<rₙ.

The stored magnetic energy term of the electron g factor of each electron of a dihydrino molecule is the same as that of a hydrogen atom since

$$\frac{e}{{m}_{e}}$$

is invariant and the invariant angular momentum and magnetic moment of the former are also [symbol] and μ_{B}, respectively, as given supra. Thus, the corresponding correction in elliptic coordinates follows from Eq. (2.92) of Ref. [5] wherein the result of the length contraction for the circular path in spherical coordinates is replaced by that of the elliptic path.

The only position on the elliptical path at which the current is perpendicular to the radial vector defined by the central force of the protons is at the semimajor axis. It was shown in the Special Relativistic Correction to the Ionization Energies section of Ref. [5] that when the condition that the electron's motion is tangential to the radius is met, the radius is Lorentzian invariant. That is, for the case that k is the lightlike k⁰, with k=ωₙ/c, a is invariant. In the case of a spherically symmetrical MO such as the case of the hydrogen atom, it was also shown that this condition determines that the electron's angular momentum of [symbol] ,

$$\frac{e}{{m}_{e}}$$

of Eq. (1.99) of Ref. [5], and the electron's magnetic moment of a Bohr magneton, μ_{B}, are invariant. The effect of the relativistic length contraction and time dilation for constant spherical motion is a change in the angle of motion with a corresponding decrease in the electron wavelength. The angular motion becomes projected onto the radial axis which contracts, and the extent of the decrease in the electron wavelength and radius due to the electron motion in the laboratory inertial frame are given by

$$\begin{matrix}λ = 2 π {r}^{′} \sqrt{1 - {( \frac{v}{c} )}^{2}} sin [ \frac{π}{2} {( 1 - {( \frac{v}{c} )}^{2} )}^{3 / 2} ] + {r}^{′} cos [ \frac{π}{2} {( 1 - {( \frac{v}{c} )}^{2} )}^{3 / 2} ] \\ and & ( 351 ) \\ r = {r}^{′} [ \sqrt{1 - {( \frac{v}{c} )}^{2}} sin [ \frac{π}{2} {( 1 - {( \frac{v}{c} )}^{2} )}^{3 / 2} ] + \frac{1}{2 π} cos [ \frac{π}{2} {( 1 - {( \frac{v}{c} )}^{2} )}^{3 / 2} ] ] & ( 352 )\end{matrix}$$

respectively. Then, the relativist factor γ* is

$${γ}^{*} = \frac{2 π}{2 π \sqrt{1 - {( \frac{v}{c} )}^{2}} sin [ \frac{π}{2} {( 1 - {( \frac{v}{c} )}^{2} )}^{3 / 2} ] + cos [ \frac{π}{ 2} {( 1 - {( \frac{v}{ c} )}^{2} )}^{3 / 2} ]} \qquad ( 353 )$$

where the velocity is given by Eq. (1.56) of Ref. [5] with the radius given by Eq. (1.223) [5].

Each point or coordinate position on the continuous two-dimensional electron MO of the dihydrino molecule defines an infinitesimal mass-density element which moves along a geodesic orbit of a spheroidal MO in such a way that its eccentric angle, θ, changes at a constant rate. That is θ=ωt at time t where ω is a constant, and
r(t)=ia cos ωt+jb sin ωt (354)
is the parametric equation of the ellipse of the geodesic. Next, special relativistic effects on distance and time are considered. The parametric radius, r(t), is a minimum at the position of the semiminor axis of length b, and the motion is transverse to the radial vector. Since the angular momentum of [symbol] is constant, the electron wavelength without relativistic correction is given by

$$2 π b = λ = \frac{h}{mv} \qquad ( 355 )$$

such that the angular momentum, L, is given by
L=r×mv=bmv= (356)
The nonradiation and the [symbol] ,

$$\frac{e}{{m}_{e}} ,$$

and μ_{B} invariance conditions require that the angular frequencies, ωₛ and ωₑ, for spherical and ellipsoidal motion, respectively, are

$$\begin{matrix}{ω}_{s} = \frac{ℏ}{{m}_{e} {r}^{2}} = \frac{\frac{π L}{{m}_{e}}}{A} \\ and & ( 357 ) \\ {ω}_{e} = \frac{π ℏ}{{m}_{e} A} = \frac{ℏ}{{m}_{e} ab} & ( 358 )\end{matrix}$$

where A is the area of the closed geodesic orbit, the area of an ellipse given by Eq. (300). Since the angular frequency ωₑ has the form as ωₛ, the time dilation corrections are equivalent, where the correction for ωₛ is given in the Special Relativistic Correction to the Ionization Energies section of Ref. [5]. Since the semimajor axis, a, is invariant, but b undergoes length contraction, the relationship between the velocity and the electron wavelength at the semiminor axis from Eq. (351) and Eq. (355) is

$$λ = 2 π b \sqrt{1 - {( \frac{v}{c} )}^{2}} sin [ \frac{π}{2} {( 1 - {( \frac{v}{c} )}^{2} )}^{3 / 2} ] + a cos [ \frac{π}{ 2} {( 1 - {( \frac{v}{ c} )}^{2} )}^{3 / 2} ] \qquad ( 359 )$$

where λ→a as v→c replaces the spherical coordinate result of λ→r′ as v→c. Thus, in the electron frame at rest v=0, and, Eq. (359) becomes
λ′=2πb (360)
In the laboratory inertial frame for the case that v=c in Eq. (359), λ is
λ=a (361)
Thus, using Eqs. (360) and (361), the relativistic relativist factor, γ*, is

$${γ}^{*} = \frac{λ}{{λ}^{′}} = \frac{a}{2 π b} \qquad ( 362 )$$

From Eqs. (351-353) and Eq. (362), the relativistic diamagnetic effect of the inverse integer radius of H₂ (1/p) compared to H₂, each with ellipsoidal MOs, is equivalent to the ratio of the semiminor and semimajor axes times the correction for the spherical orbital case given in Eq. (350). From the mass (Eq. (2.91) of Ref. [5]) and radius corrections (Eq. (2.89) [5]) in Eq. (2.92) [5], the relativistic stored magnetic energy contributes a factor γ_{SR} of

$${γ}_{SR} = 2 {πα ( \frac{b}{a} )}^{2} = πα \qquad ( 363 )$$

Thus, from Eqs. (335), (350), and (363), the relativistic change in flux, ΔB_{SR}, for the dihydrino molecule H₂ (1/p) is
ΔB_{SR}=−γ_{SR}μ₀A₂Δm=−παμ₀A₂Δm (364)
Thus, using Eq. (345) and Eq. (364), the upfield chemical shift,

$$\frac{Δ {B}_{SR}}{B} ,$$

due to the relativistic effect of the molecule H₂(1/p) corresponding to the lower-energy state with principal quantum energy state p is given by

$$\frac{Δ {B}_{SR}}{B} = - {μ}_{0} πα ( 4 - \sqrt{2} ln \frac{\sqrt{2} + 1}{\sqrt{2} - 1} ) \frac{p {ⅇ}^{2}}{36 {a}_{0} {m}_{e}} \qquad ( 365 )$$

The total shift,

$$\frac{Δ {B}_{T}}{B} ,$$

for H₂(1/p) is given by the sum of that of H₂ given by Eq. (345) with p=1 plus that given by Eq. (365):

$$\begin{matrix}\frac{Δ {B}_{T}}{B} = - {μ}_{0} ( 4 - \sqrt{2} ln \frac{\sqrt{2} + 1}{\sqrt{2} - 1} ) \frac{{ⅇ}^{2}}{36 {a}_{0} {m}_{e}} ( 1 + πα p ) & ( 366 ) \\ \frac{Δ {B}_{T}}{B} = - ( 28.01 + 0.64 ) ppm & ( 367 )\end{matrix}$$

where p=integer>1.

H₂ has been characterized by gas phase ¹H NMR. The experimental absolute resonance shift of gas-phase TMS relative to the proton's gyromagnetic frequency is −28.5 ppm [83]. H₂ was observed at 0.48 ppm compared to gas phase TMS set at 0.00 ppm [84]. Thus, the corresponding absolute H₂ gas-phase resonance shift of −28.0 ppm (−28.5+0.48) ppm was in excellent agreement with the predicted absolute gas-phase shift of −28.01 ppm given by Eq. (345).

7. The Dihydrino Molecular Ion H₂[2c′=aₒ]⁺

7.A. Force Balance of the Dihydrino Molecular Ion

Force balance between the electric and centrifugal forces of H₂⁺(1/2) is given by Eq. (67) where p=2

$$\frac{{ℏ}^{2}}{{m}_{e} {a}^{2} {b}^{2}} 2 {ab}^{2} X = \frac{2 {ⅇ}^{2}}{4 {πɛ}_{o}} X \qquad ( 368 )$$

which has the parametric solution given by Eq. (61) when
a=aₒ (369)
The semimajor axis, a, is also given by Eq. (68) where p 2. The internuclear distance, 2c′ , which is the distance between the foci is given by Eq. (77) where p=2.
2c′=aₒ (370)
The semiminor axis is given by Eq. (79) where p=2.

$$b = \frac{\sqrt{3}}{2 } {a}_{o} \qquad ( 371 )$$

The eccentricity, e, is given by Eq. (81).

$$e = \frac{1}{2} \qquad ( 372 )$$

7.B. Energies of the Dihydrino Molecular Ion

The potential energy, Vₑ, of the electron MO in the field of magnitude twice that of the protons at the foci (ξ=0) is given by Eq. (69) where p=2

$${V}_{e} = \frac{- 8 {ⅇ}^{2}}{8 {πɛ}_{o} \sqrt{{a}^{2} - {b}^{2}}} ln \frac{a + \sqrt{{a}^{2} - {b}^{2}}}{a - \sqrt{{a}^{2} - {b}^{2}}} . \qquad ( 373 )$$

The potential energy, Vₚ, due to proton-proton repulsion in the field of magnitude twice that of the protons at the foci (ξ=0) is given by Eq. (82) where p=2

$${V}_{p} = \frac{2 {e}^{2}}{8 π {ɛ}_{o} \sqrt{{a}^{2} - {b}^{{2}^{\cdot }}}} \qquad ( 374 )$$

The kinetic energy, T, of the electron MO is given by Eq. (71) where p=2

$$T = \frac{2 {ℏ}^{2}}{{m}_{e} a \sqrt{{a}^{2} - {b}^{2}}} ln \frac{a + \sqrt{{a}^{2} - {b}^{2}}}{a - \sqrt{{a}^{2} - {b}^{2}}} \qquad ( 375 )$$

Substitution of a and b given by Eqs. (369) and (371), respectively, into Eqs. (373-375) and using Eqs. (153-155) with p=2 gives

$$\begin{matrix}{V}_{e} = \frac{- 16 {e}^{2}}{8 π {ɛ}_{o} {a}_{o}} ln 3 = - 239.16 eV & ( 376 ) \\ {V}_{p} = \frac{4 {e}^{2}}{8 π {ɛ}_{o} {a}_{o}} = 54.42 eV & ( 377 ) \\ T = \frac{8 {e}^{2}}{8 π {ɛ}_{o} {a}_{o}} ln 3 = 119.58 eV & ( 378 ) \\ {E}_{T} = {V}_{e} + {V}_{p} + T + {\overline{E}}_{osc} & ( 379 ) \\ \begin{matrix}{E}_{T} = - {2}^{2} \{ \begin{matrix}\frac{{e}^{2}}{8 π {ɛ}_{o} {a}_{H}} ( 4 ln 3 - 1 - 2 ln 3 ) \\ [ 1 + 2 \sqrt{ \frac{2 ℏ \sqrt{ \frac{2 {e}^{ 2}}{ \frac{4 π { {ɛ}_{ o} ( 2 {a}_{ H} )}^{3}}{ {m}_{ e}}}}}{ {m}_{ e} {c}^{ 2}}} ] - \frac{1}{2} ℏ \sqrt{ \frac{k}{μ}}\end{matrix} \} \\ = - {2}^{2} ( 16.13392 eV ) - {2}^{3} ( 0.118755 eV ) \\ = - 65.49 eV\end{matrix} & ( 380 )\end{matrix}$$

where Eqs. (376-78) are equivalent to Eqs. (84-86) with p=2. The bond dissociation energy, E_{D}, given by Eq. (160) with p=2 is the difference between the total energy of the corresponding hydrino atom and E_{T} given by Eq. (380):

$$\begin{matrix}{E}_{D} = {E}_{T} ( H ( 1 / p ) ) - {E}_{T} ( {H}_{2}^{+} ( 1 / p ) ) \\ = {2}^{2} ( 2.535 eV ) + {2}^{3} ( 0.118755 eV ) \\ = 11.09 eV\end{matrix} \qquad ( 381 )$$

7.C. Vibration of the Dihydrino Molecular Ion

It can be shown that a perturbation of the orbit determined by an inverse-squared force results in simple harmonic oscillatory motion of the orbit [75]. The resonant vibrational frequency for H₂⁺(1/2) from Eq. (122) is

$$ω ( 0 ) = {2}^{2} \sqrt{\frac{165.51 {Nm}^{- 1}}{μ}} = 1.78 \times {10}^{15} radians \text{/} s \qquad ( 382 )$$

wherein p=2. The spring constant, k(0), for H₂⁺(1/2) from Eq. (124) is
k(0)=2⁴165.51 Nm⁻¹=2648 Nm^{-1 (}383)
The amplitude of oscillation from Eq. (126) is

$$\begin{matrix}A ( 0 ) = \frac{\sqrt{ℏ}}{{2}^{3 / 2} {( {2}^{4} ( 165.51 ) {Nm}^{- 1} μ )}^{1 / 4}} \\ = \frac{5.952 \times {10}^{- 12} m}{2} \\ = \frac{0.1125 {a}_{o}}{2}\end{matrix} \qquad ( 384 )$$

The vibrational energy, E_{vib}(1), for the υ=1→υ=0 transition given by Eq. (128) is
E_{vib}(1)=2²(0.270 eV)=1.08 eV (385)

8. The Dihydrino Molecule

$${H}_{2} [ 2 {c}^{′} = \frac{{a}_{o}}{\sqrt{2}} ]$$

8.A. Force Balance of the Dihydrino Molecule

The force balance equation for the dihydrino molecule H₂(1/2) is given by Eq. (162) where p=2

$$\frac{{ℏ}^{2}}{{m}_{e} {a}^{2} {b}^{2}} 2 a {b}^{2} X = \frac{2 {e}^{2}}{4 π {ɛ}_{o}} X + \frac{{ℏ}^{2}}{2 {m}_{e} {a}^{2} {b}^{2}} 2 a {b}^{2} X \qquad ( 386 )$$

which has the parametric solution given by Eq. (61) when

$$a = \frac{{a}_{o}}{2} \qquad ( 387 )$$

The semimajor axis, a, is also given by Eq. (164) where p=2. The internuclear distance, 2c′, which is the distance between the foci is given by Eq. (165) where p=2.

$$2 {c}^{′} = \frac{1}{\sqrt{2}} {a}_{o} \qquad ( 388 )$$

The semiminor axis is given by Eq. (166) where p=2.

$$b = c = \frac{1}{2 \sqrt{2}} {a}_{o} \qquad ( 389 )$$

The eccentricity, e, is given by Eq. (167).

$$e = \frac{1}{\sqrt{2}} \qquad ( 390 )$$

8.B. Energies of the Dihydrino Molecule

The energies of the dihydrino molecule H₂ (1/2) are given by Eqs. (168-171) and Eqs. (200-202) with p=2

$$\begin{matrix}{V}_{e} = \frac{- 4 {ⅇ}^{2}}{8 {πɛ}_{o} \sqrt{{a}^{2} - {b}^{2}}} ln \frac{a + \sqrt{{a}^{2} - {b}^{2}}}{a - \sqrt{{a}^{2} - {b}^{2}}} = - 271.34 eV & ( 391 ) \\ {V}_{p} = \frac{2}{8 {πɛ}_{o}} \frac{{ⅇ}^{2}}{\sqrt{{a}^{2} - {b}^{2}}} = 76.97 eV & ( 392 ) \\ T = \frac{{ℏ}^{2}}{2 {m}_{e} a \sqrt{{a}^{2} - {b}^{2}}} ln \frac{a + \sqrt{{a}^{2} - {b}^{2}}}{a - \sqrt{{a}^{2} - {b}^{2}}} = 135.67 eV & ( 393 )\end{matrix}$$

The energy, Vₘ, of the magnetic force is

$$\begin{matrix}{V}_{m} = \frac{- {ℏ}^{2}}{4 {m}_{e} a \sqrt{{a}^{2} - {b}^{2}}} ln \frac{a + \sqrt{{a}^{2} - {b}^{2}}}{a - \sqrt{{a}^{2} - {b}^{2}}} = - 67.84 eV & ( 394 ) \\ {E}_{T} = {V}_{e} + T + {V}_{m} + {V}_{p} + {\overline{E}}_{osc} & ( 395 ) \\ \begin{matrix}{E}_{T} = - {2}^{2} \{ \begin{matrix}\frac{{ⅇ}^{2}}{8 {πɛ}_{o} {a}_{0}} [ ( \begin{matrix}2 \sqrt{2} - \\ \sqrt{2} + \frac{\sqrt{2}}{2}\end{matrix} ) ln \frac{\sqrt{2} + 1}{\sqrt{2} - 1} - \sqrt{2} ] \\ [ 1 + 2 \sqrt{\frac{2 ℏ \sqrt{\frac{{ⅇ}^{2}}{\frac{4 {πɛ}_{o} {a}_{0}^{3}}{{m}_{e}}}}}{{m}_{e} {c}^{2}}} ] - \frac{1}{2} ℏ \sqrt{\frac{k}{μ}}\end{matrix} \} \\ = - {2}^{2} ( 31.351 eV ) - {2}^{3} ( 0.326469 eV ) \\ = - 128.02 eV\end{matrix} & ( 396 )\end{matrix}$$

where Eqs. (391-393) are equivalent to Eqs. (168-171) with p=2. The bond dissociation energy, E_{D}, given by Eq. (213) with p=2 is the difference between the total energy of the corresponding hydrino atoms and E_{T} given by Eq. (396).

$$\begin{matrix}{E}_{D} = {E}_{T} ( 2 H ( 1 / p ) ) - {E}_{T} ( {H}_{2} ( 1 / p ) ) \\ = {2}^{2} ( 4.151 eV ) + {2}^{3} ( 0.326469 eV ) \\ = 19.22 eV\end{matrix} \qquad ( 397 )$$

8.C. Vibration of the Dihydrino Molecule

It can be shown that a perturbation of the orbit determined by an inverse-squared force results in simple harmonic oscillatory motion of the orbit [75]. The resonant vibrational frequency for the H₂(1/2) from Eq. (178) is

$$ω ( 0 ) = {2}^{2} \sqrt{\frac{k}{μ}} = {2}^{2} \sqrt{\frac{621.98 {Nm}^{- 1}}{μ}} 3.45 \times {10}^{15} radians / s \qquad ( 398 )$$

wherein p=2. The spring constant, k(0), for H₂(1/2) from Eq. (180) is
k(0)=2⁴621.98 Nm⁻¹=9952 Nm⁻¹ (399)
The amplitude of oscillation from Eq. (182) is

$$\begin{matrix}A ( 0 ) = \frac{\sqrt{ℏ}}{{2}^{3 / 2} {( {2}^{4} ( 621.98 ) {Nm}^{- 1} μ )}^{1 / 4}} \\ = \frac{4.275 \times {10}^{- 12} m}{2} \\ = \frac{0.08079 {a}_{o}}{2}\end{matrix} \qquad ( 400 )$$

The vibrational energy, E_{vib}(1), of H₂(1/2) from Eq. (184) is
E_{vib}(1)=2²(0.517) eV=2.07 eV (401)

9. Data Supporting H(1/p), H⁻(1/p), H₂⁺(1/p), and H₂ (1/p)

Novel emission lines with energies of q·13.6 eV where q=1,2,3,4,6,7,8,9, or 11 were previously observed by extreme ultraviolet (EUV) spectroscopy recorded on microwave discharges of helium with 2% hydrogen [53-56, 68]. These lines matched H(1/p), fractional Rydberg states of atomic hydrogen wherein

$$n = \frac{1}{2} , \frac{1}{3} , \frac{1}{4} , … , \frac{1}{p} ;$$

(p≦137 is an integer) replaces the well known parameter n=integer in the Rydberg equation for hydrogen excited states. A series of unique EUV lines assigned to H₂(1/2) were observed as well [54]. Evidence supports that these states are formed by a resonant nonradiative energy transfer to He⁺ acting as a catalyst. Ar⁺ also serves as a catalyst to form H(1/p); whereas, krypton, xenon, and their ions serve as controls. H(1/p) may react with a proton and two H(1/p) may react to form H₂(1/p)⁺ and H₂(1/p), respectively, that have vibrational and rotational energies that are p² times those of the species comprising uncatalyzed atomic hydrogen. A series of over twenty peaks in the 10-65 nm region emitted from low-pressure helium-hydrogen (90/10%) and argon-hydrogen (90/10%) microwave plasmas matched the energy spacing of 2² times the transition-state vibrational energy of H₂⁺ with the series ending on the bond energy of H₂(1/4)⁺ [57-58, 67]. Rotational lines were observed in the 145-300 nm region from atmospheric pressure electron-beam excited argon-hydrogen plasmas. The unprecedented energy spacing of 4² times that of hydrogen established the internuclear distance as 1/4 that of H₂ and identified H₂(1/4) [67].

H₂(1/p) gas was isolated by liquefaction at liquid nitrogen temperature and by decomposition of compounds found to contain the corresponding hydride ions H⁻(1/p) [67]. The H₂(1/p) gas was dissolved in CDCl₃ and characterized by ¹H NMR. The absolute H₂ gas-phase shift was used to determine the solvent shift for H₂ dissolved in CDCl₃. The correction for the solvent shift was then be applied to other peaks to determine the gas-phase absolute shifts to compare to Eq. (367). The shifts of all of the peaks were relative to liquid-phase TMS which has an experimental absolute resonance shift of −31.5 ppm relative to the proton's gyromagnetic frequency [93-94]. Thus, the experimental shift of H₂ in CDCl₃ of 4.63 ppm relative to liquid-phase TMS corresponds to an absolute resonance shift of −26.87 ppm (−31.5 ppm+4.63 ppm). Using the absolute H₂ gas-phase resonance shift of −28.0 ppm corresponding to 3.5 ppm (−28.0 ppm−31.5 ppm) relative to liquid TMS, the CDCl₃ solvent effect is 1.13 ppm (4.63 ppm−3.5 ppm) which is comparable to that of hydrocarbons [95]. The solvent shift of H₂(1/p) was assumed to be the same as the down-field shift for H₂; thus, novel peaks were corrected by −1.13 ppm relative to a proton's gyromagnetic frequency to give the absolute gas-phase shifts.

Singlet peaks upfield of H₂ with a predicted integer spacing of 0.64 ppm were observed at 3.47, 3.02, 2.18, 1.25, 0.85, 0.21, and −1.8 ppm relative to TMS corresponding to solvent-corrected absolute resonance shifts of −29.16, −29.61, −30.45, −31.38, −31.78, −32.42, and −34.43 ppm, respectively. Using Eq. (367), the data indicates that p=2, 3, 4, 5, 6, 7, and 10, respectively, which matches the series H₂(1/2), H₂(1/3), H₂(1/4), H₂(1/5), H₂(1/6), H₂(1/7), and H₂(1/10) [67]. The ¹H NMR spectra of gases from the thermal decomposition of KH*I matched those of LN-condensable hydrogen. This provided strong support that compounds such as KH*I contain hydride ions H⁻(1/p) in the same fractional quantum state p as the corresponding observed H₂(1/p). Observational agreement with predicted positions of upfield-shifted ¹H MAS NMR peaks (Eq. (31) of Ref. [67]) of the compounds [69-70, 91, 96], catalyst reactions [59, 65, 91, 97], and spectroscopic data [59] supports this conclusion.

Excess power was absolutely measured from the helium-hydrogen plasma [67-68]. For an input of 41.9 W, the total plasma power of the helium-hydrogen plasma measured by water bath calorimetry was 62.1 W corresponding to 20.2 W of excess power in 3 cm³ plasma volume. The excess power density and energy balance were high, 6.7 W/cm³ and −5.4×10⁴ kJ/mole H₂ (280 eV/H atom), respectively. On this basis, and the results of the characterization of the hydride compounds and H₂(1/p) gas, possibilities for advanced technologies exist. In addition to power applications, battery and propellant reactions were proposed that may be transformational [67]. The application of the observed excited vibration-rotational levels of H₂(1/4) as the basis of a UV or EUV laser that could significantly advance photolithography was also discussed previously [67].

10. Systems

Embodiments of the system for performing computing and rendering of the nature of the chemical bond using the physical solutions may comprise a general purpose computer. Such a general purpose computer may have any number of basic configurations. For example, such a general purpose computer may comprise a central processing unit (CPU), one or more specialized processors, system memory, a mass storage device such as a magnetic disk, an optical disk, or other storage device, an input means such as a keyboard or mouse, a display device, and a printer or other output device. A system implementing the present invention can also comprise a special purpose computer or other hardware system and all should be included within its scope.

The display can be static or dynamic such that vibration and rotation can be displayed in an embodiment. The displayed information is useful to anticipate reactivity and physical properties. The insight into the nature of the chemical bond can permit the solution and display of other molecules and provide utility to anticipate their reactivity and physical properties.

Embodiments within the scope of the present invention also include computer program products comprising computer readable medium having embodied therein program code means. Such computer readable media can be any available media which can be accessed by a general purpose or special purpose computer. By way of example, and not limitation, such computer readable media can comprise RAM, ROM, EPROM, CD ROM, DVD or other optical disk storage, magnetic disk storage or other magnetic storage devices, or any other medium which can embody the desired program code means and which can be accessed by a general purpose or special purpose computer. Combinations of the above should also be included within the scope of computer readable media. Program code means comprises, for example, executable instructions and data which cause a general purpose computer or special purpose computer to perform a certain function of a group of functions.

A specific example of the rendering of molecular hydrogen using Mathematica and computed on a PC is shown in FIG. 1A. The algorithm used was ParametricPlot3D[{2*Sqrt[1-z*z]*Cos [u],Sqrt[(1-z*z)]*Sin [u],z},{u,0,2* Pi},{z,−1,0.9999}]. The rendering can be viewed from different perspectives. A specific example of the rendering of molecular hydrogen using Mathematica and computed on a PC from different perspectives was achieved with algorithms such as
Show[Out[1], ViewPoint→{0,−1,1}] and
Show[Out[1], ViewPoint→{−1,1,1}]

In general, the algorithms for viewing from different perspectives comprises Show[Out[1], ViewPoint→{x,y,z}] where x, y, and z are Cartesian coordinates.

The present invention may be embodied in other specific forms without departing from the spirit or essential attributes thereof and, accordingly, reference should be made to the appended claims, rather than to the foregoing specification, as indicating the scope of the invention.

### REFERENCES

1. R. Mills, “The Hydrogen Atom Revisited,” Int. J. of Hydrogen Energy, Vol. 25, Issue 12, December, (2000), pp. 1171-1183.
2. R. Mills, The Nature of Free Electrons in Superfluid Helium—a Test of Quantum Mechanics and a Basis to Review its Foundations and Make a Comparison to Classical Theory, Int. J. Hydrogen Energy, Vol. 26, No. 10, (2001), pp. 1059-1096.
3. R. L. Mills, “Classical Quantum Mechanics,” Physics Essays, in press, http://www.blacklightpower.com/pdf/CQMTheoryPaperTablesand%20Figures080403.pdf.
4. R. L. Mills, The Fallacy of Feynman's Argument on the Stability of the Hydrogen Atom According to Quantum Mechanics, Foundations of Physics, submitted, http://www.blacklightpower.com/pdf/Feynman%27s%20Argument%20Spec%20UPDATE%20091003.pdf.
5. R. Mills, The Grand Unified Theory of Classical Quantum Mechanics, September 2001 Edition, BlackLight Power, Inc., Cranbury, N.J., Distributed by Amazon.com; July 2003 Edition posted at http://www.blacklightpower.com.
6. F. Laloë, Do we really understand quantum mechanics? Strange correlations, paradoxes, and theorems, Am. J. Phys. 69 (6), June 2001, 655-701.
7. D. A. McQuarrie, Quantum Chemistry, University Science Books, Mill Valley, Calif., (1983), pp. 160-183.
8. M. Karplus, R. N. Porter, Atoms and Molecules an Introduction for Students of physical Chemistry, The Benjamin/Cummings Publishing Company, Menlo Park, Calif., (1970), pp. 447-484.
9. L. J. Butler, “Chemical reaction dynamics beyond the Born-Oppenheimer approximation,” Annu. Rev. Chem., Vol. 49, (1998), pp. 125-171.
10. D. A. McQuarrie, Quantum Chemistry, University Science Books, Mill Valley, Calif., (1983), pp. 343-422.
11. P. Pearle, Foundations of Physics, “Absence of radiationless motions of relativistically rigid classical electron,” Vol. 7, Nos. 11/12, (1977), pp. 931-945.
12. V. F. Weisskopf, Reviews of Modern Physics, Vol. 21, No. 2, (1949), pp. 305-315.
13. K. R. Lykke, K. K. Murray, W. C. Lineberger, “Threshold photodetachment of H⁻,” Phys. Rev. A, Vol. 43, No. 11, (1991), pp. 6104-6107.
14. C. A. Coulson, Trans. Far. Soc., Vol. 33, (1937), p. 1479.
15. W. Kolos and L. Wolniewicz, J. Chem. Phys., Vol. 41, (1964), p. 3663; Vol. 49, (1968), p. 404.
16. H. M. James, A. S. Coolidge, J. Chem. Phys., Vol. 1, (1933), p. 825.
17. S. C. Wang, Phys. Rev., Vol. 31, (1928), p. 579.
18. E. Purcell, Electricity and Magnetism, McGraw-Hill, New York, (1985), pp. 29-31.
19. P. W. Atkins, Physical Chemistry, Second Edition, W. H. Freeman, San Francisco, (1982), p. 589.
20. H. Beutler, Z. Physical Chem., “Die dissoziationswarme des wasserstoffmolekuls H₂, aus einem neuen ultravioletten resonanzbandenzug bestimmt,” Vol. 27B, (1934), pp. 287-302.
21. G. Herzberg, L. L. Howe, “The Lyman bands of molecular hydrogen,” Can. J. Phys., Vol. 37, (1959), pp. 636-659.
22. S. Durr, T. Nonn, G. Rempe, Nature, September 3, (1998), Vol. 395, pp. 33-37.
23. Science News, “Wave or particle? Heisenberg, take a hike!” Vol. 154, Sep. 5, 1998.
24. R. Mills, The Grand Unified Theory of Classical Quantum Mechanics, September 2001 Edition, BlackLight Power, Inc., Cranbury, N.J., Distributed by Amazon.com; July 2003 Edition posted at http://www.blacklightpower.com/bookdownload.shtml, Foreword and Chp 37.
25. D. A. McQuarrie, Quantum Chemistry, University Science Books, Mill Valley, Calif., (1983), pp. 135-140.
26. R. Wynar, R. S. Freeland, D. J. Han, C. Ryu, and D. J. Heinzen, “Molecules in a Bose-Einstein Condensate,” Science, Vol. 287, Feb. 11, (2000), pp. 1016-1019.
27. M. Mizushima, Quantum Mechanics of Atomic Spectra and Atomic Structure, W. A. Benjamin, Inc., New York, (1970), p. 17.
28. H. A. Haus, “On the radiation from point charges,” American Journal of Physics, 54, (1986), pp. 1126-1129.
29. L. A. Curtiss, K. Raghavachari, “Gaussian-3 and related methods for accurate thermochemistry,” Theor. Chem. Acc., Vol. 108, (2002), pp. 61-70.
30. L. A. Curtiss, K. Raghavachari, P. C. Redfern, V. Rassolov, J. A. Pople, “Gaussian-3 (G3) theory for molecules containing first and second-row atoms,” J. Chem. Phys., Vol. 109, No. 18, (1998), pp. 7764-7776.
31. R. M. Metzger, “INDO and MINDO/3 atom-in-molecule polarizabilities,” J. Chem Phys., Vol. 74, No. 6, (1981), pp. 3444-3457.
32. D. Rinaldi, “Versatile techniques for semi-empirical SCF-LCAO calculations including minimization of energy,” Comput. Chem., Vol. 1, (1976), pp. 109-114.
33. Z. B. Maksic, D. Kovacek, K. Kovacevic, Z. Medven, “Semiempirical calculations of the ESCA chemical shifts of nitrogen atoms in a chemical environment: failure of the PM3 and AM1 methods,” THEOCHEM Vol. 110, No. 2, (1994), pp. 151-161.
34. J. Tyrrell, R. B. Weinstock, F. Weinhold, “Bond-antibond analysis of internal rotation barriers in glyoxal and related molecules: where INDO fails,” Int. J. Quantum Chem., Vol. 19, No. 5, (1981), pp. 781-791.
35. P. Birner, H. J. Hofmann, “Quantum chemical calculations for the determination of the molecular structure of conjugated compounds. Part XVII. Critical examination of approximate LCAO MO methods. I. Reasons for the failure of the CNDO and INDO methods in theoretical conformation analysis of conjugated compounds,” Int. J. Quantum Chem., Vol. 21, No. 5, (1982), pp. 833-843.
36. W. Klopper, J. Noga, “Accurate quantum-chemical prediction of enthalpies of formation of small molecules in the gas phase,” Chem. Phys. Chem., Vol. 4, (2003), pp. 32-48.
37. NIST Atomic Spectra Database, www.physics.nist.gov/cgi-bin/AtData/display.ksh.
38. D. R. Lide, CRC Handbook of Chemistry and Physics, 79th Edition, CRC Press, Boca Raton, Fla., (1998-9), pp. 9-80-9-85.
39. A. Weinstein, Letter to the Editor of Chemical and Engineering News, May 7, 1990.
40. R. Mills, “The Grand Unified Theory of Classical Quantum Mechanics,” Int. J. Hydrogen Energy, Vol. 27, No. 5, (2002), pp. 565-590.
41. D. A. McQuarrie, Quantum Chemistry, University Science Books, Mill Valley, Calif., (1983), pp. 206-237.
42. W. J. Nellis, “Making Metallic Hydrogen,” Scientific American, May, (2000), pp. 84-90.
43. J. A. Stratton, Electromagnetic Theory, McGraw-Hill Book Company, (1941), p. 195.
44. J. D. Jackson, Classical Electrodynamics, Second Edition, John Wiley & Sons, New York, (1975), pp. 17-22.
45. H. A. Haus, J. R. Melcher, “Electromagnetic Fields and Energy,” Department of Electrical engineering and Computer Science, Massachusetts Institute of Technology, (1985), Sec. 5.3.
46. N. V. Sidgwick, The Chemical Elements and Their Compounds, Volume I, Oxford, Clarendon Press, (1950), p. 17.
47. M. D. Lamb, Luminescence Spectroscopy, Academic Press, London, (1978), p. 68.
48. D. R. Lide, CRC Handbook of Chemistry and Physics, 79th Edition, CRC Press, Boca Raton, Fla., (1998-9), p. 10-175 to p. 10-177.
49. R. Mills and M. Nansteel, P. Ray, “Argon-Hydrogen-Strontium Discharge Light Source,” IEEE Transactions on Plasma Science, Vol. 30, No. 2, (2002), pp. 639-653.
50. R. Mills, M. Nansteel, and P. Ray, “Excessively Bright Hydrogen-Strontium Plasma Light Source Due to Energy Resonance of Strontium with Hydrogen,” J. of Plasma Physics, Vol. 69, (2003), pp. 131-158.
51. R. Mills, M. Nansteel, P. Ray, “Bright Hydrogen-Light Source due to a Resonant Energy Transfer with Strontium and Argon Ions,” New Journal of Physics, Vol. 4, (2002), pp. 70.1-70.28.
52. R. Mills, J. Dong, Y. Lu, “Observation of Extreme Ultraviolet Hydrogen Emission from Incandescently Heated Hydrogen Gas with Certain Catalysts,” Int. J. Hydrogen Energy, Vol. 25, (2000), pp. 919-943.
53. R. L. Mills, P. Ray, B. Dhandapani, J. He, “Extreme Ultraviolet Spectroscopy of Helium-Hydrogen Plasma,” J. Phys. D, Applied Physics, Vol. 36, (2003), pp. 1535-1542.
54. R. L. Mills, P. Ray, J. Dong, M. Nansteel, B. Dhandapani, J. He, “Spectral Emission of Fractional-Principal-Quantum-Energy-Level Atomic and Molecular Hydrogen,” Vibrational Spectroscopy, Vol. 31, No. 2, (2003), pp. 195-213.
55. R. L. Mills, P. Ray, B. Dhandapani, M. Nansteel, X. Chen, J. He, “New Power Source from Fractional Quantum Energy Levels of Atomic Hydrogen that Surpasses Internal Combustion,” J Mol. Struct., Vol. 643, No. 1-3, (2002), pp. 43-54.
56. R. Mills, P. Ray, “Spectral Emission of Fractional Quantum Energy Levels of Atomic Hydrogen from a Helium-Hydrogen Plasma and the Implications for Dark Matter,” Int. J. Hydrogen Energy, Vol. 27, No. 3, pp. 301-322.
57. R. Mills, J. He, A. Echezuria, B Dhandapani, P. Ray, “Comparison of Catalysts and Plasma Sources of Vibrational Spectral Emission of Fractional-Rydberg-State Hydrogen Molecular Ion,” European Journal of Physics D, submitted, http://www.blacklightpower.com/pdf/technical/sources111303textfigs.pdf?prog=normal&id=JAPIAU000092000012007008000001&idtype=cvips&gifs=Yes.
58. R. Mills, P. Ray, “Vibrational Spectral Emission of Fractional-Principal-Quantum-Energy-Level Hydrogen Molecular Ion,” Int. J. Hydrogen Energy, Vol. 27, No. 5, (2002), pp. 533-564.
59. R. L. Mills, P. Ray, “A Comprehensive Study of Spectra of the Bound-Free Hyperfine Levels of Novel Hydride Ion H⁻(1/2), Hydrogen, Nitrogen, and Air,” Int. J. Hydrogen Energy, Vol. 28, No. 8, (2003), pp. 825-871.
60. R. Mills, “Spectroscopic Identification of a Novel Catalytic Reaction of Atomic Hydrogen and the Hydride Ion Product,” Int. J. Hydrogen Energy, Vol. 26, No. 10, (2001), pp. 1041-1058.
61. R. L. Mills, P. Ray, B. Dhandapani, R. M. Mayo, J. He, “Comparison of Excessive Balmer α Line Broadening of Glow Discharge and Microwave Hydrogen Plasmas with Certain Catalysts,” J. of Applied Physics, Vol. 92, No. 12, (2002), pp. 7008-7022.
62. R. L. Mills, P. Ray, E. Dayalan, B. Dhandapani, J. He, “Comparison of Excessive Balmer α Line Broadening of Inductively and Capacitively Coupled RF, Microwave, and Glow Discharge Hydrogen Plasmas with Certain Catalysts,” IEEE Transactions on Plasma Science, Vol. 31, No. (2003), pp. 338-355.
63. H. Conrads, R. Mills, Th. Wrubel, “Emission in the Deep Vacuum Ultraviolet from a Plasma Formed by Incandescently Heating Hydrogen Gas with Trace Amounts of Potassium Carbonate,” Plasma Sources Science and Technology, Vol. 12, (3003), pp. 389-395.
64. R. Mills, T. Onuma, and Y. Lu, “Formation of a Hydrogen Plasma from an Incandescently Heated Hydrogen-Catalyst Gas Mixture with an Anomalous Afterglow Duration,” Int. J. Hydrogen Energy, Vol. 26, No. 7, July, (2001), pp. 749-762.
65. R. Mills, P. Ray, R. M. Mayo, “CW HI Laser Based on a Stationary Inverted Lyman Population Formed from Incandescently Heated Hydrogen Gas with Certain Group I Catalysts,” IEEE Transactions on Plasma Science, Vol. 31, No. 2, (2003), pp. 236-247.
66. R. Mills, P. Ray, R. M. Mayo, “The Potential for a Hydrogen Water-Plasma Laser,” Applied Physics Letters, Vol. 82, No. 11, (2003), pp. 1679-1681.
67. R. L. Mills, Y. Lu, J. He, M. Nansteel, P. Ray, X. Chen, A. Voigt, B. Dhandapani, “Spectral Identification of New States of Hydrogen,” J. Phys. Chem. B, submitted, http://www.blacklightpower.com/pdf/technical/EGunNMR%20032604.pdf.
68. R. L. Mills, X. Chen, P. Ray, J. He, B. Dhandapani, “Plasma Power Source Based on a Catalytic Reaction of Atomic Hydrogen Measured by Water Bath Calorimetry,” Thermochimica Acta, Vol. 406/1-2, pp. 35-53.
69. R. Mills, B. Dhandapani, M. Nansteel, J. He, T. Shannon, A. Echezuria, “Synthesis and Characterization of Novel Hydride Compounds,” Int. J. of Hydrogen Energy, Vol. 26, No. 4, (2001), pp. 339-367.
70. R. Mills, B. Dhandapani, N. Greenig, J. He, “Synthesis and Characterization of Potassium Iodo Hydride,” Int. J. of Hydrogen Energy, Vol. 25, Issue 12, December, (2000), pp. 1185-1203.
71. R. L. Mills, B. Dhandapani, J. He, “Highly Stable Amorphous Silicon Hydride,” Solar Energy Materials & Solar Cells, Vol. 80, No. 1, pp. 1-20.
72. G. R. Fowles, Analytical Mechanics, Third Edition, Holt, Rinehart, and Winston, New York, (1977), pp. 145-158.
73. J. A. Stratton, Electromagnetic Theory, McGraw-Hill Book Company, (1941), pp. 38-54; 195-267.
74. Jahnke-Emde, Tables of Functions, 2nd ed., Teubner, (1933).
75. G. R. Fowles, Analytical Mechanics, Third Edition, Holt, Rinehart, and Winston, New York, (1977), pp. 161-164.
76. G. R. Fowles, Analytical Mechanics, Third Edition, Holt, Rinehart, and Winston, New York, (1977), pp. 57-66.
77. J. D. Jackson, Classical Electrodynamics, Second Edition, John Wiley & Sons, New York, (1975), p. 659.
78. J. D. Jackson, Classical Electrodynamics, Second Edition, John Wiley & Sons, New York, (1975), pp. 780-786.
79. D. A. McQuarrie, Quantum Chemistry, University Science Books, Mill Valley, Calif., (1983), p. 172.
80. K. P. Huber, G. Herzberg, Molecular Spectra and Molecular Structure, IV. Constants of Diatomic Molecules, Van Nostrand Reinhold Company, New York, (1979).
81. D. R. Lide, CRC Handbook of Chemistry and Physics, 79th Edition, CRC Press, Boca Raton, Fla., (1998-9), p. 10-181.
82. R. Loch, R. Stengler, G. Werth, “Measurement of the electronic g factor of H₂⁺,” Phys. Rev. A, Vol. 38, No. 11, (1988), pp. 5484-5488.
83. C. Suarez, E. J. Nicholas, M. R. Bowman, “Gas-phase dynamic NMR study of the internal rotation in N-trifluoroacetlypyrrolidine,” J. Phys. Chem. A, Vol. 107, (2003), pp. 3024-3029.
84. C. Suarez, “Gas-phase NMR spectroscopy,” The Chemical Educator, Vol. 3, No. 2, (1998).
85. D. R. Lide, CRC Handbook of Chemistry and Physics, 79th Edition, CRC Press, Boca Raton, Fla., (1998-9), p. 9-82.
86. E. Purcell, Electricity and Magnetism, McGraw-Hill, New York, (1965), pp. 370-389.
87. J. A. Stratton, Electromagnetic Theory, McGraw-Hill Book Company, (1941), pp. 211-215, 257-258.
88. Whittaker and Watson, Modern Analysis, 4th Edition, Cambridge University Press, (1927), pp. 512ff.
89. D. R. Lide, CRC Handbook of Chemistry and Physics, 79th Edition, CRC Press, Boca Raton, Fla., (1998-9), p. A-30.
90. D. R. Lide, CRC Handbook of Chemistry and Physics, 79th Edition, CRC Press, Boca Raton, Fla., (1998-9), p. A-29.
91. R. Mills, P. Ray, B. Dhandapani, W. Good, P. Jansson, M. Nansteel, J. He, A. Voigt, “Spectroscopic and NMR Identification of Novel Hydride Ions in Fractional Quantum Energy States Formed by an Exothermic Reaction of Atomic Hydrogen with Certain Catalysts,” European Physical Journal-Applied Physics, submitted, http://www.blacklightpower.com/pdf/NMR%20031303.pdf.
92. E. Purcell, Electricity and Magnetism, McGraw-Hill, New York, (1985), pp. 417-418.
93. K. K. Baldridge, J. S. Siegel, “Correlation of empirical δ(TMS) and absolute NMR chemical shifts predicted by ab initio computations,” J. Phys. Chem. A, Vol. 103, (1999), pp. 4038-4042.
94. J. Mason, Editor, Multinuclear NMR, Plenum Press, New York, (1987), Chp. 3.
95. H. E. Gottlieb, V. Kotlyar, A. Nudelman, “NMR chemical shifts of common laboratory solvents as trace impurities,” J. Org. Chem., Vol. 62, (1997), pp. 7512-7515.
96. R. Mills, B. Dhandapani, M. Nansteel, J. He, A. Voigt, “Identification of Compounds Containing Novel Hydride Ions by Nuclear Magnetic Resonance Spectroscopy,” Int. J. Hydrogen Energy, Vol. 26, No. 9, (2001), pp. 965-979.
97. R. L. Mills, P. Ray, “Stationary Inverted Lyman Population Formed from Incandescently Heated Hydrogen Gas with Certain Catalysts,” J. Phys. D, Applied Physics, Vol. 36, (2003), pp. 1504-1509.
98. K. Burke, E. K. U. Gross, “A guided tour of time-dependent density functional theory” in Density Functionals: Theory and Applications, D. Joubert, ed. Springer, Berlin, (1998) pp. 116-146.
99. T. Grabo, E. K. U. Gross, M. Luders, “Orbital functionals in density functional theory: the optimized effective potential method” Psi-k Newsletter, Vol. 16, No. 55, (1996), pp. 1-19.
100. K. Capelle, E. K. U. Gross, “Spin-density functionals from current-density functional theory and vice versa: a road towards new approximations,” Phys. Rev. Letts., Vol. 78, No. 10, (1997), pp. 1872-1875.

1. A system of computing and rendering a nature of a chemical bond comprising physical, Maxwellian solutions of charge, mass, and current density functions of hydrogen-type molecules and molecular ions, said system comprising:
processing means for processing Maxwellian equations representing charge, mass, and current density functions of hydrogen-type molecules and molecular ions, and;
an output device in communication with the processing means for displaying the nature of the chemical bond comprising physical, Maxwellian solutions of charge, mass, and current density functions of hydrogen-type molecules and molecular ions.

2. The system of claim 1 wherein the output device is a display that displays at least one of visual or graphical media.

3. The system of claim 2 wherein the display is at least one of static or dynamic.

4. The system of claim 3 wherein at least one of vibration and rotation is be displayed.

5. The system of claim 1 wherein displayed information is used to model reactivity and physical properties.

6. The system of claim 1, wherein the output device is a monitor, video projector, printer, or three-dimensional rendering device.

7. The system of claim 1 wherein displayed information is used to model other molecules and provides utility to anticipate their reactivity and physical properties.

8. The system of claim 1 wherein the processing means is a general purpose computer.

9. The system of claim 8 wherein the general purpose computer comprises a central processing unit (CPU), one or more specialized processors, system memory, a mass storage device such as a magnetic disk, an optical disk, or other storage device, an input means.

10. The system of claim 9, wherein the input means comprises a serial port, usb port, microphone input, camera input, keyboard or mouse.

11. The system of claim 1 wherein the processing means comprises a special purpose computer or other hardware system.

12. The system of claim 1 further comprising computer program products.

13. The system of claim 12 comprising computer readable medium having embodied therein program code means.

14. The system of claim 13 wherein the computer readable media is any available media which can be accessed by a general purpose or special purpose computer.

15. The system of claim 14 wherein the computer readable media comprises at least one of RAM, ROM, EPROM, CD ROM, DVD or other optical disk storage, magnetic disk storage or other magnetic storage devices, or any other medium which can embody the desired program code means and which can be accessed by a general purpose or special purpose computer.

16. The system of claim 15 wherein the program code means comprises executable instructions and data which cause a general purpose computer or special purpose computer to perform a certain function of a group of functions.

17. The system of claim 16 wherein the program code is Mathematica programmed with an algorithm based on the physical solutions, and the computer is a PC.

18. The system of claim 17 wherein the algorithm is ParametricPlot3D[{2*Sqrt[1-z*z]*Cos [u],Sqrt[(1-z*z)]*Sin [u],z),{u,0,2* Pi},{z,−1,0.9999}], and the rendering is viewed from different perspectives.

19. The system of claim 18 wherein the algorithms for viewing from different perspectives comprises Show[Out[1], ViewPoint→{x,y,z}] where x, y, and z are Cartesian coordinates.

20-54. (canceled)
